(19) United States
(12) Patent Application Publication
(10) Pub. No.: US 2006/0041448 A1
(43) Pub. Date: Feb. 23, 2006

(54) Number of new and unique manufacturing and assembley methods and processes to cost effectively refit and market legacy implements like "The Gilhoolie" presently names "The Wili Grip" TM

(76) Inventors: Robbie Lynne Patterson, Potomac, MD (US); Richard Lewis Stephens JR., Silver Spring, MD (US); Richard C. Walker, Waldorf, MD (US)

Correspondence Address: Richard Walker, 15000 Hanters Harbor Lane, Waldorf, MD, 20601, US

(21) Appl. No.: 11/204,160

(22) Filed: Aug. 16, 2005

Related U.S. Application Data
(60) Provisional application No. 60/602,861, filed on Aug. 20, 2004.

(51) Int. Cl. G06Q 99/00

(52) U.S. Cl. 705/1

(57) ABSTRACT

The invention: involves a unique set of mass production process and evaluation tools to reappraise intricate otherwise costly products to produce or reproduce and manufacture them best in a high cost of living society and low cost of living society. The techniques described here are to specifically bring back a legacy kitchen aids tools, products and other such devices like (The Gilhoolie renamed the WiliGrip™). “The Wili Grip” is a perfect example of intricate craftsmanship that was possible to make when labor was inexpensive in the United States and other industrial countries but has become more difficult to reproduce or compete without inexpensive labor. The invention teaches a variety of metal fabrication production techniques designed to provide technically advanced nations like the US a competitive set of modalities to maintain jobs domestically and compete with low cost labor operations world wide. The production technologies are not limited to aiding industrialized countries, but also presented to teach world leaders, commercial interests and societies how to plan the best use of their assets and technology to proficiently develop competitive commercial product progressively and reduce negative environmental and socio economic impacts, due to gaps in production technology.

### RELATED APPLICATIONS

N/A

### BACKGROUND OF THE INVENTION

### FIELD OF THE INVENTION

For years the United States lead the world in the manufacture of inexpensive hand tools and kitchen devices/home implements like The “Willi Grip” presented in this application. The metal manufacture of these devices has gone from inexpensive in the fifties and early sixties to prohibitive in the US. One major reason is the cost of labor for these somewhat intricate implements. These domestic jobs have gone over seas for the last 40 years. Now there exists technology to retrieve some of those jobs and protect US capability to produce anything cost effectively.

With the aging populous in the US and other industrialized nations more individuals are facing their senior years with crippling diseases like arthritis and require assistance in removing tightly sealed containers with screw off lids. Other legacy tools and device applications are greatly needed creating more and more market for manufactured items that have gone out of production do to high labor cost in this country. Existing prior art has provided very good implementation however the intricacies have become expensive to manufacturer and produce in the United States. A modality of this specification involves innovative and unique production techniques to reproduce an intricate legacy invention/device that is presently to labor intense to be cost effective in the US. Another modality is to provide improved automation techniques to third world countries but maintain a balance so industrialized nations retain a competitive component. This way industrialized nations don't lose a manufacturing component necessary for critical items essential to national security or to maintain a healthy economy.

The techniques include reduced labor, component production or modular production and a progressive centralized machinig/assembly process. Which provides the capability to perform a wide variety of operations inexpensively, such as: bending, forming, punching, blanking, stamping, forging, broaching, and assembly work. Also deep draw production work is possible. Other techniques enable the use of cut-off tools and dies designed for special applications to be created digitally and more efficiently than hand tooling. One goal of this technology is to bring back the production of legacy devices in a cost effective manner and secure market share for the product reproducer, during small run market introductions, till large run mass productions are needed and market share has been acquired. This is a very vulnerable aspect to a totally involved US enterprise competing in a free market economy. And it causes further US discontent for foreign manufacturing.

One modality taught within this application seeks to satisfy both parties by using low cost overseas manufacturers to produce separate components (requiring labor intense work and then shipping them to the U.S. for assembly, marketing and distribution. The innovative manufacturing techniques taught in this specification will include the possible use of low cost foreign labor, but not be limited to it, or dependent on it. In fact, a second modality taught here is to employ overseas cost cutting possibilities only after evaluating highly automated pilot programs here domestically. This can be done via virtual machine shops electronically The exemplary device chosen to display the new production techniques is called a gilhoolie and was first patented in July 1952 Under U.S. Pat. No. 2,669,142 and is listed here in as The Wili Grip. In the past products were made from sub quality materials that did not always meet standards and the means to produce consistency in them was much more restricted and limited. This device was produced during such an era.

This technology teaches the highest standards and techniques by which a product can be made and provides the following information to those skilled in the art to choose proper materials and equipment to redesign and produce cost prohibitive legacy devices today. Data and info for the metal fabrication of products constructed via the description of the Wili grip technology.

### BRIEF DESCRIPTION OF DRAWINGS

Fig A Forming Components

Fig B Global Assembly technologies Of Component Parts

FIG. 1 Frame Rails

FIG. 2 Handle Part

FIG. 3 Jaw Mount for end part

FIG. 4 Jaw Mount slider

FIG. 5 Jaw Parts or Grippers

FIG. 6 Toggle or Latch Parts

FIG. 7 Slider Bed Part and Rail Guides

FIG. 8 End and hook part

### INTRODUCTION

In describing new metal manufacturing processes it is necessary to have a relevant vocabulary and knowledge of the materials being processed and how they have been handled in the past. For this reason the next two sections prior to formal figures are dedicated to providing industry terms and standards for materials used in numerous manufacturing markets. This section is provided to teach the technology and serve as a ready reference for those skilled in the art. It is projected that other exemplary devices will be submitted as related technology to demonstrate unique production techniques and modalities to cost effectively re-manufacture them today and into the future. As part of this new technology exhibited these exemplary devices will be proprietary to it, and also provide technical instruction to manage co-manufacturing and competitive markets nationally and internationally for the manufacture of the devices.

Terminology and Glossary

A

Abrasion Resistance

Ability of a coating to withstand rubbing, scraping and other eroding forces.

Accordion Reed Steel

Hardened, tempered, polished and blued or yellow flat steel with dressed edges and a carbon content of about 1.00%. Material has to possess good flatness, uniform hardness and high elasticity.

Actual Weight

Actual weight is also called the scale weight. Customers buy by the actual (scale) weight of the steel. The theoretical weight is used in estimating, not billing.

Adapter (Lower)

Lower section of a die on which the part nests. Also called a boss, die post, horn, locator, master, master adapter, master plug, riser, and stool.

Adaptor

A block used to mount a forming tool to a slide.

Advance

See progression

Aerial Cam

A cam attached to the upper half of the die with a driver on the bottom half of the die. Also called flying cam, dog leg cam, or walking cam.

Aids

See skin or cast.

Air Bend Die

Angle-forming dies in which the metal is formed without striking the bottom of the die. Metal contact is made at only three points in the cross section—the nose of the male die and the two edges of a V-shaped die opening.

Air Bending

A metal forming operation in which a metal part is formed without the punch and die closing completely on the part. See press brake.

Air Cushion

An air-actuated die cushion.

Air Draw

A draw operation performed in a single action press with the blankholder pressure supplied by an air cushion.

Air Hardening Steel

An alloy steel that will harden by cooling in still air from a temperature higher than the transformation range. It is also referred to as self-hardening steel.

Air Pin

See pressure pin.

Air Spring

See pneumatic spring.

AISI

Acronym for American Iron and Steel Institute.

Alloy

A substance that has metallic properties and is composed of two or more chemical elements of which at least one is an elemental metal. A metal that contains one or more other elements usually added to increase strength or give the base metal important properties.

Alloys

Base metal with other metal or non-metal constituents melted together into a new molecular structure.

Alodine

Commercial trade name for a chromate conversion coating over aluminum.

Aluminum

A soft, lightweight, silver-white metallic chemical element that is the third most common element. Aluminum is denoted by the symbol Al and has an atomic number of 13, an atomic weight of 26.9815, a melting point of 650° C., and a boiling point of 2450° C. It is highly ductile, malleable, conductive, and resistant to corrosion and wear, and is widely used in alloys for beverage cans, household utensils, aircraft and automobile parts, electrical equipment, and many other products.

Aluminum Alloy

Pure aluminum that has been melted together with other constituents to achieve specific physical and mechanical properties.

Aluminum Oxide

Hard mineral of aluminum and oxygen (AlO₃) used as an abrasive and multi-tooth cutters.

Angle Steel

See pre-hem steel. The steel in a hem die that bends the 90° flange to approximately a 45° flange so the hem steel can finish hemming the flange. Also called starting steel or starting ring.

Anisotropy

See plastic anisotropy.

Anneal

A process, consisting of heating to and holding at a suitable temperature followed by cooling at a suitable rate, used primarily to soften metallic materials, such as steel. This process also simultaneously produces desired changes in microstructure, as in other properties, such as improvement of mechanical or electrical properties, increase in stability in dimensions, facilitation of cold work, and more. See batch anneal.

Annealed

The softest possible state of any material.

Annealing

A process involving the heating and cooling of a metal, commonly used to induce softening. The term refers to treatments intended to alter mechanical or physical properties or to produce a definite microstructure.

Annealing, Full

A heat treating process in which metal is heated to a temperature above its critical range, held at that temperature long enough to allow full recrystallization, then slowly cooled through the critical range. Annealing removes working strains, reduces hardness, and increases ductility.

Anodizing

Process of applying a controlled oxide layer to the surface of aluminum.

Anvil Steel

The lower steels or adapter against which the hem steel finishes or flattens the hem.

Arbor Press

A press originally developed for forcing arbors or mandrels into holes and similar assembling.

Arcs

Partial circles used to describe rounded corners of material and show bends in material. Artificially aged-hardening process of material accelerated by temperature.

Aspect Ratio: Dimensionless

The maximum length-to-thickness ratio of which a process is capable. Batch processes like casting have limits imposed by the physics of the process. Continuous processes like rolling, extrusion or wire-drawing have no real upper limit. For these, a cut-off of 1000 has been used.

ASTM

American Standard of Testing and Materials. A non-profit organization that provides a forum for producers, users, ultimate consumers, and those having a general interest (representatives of government and academia) to meet on common ground and write standards for materials, products, systems, and services.

ASTM Standards

A series of documents approved and published by ASTM, that include specifications or requirements, practices, guides, test methods, etc., covering various materials, products, systems or services. In the steel industry, the steel related ASTM standards are used by both the producers and users to ensure that a steel product or service meets all intended requirements. See ASTM—American Society for Testing and Materials.

Austentic Stainless Steel

None-magnetic stainless steel. This material cannot be hardened through heat treatment.

AutoCAD

A brand name of CAD software prevalent in the marketplace.

Automatic Press Stop

A machine-generated signal for stopping the action of a press, usually after a complete cycle, by disengaging the clutch mechanism and engaging the brake mechanism.

Automatic Press

A press with built-in electrical and pneumatic control in which the work is fed mechanically through the press in synchronism with the press action.

Automatic Spinning

The art of forming metal over a mold using an automatic (computer controlled or template) spinning lathe.

Auxiliary Slide

A bed mounted, cam operated, slide typically used for forming on a slide-forming machine.

Axisymmetric Drawing

The drawing of shaped having an axis of symmetry such as cones and round caps.

B

Back Gauge

Stop located in the rear of a metal forming or fabricating machine which is used to position the workpiece during an operation.

Back-Off

Clearance obtained by removing metal either behind or beyond the cutting edge of a punch or die. Same as relief.

Back-Ups

Keys or spacer plates mounted behind a die detail to reinforce that detail.

Balancing Pins

Pins used in conjunction with pressure pins to distribute and balance the load on a die cushion.

Banding, Metallic or Non-Metallic

Strong, lightweight ribbons, generally of steel or nylon, applied under tension to strap packages on a pallet.

Bar Coding

Machine readable alphabetic and/or numeric information used for identification of packaged parts.

Barber Shop

An area, a separate part of a production facility, usually designated just for barbering of dies.

Barbering

Rough grinding, by hand, of excess stock in a die.

Bare Spot

A location on the strip where coating did not hold.

Bark

An older term used to describe the decarburized skin that develops on steel bars heated in a non-protective atmosphere.

Barrel Tumbling

Process in which parts to be deburred are put together with abrasive material into a many-sided barrel and slowly rotated for prolonged periods for the purpose of burr removal.

Base Box

Unit of area of 112 sheets of tin mill products (tin plate, tin free steel or black plate) 14 by 20 inches, or 31,360 square inches. Tin Plate is sold, and carried in finished inventory, on a weight per unit area basis rather than on a thickness basis.

Base Metal Contamination

contamination caused by dirt or other impurities in the steel strip.

Base Weight

Base weight is a Tin Mill term meaning the thickness divided by 0.00011. It is also the weight in pounds of one base box of tin plate. In finished inventory, base weight is specified instead of decimal thickness.

Base Anneal

The process by which a large, stationary stack of steel coils (typically 4 coils high) is subjected to a long heating-treating cycle. This process enables the cold-rolled sheet to fully recrystallize into the softest possible product conforming to customer specifications. See anneal.

Bread

The stationary platen of a press to which the lower die assembly is attached or the stationary part of the shear frame that supports the material being sheared and the fixed blade. Also, a narrow ridge in a sheet metal workpiece or part, commonly formed for reinforcement.

Beaded Flange

A flange reinforced by a low ridge, used mostly around a hole.

Bed

Bottom transverse structural member on a metal forming machine.

Bellmouth

The angular condition on the working surface of a trim or form steel caused by excessive wear.

Belt Sanding

Metal removing process in which an abrasive impregnated endless cloth belt does the cutting.

Bend Angle

The angle through which a bending operation is performed, that is, the supplementary angle to that formed by the two bend tangent lines or planes.

Bend Radius

The inside radius of a bent section or a formed feature.

Bend Relief

The clearance notch at an end of a flange to allow bending without distorting or tearing adjacent material.

Bendability

It is defined as the minimum bending radius (shown as Ri, inner radius) attainable by a given material.

Bending

A term typically applied to a metal forming process. It is the creation of a formed feature by angular displacement of a sheet metal workpiece. The straining of material, usually flat sheet or strip metal, by moving it around a straight axis lying in the neutral plane. Metal flow takes places within the plastic range of the metal, so that the bent part retains a permanent set after removal of the applied stress. The cross section of the bend inward from the neutral plane is in compression; the rest of the bend is in tension. See bending stress, forming, and drawing.

Bending Brake or Press Brake

A form of open-frame single-action press that is comparatively wide between the housings, with a bed designed for holding long, narrow forming edges or dies. Used for bending and forming strip, plate, and sheet (into boxes, panels, roof decks, and so on).

Bending Dies

Dies used in presses for bending sheet metal or wire parts into various shapes. The work is done by the punch pushing the stock into cavities or depressions of similar shape in the die or by auxiliary attachments operated by the descending punch.

Bending Rolls

Various types of machinery equipped with two or more rolls to form curved sheet and sections.

Bending Stress

A stress involving tensile and compressive forces, which are not uniformly distributed. Its maximum value depends on the amount of flexure that a given application can accommodate. Resistance to bending can be termed stiffness.

Binder

The upper and lower holding surfaces which control metal flow around a shape to be formed in a draw operation. Also see blank holder and draw ring.

Binder Force

The force applied to the perimeter of a sheet during a deep drawing operation to suppress wrinkling and control metal flow. See blank holder force.

Binder Ring

That part of a forming die that holds the blank by pressure against a mating surface of the die to control metal flow and prevent wrinkling. A blank holder is also called binder, binder ring, or ring. See blank holder.

Bi-Planar

Refers to surfaces that meet at an angle in different planes.

Birdbath

A local inboard condition on a panel which is usually in a high stress area. See low spot.

Black Plate

Any steel that has not been coated. Typically, black plate has gone through Tandem mill (cold-rolled). This term also defines a product, an uncoated material in tin plate gauges. 128 lb. (0.141 inch) and lighter in tin mill product that has not received any additional metallic coating during production. A low carbon cold reduced steel intended for use in the uncoated state or for coating with tin and chromium.

Back Plate Tin

A light-gauge cold-rolled non-coated steel, it is the basic tin mill product from which all other tin mill products are made.

Blade Steel

A long narrow trim steel quite often mounted from the side. Also see details.

Blank

In forming, a piece of sheet metal stock from which a product is made. Material, produced in cutting dies, that is usually subjected to further press operations. A workpiece that results from a blanking operation. A pre-cut metal shape for a subsequent press operation.

Blank Development

The technique of determining the size and shape of a blank. The resultant flat pattern.

Blank Holder

As a double action of forming or drawing operation takes place, the blank holder restrains the metal on its movement. During drawing operation, if the force is sufficient, the metal wrinkles. If the force is excessive, the metal tears. The part of a draw die which hold the workpiece against the draw ring to control metal flow. A blank holder is also called binder, binder ring, or ring. That part of a forming die, which holds the blank by pressure against a mating surface of the die to control metal flow and prevent wrinkling. The blank holder is sometimes referred to as hold down or binder area. Pressure applied by mechanical means, springs, air, or fluid cushions.

Blank Holder Force (BHF)

The force applied to the perimeter of a sheet during a deep drawing operation to suppress wrinkling and control metal flow.

Blank Holder Pressure (BHP)

The pressure pattern on the blank that results from applying a blank holder force. The pressure exerted by the blank holder against the blank. This pressure is normally adjustable to control metal flow during the drawing.

Blank Sheet

The flat stamping produced in a stamping die. The use of a blank to describe a stamping usually implies the need for subsequent drawing.

Blanking

The operation of punching, cutting, or shearing a piece out of stock to a predetermined shape. Die cutting of the outside shape of a part.

Bleeding

A coating defect consisting of the movement of an ingredient to the surface of a coating, or a movement, which stains in an adjoining area. The term blooming is also a form of bleeding, but it is normally used when describing lubricants rather than pigments.

Bleed-Out

Leaching of entrapped plating solutions, causing surface discoloration and corrosion.

Blind End Fastener

Internally threaded fastener which is manufactured with one end closed such that, when installed, it forms a gas and moisture resistant seal.

Blind Fastener

Fastener which is capable of being permanently installed and used in a workpiece with access from only one side.

Blind Rivet

Rivet which is capable of being installed and used in a workpiece or assembly with access from only one side.

Blocking

Another coating defect consisting of the adhesion of two adjusting coatings of materials. Usually this term refers to the coating on one side of coated plate being tacky or sticky and adhering to the adjacent sheet.

Blue Tampered Spring Steel Strips

See tempered spring steel strip.

Bluing

Subjecting the scale-free surface of a ferrous alloy to the action of air, steam, or other agents at a suitable temperature, thus forming a thin blue film of oxide and improving the appearance and resistance to corrosion. This term is ordinarily applied to sheet, strip, or finished parts. It is used also to denote the heating of springs after fabrication in order to improve their properties.

Bologna

A bulge outside of the finish form area on a draw punch or cavity to take up loose metal or to help control the draw process. Also known as kidney.

Bolster Plate

The plate to which dies can be fastened so the assembly is secured to the top surface of a press bed.

Boss

See adapter. A raised portion of a casting, die, or part such as bosses for tie slots on the die shoes.

Bottoming

Forming operation in which the punch and the die are closed completely on the workpiece.

Bottoming Bending

Press-brake bending process in which the upper die (punch) enters the lower die and coins or sets the material to eliminate springback.

Bottoming Blocks

Adjustable blocks mounted under a pad to determine the proper height of the pad when the die is closed. Also see stop blocks.

Bottoming Stamp

A stamp or weld marks that is used in a form die to indicate that the die is on the bottom. Usually positioned in a scrap area of the part.

Bow

See camber.

Blow Distortion

Out of flatness condition in sheet material commonly known as oil canning in which, with the edges of the sheet restrained, the center of the sheet can be popped back and forth but cannot be flattened without specialized equipment. This condition is sometimes inherent in the material as received from the supplier and sometimes the result of multiple punching or forming operations.

Box Cam

A precision made box containing cam slide and driver.

Box Heels

See heel block.

Brake Press Pending or Brake Press Bending

An operation that produces various degree bends when fabricating parts from steel.

Breakage

The space, per side, between the punch and die on a trim or pierce die. Also called clearance or die clearance.

Break-Off

See breakout.

Breakout

Fractured portion of the cross section of a cut edge of stock. A condition naturally occurring during shearing, blanking, punching and other cutting operations.

Breathing

The non-desired action of a die member moving away from the force applied.

Bridle Unit

A three-roll cluster used to control line tension at strategic locations on the line.

Bridges

See micro ties.

Bright Commercial Finish

See finishes.

Brinnell Hardness Testing

A method of testing the hardness of material. This test is usually used on softer materials and castings in which a carbide ball is pressed into the material for a given period of time and then removed. The impression that results is measured for the width along with a value determines hardness of the material.

Brittleness

A tendency to fracture without appreciable deformation.

Brushing or Etching

Mechanical or chemical cleaning of parts before further processing.

Bubble Die

A pre-draw die to gain material in the areas of a deep draw to help prevent the fracture of the metal in these areas.

Buckling

An uncontrolled deformation pattern perpendicular to the surface of a sheet caused by compressive stresses. Buckling in the flange of the part is referred to as wrinkling, and buckling in the wall of the part is referred to as puckering. A bulge, bend, kink, or other wavy condition of the workpiece caused by compressive stresses.

Buffing

Polishing method employing soft cloth to carry very fine polishing compounds.

Build Up Coil

A coil that is made by joining two or more coils to make one max coil or one shippable coil.

Bulging

The process of increasing the diameter of a cylindrical shell (usually to a spherical shape) or of expanding the outer walls of any shell or box shape whose walls were previously straight.

Bumper-Actuated Die

See free-shoe die.

Burn Mark

Heat discoloration created in the contact area of a welding electrode.

Burnish

Smooth or shiny area above the breakout on a sheared edge. Also called shear or cut band.

Burr

A thin ridge, raised sharp edge, or roughness left on forgings or sheet metal blanks by cutting operations such as slitting, shearing, trimming, punching, blanking, or sawing.

Burr Direction

Side of the stock on which burns appear.

Burr Height

Height to which burr is raised beyond the surface of the material.

Burr Rollover

Condition of burr displacement resulting from mechanical deburring operation.

Burr-Free

Edge without sharp protrusions.

Burring

A common term for debarring or smoothing the rough cut edges of metal.

Bus Bar Copper

Copper with minor alloying constituents and high conductivity used for electrical applications.

Butt

Place material, or material placed, end to end.

Button

A small cylindrical die steel with an opening larger than the punch point size, generally by a percentage of the thickness of the material being pierced. Also called die button or pierce button.

By Coil

This is a selling term that refers to product sold in the form of a coil vs. cut plate. “Bi Coil ” is also used in production to refer to coil vs. cut plate.

Bypass

C

CAD

Acronym for Computer Aided Design

CAM

Acronym for Computer Aided Manufacturing.

Cam

A device to move or do work at an angle to the press stroke. See cam slide or specific cams: aerial cam, dwell cam, incline cam, shimmy cam, and box cam.

Cam Action

A motion at an angle to the direction of an applied force achieved by a wedge or cam.

Cam Chart

A chart created by the tool designer assuming that the sequences of operations of a complicated part fall within the 360° slide forming machine cycle.

Cam Drive

A block with one or more angular surfaces that applied force by the vertical movement of the press to mating angular surfaces on a cam slide. Also called driver.

Cam Press

A mechanical press in which one or more of the slides are operated by cams; usually a double-action press in which the blank holder slide is operated by cams through which the dwell is obtained.

Cam Slide

A device to perform work at an angle to the press stroke. Most common angle is 90°. Also called cam or slide.

Cam Trim

Removing excess material after the part has been drawn or formed. This is done with a cam activated operation, usually as a secondary operation.

Camber

Gradual deviation from straightness of the edge of the sheet or coil stock caused during the slitting operation.

Camber Tolerances

Camber is the deviation from edge straightness. ASTM Standards define the maximum allowable tolerance of this deviation of a side edge from a straight line.

Camera Shutter Steel

Hardened, tampered and bright polished extra flat and extra precision rolled. Carbon content is 1.25 with Chromium content at 0.15.

Canning

A dished distortion in a flat or nearly flat sheet metal surface, sometimes referred to an oil canning. Enclosing a highly reactive metal within a relatively inert material for the purpose of hot working without undue oxidation of the active metal.

Capital Cost: Units

The capital cost is the total cost of the equipment required to perform the process. Manual processes have lower capital costs than automated processes. In cost estimation, the capital cost is converted to a time-cost by dividing it by the capital write-off time, except when the equipment is totally dedicated to a single product. Then, it is calculated in the same way as tooling cost.

Carbon Steel

A steel that owes it specific properties chiefly to the presence of carbon, without substantial amounts of other alloying elements. It is also referred to as ordinary steel, straight carbon steel, or plain carbon steel.

Carburr

A small carbide mill cutter usually one-half inch or less in diameter. Designed to remove stock from hardened tool steel.

Carrier Strip

The area of a stock strip that ties the parts together and carries them through a progressive die until the final operation.

Case

The surface layer or case of a ferrous alloy that has been made substantially harder than the interior or core.

Case Hardening

Any process of hardening a ferrous alloy so that the case or surface is substantially harder than the core or interior.

Center

The point that is defined midway between the extents of a hole in both the X and Y directions.

Center Buckle

A condition in a band of steel where the center (in the direction of rolling) is longer than the edges and has a wave or buckle.

Center Drill

A combined drill and countersink. The countersink is 60° included angle. Primarily used to drill center holes in the end of parts on the lathe and spotting centers of holes to be drilled.

Center Tool

See mandrel.

C-Frame Press

A press having uprights or-housing resembling the letter “C”. Also called gap frame or overhanging press.

Chain Dimensioning

A drafting practice which dimensions repetitive features from each other.

Chain Slots

Machined or cast slots in the upper and lower die shoe and large adapters for handling purposes.

Chair

A precision ground block, which has a slot or hold on one surface and a leg off the opposite surface from the slot or hole. One surface of the leg is on the center line of the slot or hole. Used with an indicator to find the exact edge of a surface.

Chamfer

A beveled surface to eliminate an otherwise sharp corner that is typically about a 45° angle. A relieved angular cutting edge at a tooth corner.

Checks

Surface ripples and cracks induced by forming.

Chemistries

The chemical composition of steel indicating the amount of carbon, manganese, sulfur, phosphorus and a host of other elements.

Chicago Screw

A socket head cap screw with the head and the upper portion of the body turned down, leaving a minimum number of threads of the end of the body. Used where the screw hole in the detail does not align with the threaded hole in the mounting surface. Also called Eberly screws, rubber screws, or Kelly screws.

Chopoff

See cutoff.

Chord Modulus

The slope of the chord drawn between any two specific points on a stress-strain curve. See also modulus of elasticity.

Chromium-Nickel Steel

steel usually made by the electric furnace process in which chromium and nickel participate as alloying elements. The stainless steel of 18% chromium and 8% nickel are the better known of the chromium-nickel types.

Chute

A trough in which blankets, workpieces, scrap, or parts are fed to or conveyed away from a die or press.

Circle

A continuous arc starting and ending at the same point.

Circle Grid

A regular pattern of circles [2.5 mm (0.1 in.) diameter], marked on a sheet metal blank.

Circle Grid Analysis

A technique of measuring strains on deformed sheet steel. The result can then be plotted on the forming limit diagram.

Clad Shape

A roll formed shape made up of two material simultaneously fed into the roll forming mill to produce a composite section.

Clamp Marks

These are slight indentations at the edge of one side of metal stock caused by pressure from turret press holding devices.

Class 1 Surface Quality Steel

A class of cold rolled steel processed to meet requirements for controlled surface texture, flatness, and temper requirements. This steel is commonly produced for use in exposed applications.

Classes of Milled Pockets

Class “A”—bottom and sides machined flat and square to each other and to dimensions. Class “B”—bottom machined flat. Sides need not be flat or square. Class “C”—strictly clearance. Loose tolerance on dimensions and finish of bottom and sides.

Clearance

The space, per side, between the punch and die. This space is also called breakage on trim and/or pierce dies. It is also the space between any two details to avoid interference.

Clinch Die

See nutter die.

Clinch Nut Die

See nutter die.

Clock Spring Material

Alloy steel available in a pre-hardened condition between RC 45 and 52.

Clock Spring Steel

This steel product is manufactured and processed with great and extreme care exercised in each step of it production. Manufactured from carbon range of 0.90/1.03 with Rockwell range C 48/51. Clock spring quality has been ground and polished with edges dressed. It is usually supplied dark blue in color and has a wide range of uses, such as coiled and flat mechanical springs, ignition vibrator springs, springs for timing devices, springs for the electric and electronic fields, steel tapes, rules, etc.

Clock Spring Strip

Clock spring steel made available in a strip form.

Closed-Die

A tool that creates a work-shape-imposing office, cavity, or passageway.

Closed Hem

See flattened hem.

CNC

Industry acronym for Computer Numerical Control. See NC.

CNC Punch Press

Machine supplying compression force for reshaping materials and being controlled by a computer numerical control device,

CNC Turret Press

Automatic punch press indexing the material and selecting the intended tool out of the rotary tool holding device (turret) totally by computer control for piercing, blanking and forming workpieces as Programmed.

Coat

The paint, varnish or lacquer applied to a surface in a single application (one layer) to form a properly distributed film when dry.

Coating

The process of appling a coat to a metal surface.

Coating a System

A system of applying a number of coats separately, in a predetermined order, at suitable intervals to allow for drying or curing.

Coating Weight

In the Sheet Mill, the amount of zinc on a galvanized sheet measured in ounces per square foot.

Co-Engineering

Process in which the customer and the supplier review and modify a design to simplify manufacturability of a part.

Coil

A length of steel wound into roll-form.

Coil Breaks

Creases, ridges, or marks appearing in sheets as parallel lines transverse to the direction of rolling and generally extending across the width of the sheet. Coil breaks are usually caused by improper coiling or leveling. They are also referred to as crossbreaks.

Coil Set

A curvature of the strip in the lengthwise sense, parallel to the direction in which the strip was rolled or uncoiled.

Coils

Coiled flat sheet or strip metal that is usually in one continuous piece or length.

Coin Straightening

A combination coining and straightening operation performed in special cavity dies designated to impart a specific amount of working in specified areas of a forgoing to relieve the stresses developed during heat treatment.

Coining

A compressive metal flowing action. A closed-die squeezing operation in which all surface of a workpiece are confined or restrained, resulting in well-defined imprint of the die on the work. A restriking operation used to sharpen or change an existing radius or profile.

Cold Developing

The initial development of a blank or part on paper or in wax during the designing of a die.

Cold Forming

See cold working.

Cold Heading

The process or upsetting the ends of a bar, wires, or tube stock while cold.

Cold Rolled

A metal finishing process that subjects strip or sheet steel to a cold-reduction mill. Steel that has been subjected to the cold rolling process is considerable thinner and stronger than hot-rolled sheet. See cold rolled sheet and cold rolled steel.

Cold Rolled Sheet

A mill product produced from a hot-rolled pickled coil that has been given substantial cold reduction at room temperature. The usual end product is characterized by improved surface, greater uniformity in thickness, and improved mechanical properties as compared with hot-rolled sheet. A product manufactured from hot rolled descaled (pickled) coils by cold reducing to the desired thickness, generally followed by annealing and temper rolling. If the sheet is not annealed after cold reduction it is known as full hard.

Cold Rolled Steel

Steel that was reduced to final thickness in the cold state by a rolling mill that creates a smooth surface with slight skin hardness.

Cold Rolling

Rolling metal at a temperature below the softening point of the metal to create strain hardening (work-hardening). Same as cold reduction, except that the working method is limited to rolling. Cold rolling changes the mechanical properties of strip and procedures certain useful combinations of hardness, strength, stiffness, ductility and other characteristics known as tempers. Term applied to the operation of passing unheated metal through rolls for the purpose of reducing its gauge.

Cold Rolling Mill

A mill that reduces the cross sectional area of the metal by rolling at approximately room temperature.

Cold Weld

Defective weld due to improper contact or inadequate heat during welding.

Cold Worked

Material hardened naturally through forming at ambient temperatures.

Cold Working

The plastic deformation of metal under conditions of temperature and strain rate that induce strain hardening. Usually, but not necessarily, conducted at room temperature. Also referred to as cold forming or cold forging. Contrast with hot working.

Collapsible Tool (Segmented)

A mold having a removable center core which keeps the perimeter pieces in place during spinning.

Column Press

A four post single slide press.

Combination Die

See compound die.

Combined Drill and Countersink

See center drill.

Commercial Finish

See finishes.

Commercial Tolerance

The range of difference that a product's specifications can deviate from the ordered specifications and still meet the industry accepted ranges as defined by ASTM Standards.

Commercial Grade

Standard materials commonly available through supply houses.

Composite Forming

Composite forming methods vary depositing on the form of the fibers used. Chopped fibers are mixed with resin and shaped by polymer molding techniques; resin-impregnated mats of fibers are laid in a mold or pressed together and then allowed to cure; and continuous fibers coated with resin are wound on a mandrel to make spherical, cylindrical and other shapes.

Compound Die

Tool used to pierce, form and blank a part at the same time, with one stroke of the press.

Compressive Strength

The maximum compressive stress a material is capable of developing. With a brittle material that fails in compression by fracturing, the compressive strength has a definite value. In the case of ductile, malleable, or semi-viscous material (which do not fail in compression by a shattering fracture), the value obtained for compressive strength is an arbitrary value dependent on the degree of distortion that is regarded as effective failure of the material. See ductility, malleability.

Compressive Stress

A stress that causes an elastic body to deform (shorten) in the direction of the applied load. Contrast with tensile stress.

Concave Perimeter Contour

Curvature of the peripheral edge viewed from outside of the part.

Concave Surface Contour

Curvature viewed from outside of the material. See O.S.M.

Concealed Head Fastener

A fastener installed in a blind hole.

Concentricity

Dimensional relationship of 2 or more items sharing a common center line.

Conditional Match

Perceived identity of color exhibited by a pair of colors, each with different spectral distribution curves. Also called Metameric match.

Construction Hole

A hole in which the center line is used to dimension other holes or surfaces. Sometimes refereed to as a point of origin or coordinating hole.

Continuous Weld

Continuously welding one coil to another at the entry end and splitting off coils of a specific weight at delivery end.

Contour Forming

See roll forming, stretch forming, tangent bending.

Contouring

Machining surface shape on die members. Also called kellering.

Conventional Draw Die

See draw die.

Convex Perimeter Contour

The curvature of the peripheral edge viewed from outside of the part.

Convex Cutter Die

A die employing a thin strip of steel formed to the outline of a part and a flat metal plate or block of wood for the punch. A cookie cutter die is used to cut non-metallic material, soft metals, and low run prototype sheet metal parts. See steel rule die.

Coordinate Measuring Machine (CMM)

A machine for measuring three dimensional (X, Y, Z) coordinates on a component for inspection or geometry description purposes. The basic CMM system is comprised of four components, the machine itself, the probing system, the computer system and the measuring software.

Coordinating Hole

See construction hole.

Co-Planar

Having all elements, features, Dimensions or functions existing in one geometric plane.

Corn Cob

A milling cutter with serrated flutes or teeth. See roughening cutter.

Corner

Three surfaces meeting at one point.

Corner Radius

Outside radius.

Corrective Leveling

Capability of a leveling machine to remove or reduce shape defects across the strip, coil, or sheet, in addition to flattening lengthwise curvatures.

Corrugated

Metal that has been formed using the corrugating process. As a defect, material with alternate ridges and furrows or a series of deep short waves.

Corrugating

The forming of sheet metal into a series of straight, parallel alternate ridges and grooves with a rolling mill equipped with matched roller dies or a press brake equipped with specially shaped punch and die.

Corrugations

Transverse ripples caused by a variation in a strip shape during hot or cold reduction.

Counterbalance

See slide counterbalance.

Counterbalance Pressure

See slide counterbalance pressure.

Counterbore

A rotary, pilot guided, end-cutting tool, having one or more cutting lips and usually having straight or helical flutes.

Counterboring

Enlarging a hole to a limited depth producing a flat bottom in the enlargement. A machining or coining operation to generate a cylindrical flat-bottomed hole.

Countersink

A funnel shaped enlargement at the outer end of a drilled hole having an 82° included angle to allow the head of a screw to be flush with or below the surface. Also, a bit or drill for making a countersunk hole.

Countersinking

Machining or coining operation to generate a conical angle on a hole.

Cracked Edges

Discontinuity or cracked condition on the edge of the strip.

Crank Press

A mechanical press whose slides are actuated by a crankshaft.

Cratering

A coating defect consisting of small, apparently uncoated, spots of coated plate consisting of a very thin film of coating that has been contaminated by oil, silicon, or other foreign matter. Eyeholing is similar to cratering, but with metal exposure in the crater.

Creep

A term used in a hemming operation for the amount the part reduces in size along the flange radius when forming from a 90° flange to a full fold or hem.

Crimping

The forming of relatively small corrugations in order to set down and lock a seam, to create an arc in a strip of metal, or to reduce an existing arc or diameter. See also corrugating.

Crossbow

A curvature across the width of the strip at a 90° angle to the direction which the strip has been rolled or uncoiled.

Crossbreaks

See coil breaks.

Cross-Over

The physical area of a trim steel that overlaps the top of another trim steel, such as the area of an upper trim steel that is notched to go over the top of a lower scrap cutter. The distance between the two steels in this area, when die is closed, should be at least twice stock thickness.

Crown

The upper part (head) of a press frame. On hydraulic presses, the crown usually contains the cylinder; on mechanical presses, the crown contains the drive mechanism. A shape (crown) ground into a flat roll to ensure flatness of cold rolled sheet (and hot) and strip.

Cumulative Tolerance

Progressive accumulation of tolerances resulting from multiple operations or assembly of multiple parts.

Cup

A sheet metal part that is the product of the first drawing operation. Also, any cylindrical part or shell closed at one end.

Cup Fracture (Cup-and-Cone Fracture)

A mixed-mode fracture, often seen in tensile test specimens of a ductile material, in which the central portion undergoes plane-strain fracture and the surrounding region undergoes plane-stress fracture. One of the mating fracture surfaces looks like a miniature cup; it has a central depressed flat-face region surrounded by a shear lip. The other fracture surface looks like a miniature truncated cone.

Cupping

The fast step in deep drawing.

Cupping Test

A mechanical test used to determine the ductility and stretching properties of sheet metal. It consists of measuring the maximum part depth that can be formed before fracture. The test is typically carried out by stretching the test piece champed at its edges into a circular die using a punch with a hemispherical end. See also cup fracture and Olsen ductility test.

Curling

The act of forming an edge of circular cross section along a sheet, workpiece, or at the end of a shell or tube.

Cushion Pins

Metal pins used in conjunction with a die cushion to transfer pressure from the cushion to the bottom of a die pad. They are also called air pins, cushion pins, pressure pins, and transfer pins.

Cut

To separate any portion of a workpiece from any other portion of the same workpiece by a step of machining (e.g., grinding, drilling, boring, milling, planing), severing (e.g., breaking, sawing, slicing, shearing), or by intrusion of a sharp-edged or pointed tool without removal of material (e.g., stabbing, splitting, intrusive punching). See pierce.

Cut and Carry Method

A method in which the part under fabrication is not entirely detached from the strip or is pushed back into the strip for transporting to a succeeding station in a progressive die.

Cut Edge

The normal edge that results from the shearing, slitting or trimming of a mill edge.

Cutoff

A pair of blades positioned in dies or equipment (or a section of the die milled to produce the same as inserted blades) used to separate the forging from the bar after forging operations are completed. Used only when forgings are produced from relatively long bars instead of from individual, precut multiples or blanks. See blank.

Cutting

See cut.

Cutting Land

D

Date of Run

See run stamps.

Datums

Theoretically exact planes, lines or points from which other features are located on design drawings.

Daylight

The maximum clear distance between the pressing surfaces of a press when the surfaces are in the usable open position. Where a bolster plate is supplied, it is considered the pressing surface. See also shut height.

Deburr

To remove the sharp, knife-like edge from parts. Decrease the height of die space.

Dedicated Tooling

Commonly referred to as hard tooling. This is tooling made to produce a specific part.

Deep Drawing

The fabrication process of flat rolled steel to make drawn parts. The part is mechanically formed through or in a die. The blank diameter is reduced; the blank contracts circumferentially as it is drawn radially inward. Deep drawing is characterized by the production of a parallel-wall cup from a flat blank of sheet metal. The blank may be circular, rectangular, or a more complex shape. The blank is drawn into the die cavity by the action of a punch. Deformation is restricted to the flange areas of the blank. No deformation occurs under the bottom of the punch—the area of the blank that was originally within the die opening. As the punch forms the cup, the amount of material in the flange decreases. Deep drawing is also called cup drawing or radial draw forming. See deep drawing applications.

Deep Drawing Applications

Parts or applications that require deep drawing to meet their fabrication requirements. Examples would include are motor shells, fenders, quarter panels, and door panels for automotive parts and battery cases for AA or AAA batteries.

Deep Drawn

Metals that have been subjected to the deep drawing metal stamping process.

Defect

Anything that renders the steel unfit for the specific use for its intended use such as punchmarks, roll marks, oil spots, and scratches. However, what is defective for one user may be prime steel for another.

Deflection

The amount of deviation from a straight line or plane when a force is applied to a press member. Generally used to specify the allowable bending of the bed, slide, or frame at rated capacity with a load of predetermined distribution.

Deformation

The process of metal forming the solid material into shape by applying forces to it.

Deformation Limit

In drawing, the limit of deformation is reached when the load required to deform the flange becomes greater than the load-carrying capacity of the cup wall. The deformation limit (limiting draw ratio, LDR) is defined as the ratio of the maximum blank diameter that can be drawn into a cup without failure, to the diameter of the punch.

Deformation Processing

Deformation is forming the solid material into shape by applying forces to it. Because the materials in the solid state, the forces required are high and for this reason, metals with very high yield stresses are deformed hot. However, many commonly used metals can be deformed at room temperature eliminating the need for expensive heating equipment. The most well known deformation processes are forging, rolling and extrusion, which can produce components of a variety of shapes. Forming sheets into various shapes is also a type of deformation processes. Cold forming gives a better surface finish than hot forming and cold-formed parts generally have a higher yield strength than those that are hot-formed because the work hardening is retained.

Demarest Process

A fluid forming process in which cylindrical and conical sheet metal parts are formed by a modified rubber bulging punch. The punch, equipped with a hydraulic cell, is placed inside the workpiece, which in turn is placed inside the die. Hydraulic pressure expands the punch.

Details

Individual parts of the die. Also known as steels, sections, die sections, and back-ups.

Developed Blank

A sheet metal blank that yields a finished part without trimming or with the least amount of trimming.

Die

Tool with a void or cavity that is precisely fitted to a punch used to solid, molten, or powdered metal primarily because of the shape of the tool itself. Die-casting and powder metallurgy dies are sometimes referred to as molds.

Die Ad

A movable plate or pad in a female die; usually used for part ejection by mechanical means, springs, or fluid cushions.

Die Aid

See skin or cast.

Die Assembly

The parts of a die stamp or press that hold the die and locate it for the punches.

Die Block

A block, often made of heat treated steel, into which desired impressions are machined or sunk and from which closed die forgings or sheet metal stampings are produced using hammers or presses. In forging, die blocks are usually used in pairs, with part of the impression in one of the blocks and the rest of the impression in the other. In sheet metal forming, the female die is used in conjunction with a male punch.

Die Button

See button.

Die Cavity

The machined recess that gives a forging or stamping its shape.

Die Clearance

Amount of space between the punch and die opening.

Die Cushion

A large pressurized cylinder, generally housed beneath the bed of a press used to apply upward pressure to the lower die. The die cushion is actuated by air, oil, rubber, springs, or a combination of these.

Die Cut Inserts

Packaging elements, generally of cardboard, which are machine blanked to a specific shape in order to precisely fit a part contour.

Die Height

The distance from the finished top face of the upper shoe to the finished bottom face of the lower shoe immediately after the die operation and with the work in the die.

Die Holder

A plate or block, on which the die block is mounted, having holes or slots for fastening to the bolster plate or the bed of the press.

Die Hooks

See turnover.

Die Impression

The portion of the die surface that shapes a forging or sheet metal part.

Die Life

The productive life of a die impression, usually expressed as the number of units produced before the impression has worn beyond permitted tolerances.

Die Line

A line or scratch resulting from the use of a roughened tool or the drag of a foreign particle between tool and product.

Die Lubricant

In forging or forming, a compound that is sprayed, swabbed, or otherwise applied on die surfaces or the workpiece during the forging or forming process to reduce friction. Lubricant also facilitate release of the part from the dies and provide thermal insulation. See also lubricant.

Die Maker's Friend or Helper

See profile grinder.

Die Marks

Scratches, scrub marks, indentations, galling or burnishing of sheet metal workpieces by tooling.

Die Match

The alignment of the upper (moving) and lower (stationary) dies in a hammer or press. An allowance for misalignment (or mismatch) is included in forging tolerances.

Die Post

Lower section of die on which the part nests. Also called an adapter, boss, horn, locator, master, master plug, and stool. Guide post where wear plates are attached.

Die Proof (Cast)

A casting of a die impression made to confirm the accuracy of the impression.

Die Radius

The radius on the exposed edge of a deep drawing die, over which the sheet flows in forming drawn shells.

Die Set

The assembly of the upper and lower die shoes (punch and die holders), usually including the guide pins, guide pin bushings, and heel blocks. This assembly takes many forms, shapes, and sizes and is frequently purchased as a commercially available unit. Two (or, for a mechanical upsetter, three) machined dies used together during the product of a die forging.

Die Shoes

The upper and lower plates or castings that constitute a die set (punch and die holder). Also a plate or block upon which a die holder is mounted, functioning primarily as a base for the complete die assembly. This place or block is bolted or champed to the bolster plate or the face of the press slide.

Die Space

The maximum space (volume), or any part of the maximum space, within a press for mounting a die.

Die Stamping

The general term for a sheet metal part that is formed, shaped, or cut by a die in a press in one or more operations.

Differential Coatings

Coatings on flat rolled products where the thickness the coating on the one side is heavier than the other side.

Dimension

A measurement describing size and/or appearance of a part feature.

Dimensional Tolerance

A range by which a product's width and gauge can deviate from those ordered and still meet the order's requirements. Also see commercial tolerance.

Dimpling

The stretching of a relatively small, shallow indentation into sheet metal. In aircraft/aerospace industries, the stretching of metal into a conical flange for a countersunk head rivet.

Dings

A small unwanted mark or dimple in a completed part. These are usually caused by dirt or material in the die.

Distortion:

Any deviation from a desired contour or shape.

Doctor Blade Steel Strip:

A hardened and tempered spring steel strip, usually blued, produced from approximately 0.85 carbon cold rolled spring steel strip specially selected for straightness and good edges. Sometimes hand straightened or straightened by grinding and cut to desired lengths. This product is used in the printing trade as a blade to uniformly remove excess ink, caged dope, from the rolls providing the origination of the name.

Dog Leg Cam

A cam attached to the upper half of the die with a driver on the bottom half of the die. Also called an aerial cam, flying cam, or walking cam.

Dog Leg Driver

A cam driver designed to ensure positive cam-slide travel in both directions.

Dope

A drawing compound used to lubricate the stock during a forming operation.

Double Burned

A condition that may occur on a laser wherein the laser essentially produces a feature twice destroying the part's edge and causing out of dimension condition.

Double-Action

Press utilizing two moving elements.

Double-Action Die

A die in which pressure is first applied to a blank through the blank holder and is then applied to the punch.

Double-Action Mechanical Press

A press having two independent parallel movements by means of two slides, one moving within the other. The inner side or plunger is usually operated by a crankshaft and the outer or blank holder slide, which dwells during the drawing operation, is usually operated by a toggle mechanism or by cams. See slide, triple action press.

Double-Action Press

Same as double action mechanical press that is run automatically.

Dowel

A round pin, usually case hardened, that fits into a corresponding hole to align two die members.

Dowel Puller

A weight that slides along a rod with a head on one end and threads on the other end that is normally used to pull dowels and details. This weight and rod combination is commonly called a dowel puller. See slide hammer.

Draft

The taper given to a die so as to allow the part to fall through the die or be removed.

Drain Holes

Holes placed in the part that are nonfunctional except to allow for drainage.

Draw

See drawing, deep drawing.

Draw Bead

An insert or rib-like projection on the draw ring or hold-down surfaces that aids in controlling the rate of metal flow during deep draw operations. Draw beads are especially useful in controlling the rate of metal flow in irregularly shaped stampings.

Draw Die

A specific type of form die that basically involves forcing the flat sheet of metal into a die cavity with a punch while holding the workpiece around the cavity to control metal flow.

Draw Die Punch

A punch that is tied to the press ram.

Draw Line

See impact line.

Draw Marks

Impressions such as scratches, burnished areas, and similar marks left on the surface of the workpiece, part, or panel by a draw die. Also called skid marks.

Draw Plate

A circular plate with a hole in the center contoured to fit a forming punch used to support the blank during the forming cycle.

Draw Radius

The radius at the edge of a die or punch over which sheet metal is drawn.

Draw Ring

Holding device in a die to control material flow and wrinkling during forming. Also referred to as a binder.

Drawability

A measure of the feasible deformation of a blank during a drawing process. A measure of the percentage of reduction in diameter of a blank when it is drawn to a shell of maximum practical depth. The general formability and ductility of a metal.

Drawing

Sheet metal that has been mechanically formed by use if tension though a die or in a die

Driver

A block with one or more angular surfaces that applies force by the vertical movement of the press to mating a r surfaces on a cam slide

Ductility

A qualitative, subjective, property of material that indicates the extent that it can be deformed without fracture in normal metal working operations such as rolling, extrusion, or fabrication.

Dutch Bend

See hem.

Dutchman

A unshaped device for tying sections of dies together either by design or to repair a die which has been broken.

Dwell

Portion of a press cycle during which the movement of a member is zero or at least insignificant. Usually refers to the interval when the blank holder in a drawing operation is holding the blank while the punch is mating the draw or the interval between the completion of the forging stroke and the retraction of the ram.

Dwell Cam

A term used for a variety of forming operations, such as deep drawing a sheet metal blank; redrawing a tubular pat; and drawing rod, wire, and tube. The usual drawing process with regard to sheet metal working in a press is a method for producing a cup-like form from a sheet metal disk by holding it firmly between blank holding surfaces to prevent the formation of wrinkles while the punch travel produces the required shape. In metal forming, the stretch rig or compressing of a sheet metal part into a die by a punch to create a 3-dimensional part. The process of cold forming a flat pre-cut metal blank into a hollow vessel without excessive wrinkling, thinning, or fracturing.

Drawing Compound

A substance applied to prevent pickup and scoring during deep drawing or pressing operations by preventing metal-to-metal contact of the workpiece and die. Also known as die lubricant.

Drawing Quality (DQ)

Draw quality steel that is a more flexible grade of steel. Flat-rolled products produced from either deep drawing rimmed steel or extra deep drawing aluminum killed steels. Special rolling and processing operations aid in producing a product that can withstand extreme pressing, drawing or forming, without creating defects.

Drawn

A process where material is mechanically formed by tension through or in a die.

Drawn Sheet

E

Earing

The formation of ears or scalloped edges around the top of a drawn shell, resulting from directional differences in the plastic-working properties of rolled metal with, across, and at angles to the direction of rolling.

Eberly Screw

A socket head cap screw with the head and the upper portion of the body turned down, leaving a minimum number of threads on the end of the body. Used where the screw hole in the detail does not align with the threaded hole in the mounting surface. Same definition as for Chicago screws or Kelly screws.

Eccentric

The offset portion of the driveshaft that governs the stroke or distance the crosshead moves on a mechanical or manual shear.

Eccentric Press

A mechanical press in which an eccentric, instead of a crankshaft, is used to move the slide.

Edge

A transit between surfaces.

Edge Bulge

Condition resulting from any forming, piercing, hardware insertion or spot welding operation too dose to an edge.

Edge Deckle (Mill Edge

Waviness of an unslit coil edge, as received from the material supplier.

Edge Pucker

Material extrusion beyond an outside edge through metalforming.

Edger (Edging Impression)

The portion of a die impression that distributes metal during forging into areas where it is most needed in order to facilitate filling the cavities of subsequent impressions to be used in the forging sequence.

Edge-to-Feature

A dimension between the edge of the part and a feature.

Edging

The dressing of metal strip edges by rolling, filing or drawing.

Effective Draw

The maximum limits of forming depth that can be achieved with a multiple action press that is sometimes called maximum draw or maximum depth of draw.

Electing

The removing of a part from a die by an air blast or mechanical means.

Ejector

A mechanism for removing a part from a die. Also called kicker or knockout.

Ejector Rod

A rod used to push out a formed piece.

Elastic Deformation

Stretching of the material below the point at which a permanent set takes place. That is, in the range where the metal acts spring-like or elastic.

Elastic Instabilities

A section of a part that has two equilibrium positions and can be manually switched between each position. Elastic instabilities are created when a highly deformed area is constrained on all sides by regions of less deformed areas. Elastic instabilities are also referred to as oil canning.

Elastic Limit

The maximum stress a material can sustain without any permanent strain (deformation) remaining upon complete release of the stress. See also proportional limit.

Elasticity

The property of a material by which the deformation caused by stress disappears upon removal of the stress. A perfectly elastic body completely recovers its original shape and dimensions after the release of stress.

Electrode

A consumable used in the welding process. The electrode carries the current between the electrode holder and the base material. In metal arc welding it is usually a consumable electrode which also supplies filler material for the weld.

Electrolytic Galvanized

Cold rolled or black plate to which a coating of zinc is applied by electro-deposition and typically used for applications in which corrosion resistance and paintability is a primary concern.

Electrolytic Tin Coated Sheets (ETCS)

Cold rolled sheet coated with tin by electrodeposition through an acid or alkaline

Electromagnetic Forming

A process for forming metal by the direct application of an intense, transient magnetic field. The workplace is formed without mechanical contact by the passage of a pulse of electric cur-rent through a forming coil. Also known as magnetic pulse forming.

Electron Beam Welding (EBW)

Melting and fusing of metals by use of a collimated stream of elections traveling at close to the speed of light. The kinetic energy from the electrons converts to heat on impact.

Elephant Ears

Cast or welded projections in the shape of an ear on the outboard section of a die. They are used for handling the die with chains.

Elongation

The amount of permanent extension of the material before it fractures. Elongation takes place in the part during forming or drawing operations. See also elongation percent.

Elongation, Percent

The extension of a uniform section of a specimen expressed as a percentage of the original gage length: Elongation=(Lx−Lo)/Lo×100 Where Lo is the original gage length and, Lx is the final gage length.

Emboss

A relatively shallow indentation or raised design with basically no change in metal thickness.

Embossing

A process for producing raised or sunken designs or relief in sheet material by means of male and female dies, theoretically with no change in metal thickness or by passing sheet or a strip of metal by passing between rolls of desired pattern. (See patterned or embossed sheet). Examples are letters, ornamental pictures, and ribs for stiffening. Heavy embossing and coining are similar operations.

Embossing Die

A die used for producing embossed designs.

Enclosed Scam and Pocket

Formed, spot welded or welded area that can entrap plating solutions.

End Flare

Seen after cut off, caused by the release of residual forming stresses in material being roll formed where one longitudinal end springs open and the other springs closed.

Environmental Testing

Testing of a product or finish for resistance to attack by specific elements.

Equalizer Pins

A pin used in conjunction with pressure pins to distribute and balance the load on a die cushion. These are also called balancing pins.

Erichsen Test

A cupping test used to assess the ductility of sheet metal. The method consists of forcing a conical or hemispherical-ended plunger into the specimen and measuring the depth of the impression at fracture.

Explosive forming

The shaping of metal parts in which the forming pressure is generated by an explosive charge. See also high-energy-rate forming.

Extractor

A mechanism attached to a press for removing a part from a die. Also called an iron hand.

Extruded Hole

Pierced and formed hole in sheet metal in which the metal has been stretched creating a tubular shape.

Extruding

The turning up or drawing out of a flange around a hole which has been punched in a previous operation. Also called hole flanging. The punching and flanging of a hole in one operation generating a slug. The cutting or tearing (piercing) and flanging of a hole in one operation without generating a slug. Also called spearing or spear punching.

Extrusion

A metal forming process which a punch compresses a billet (hot or cold) confined in a container so that the billet material flows through a die in the same direction as the punch.

Eye Bands

Metal bands wrapped through the center or eye of the coil to prevent it from uncoiling and to hold strip mults together.

Eyeholing

A coating defect, similar to cratering, but with exposed metal in the void.

Eyeleting

The displacing of material about an opening in sheet or plate so that a lip protruding above the surface is formed.

L|M|N|O|P|Q|R|S|T|U|V|W|XYZ

Fabrication

A number of metalworking techniques that allow a part to be assembled from smaller components. Welding, adhesive bonding and fastening by the use of bolts and rivets are the most widely used examples.

Factor

A factor is a rib-like projection on a draw ring or blank holder for controlling metal flow. It is also called a spleen or bead.

Feather Edge

A sharp reduction in gauge, metal thinning, on a band edge caused by grooves worn in rolls due to extensive rolling of the same width material that create a knife edge appearance. This is done for coating control on edge.

Feature-to-Feature

Dimension between two features on a part.

Feed

See progression.

Feed Eccentric

A screw adjusted device used to set the feed length on a slide forming machine.

Feed Unit

An integral part of the slide forming machine, eccentric-driven and cam controlled, that advances either wire or strip in accurate increments.

Female Tool

A mold duplicating the exterior dimensions of the part.

Ferritic

Referring to iron content.

Ferro Magnetic

Various alloys that exhibit magnetic qualities.

Ferrous

Metals containing iron as a major alloying constituent.

Fill Slide

See filler cam.

Filler Cam

A dwell type cam slide that generally fits the part shape and retracts to permit loading and unloading of the part. Also called fill slide.

Fillet

The concave intersection of two surfaces.

Fillet Weld

Joining method of filling an inside edge with welding metal.

Final Hem Contact Path

Angle between a line (formed by a point on the final hem steel at fast contact with flange to the same point at end of final hem) and the mating surface.

Final Hem Dwell

Duration of time which the final hem steel stay at final hem position.

Final Hem Face Geometry

Angle of the final hem steels measured relative to the mating flange area.

Final Hem Force

Maximum force required to bend flange from pre hem position to final hem position.

Final Hem Springback

Elastic recovery that follows plastic deformation when the final hem load is removed.

Final Hem Steel

Hardened steels mounted to the hemmer to bend the flange from pre-hem angle to final hem.

Finish

The surface appearance of a product. The forging operation in which the part is forged into its final shape in the finish die. If only one finish operation is scheduled to be performed in the finish die, this operation will be identified simply as finish; first, second, or third finish designations are so termed when one or more finish operations are to be performed in the same finish die.

Finish Form

The act of forming a panel shape to the finish position. Also see restrike.

Finishes

The texture of the steel surface which is determined by the grit on the rolls or by the grind on the rolls in the case of bright finish.

Finite Element Method (FEM)

A method of analysis developed for prediction, practical forming of the instantaneous velocities, strain rates, strains, stresses and temperatures within the deforming metal.

Fire Cracks

An irregular pattern of lines on the surface of a sheet caused by rolling with a fire cracked roll. Fire cracks will develop when a roll is not properly cooled.

Fish Eyes

A coating defect consisting of undissolved particles in the coating usually surrounded by a circular crater. The particles are usually resinous and are raised up from the cured surface with the appearance of the eye of a fish.

Fit-Up

Degree of physical match between two or more components.

Fixture

Tooling designed to locate and hold components in position.

Flange

A projecting rim or edge of a part, usually narrow and of approximately constant width for stiffening or fastening.

Flange Die

Die used to form a flange form a blank.

Flange Inside Breakline Radius

Inside of metal radius of the upturned flange of the outer panel formed by the flanging process over the flange die corner radius.

Flange Inside of Metal Breakline

Midpoint of the inside of metal breakline radius.

Flange Outside Breakline Radius

Outside of metal radius of the upturned flange of the outer panel formed by the flanging process. It is equivalent to the sum of the inside breakline radius and the sheet metal thickness.

Flange Outside of Metal Breakline

Midpoint of the outside of metal breakline radius.

Flange Relief

Flange material that has been cut to allow flange to lay flat after final hem.

Flange Steel

A steel used in a forming operation in which a narrow strip at the edge of a sheet or part is bent down along a straight or curved line. Also called a wiping steel.

Flange Stripper

A stripper that pushes against the bottom edge or surface of a flange to release the part from the stool.

Flanging

A variable that is intentionally changed in a controlled manner during an experiment to observe its effects on the response variable, sometimes called an independent variable or causal variable.

Flanging Springback

Elastic recovery that follows plastic deformation when the flanging load is removed.
top|▴|
   Flash

The excess metal attached to a part after a forming operation. Also, the excess materials that squeezes out between the joint lines of mold dies.

Flat (or Matte)

Coating surface which displays no gloss when observed at any angle. A perfectly diffused surface.

Flat Latch Needle Galling

The damaging of one or both metallic surfaces by removal of particles from localized areas due to seizure curing sliding friction.

Flat Pattern

A two-dimensional development that represents the part before it is formed into a three dimensional shape.

Flat Rolled Steel

Steel produced on rolling mills utilizing relatively smooth, cylindrical rolls. The with to thickness ratio of flat rolled products is usually fairly large. Examples of flat rolled steel products are hot-rolled, cold-rolled, and coated sheets and coils, plus tin mill products.

Flat Surface Contour

Curvature with no radius.

Flatness

The absence of any gap or clearance when a strip is placed, without applying any pressure, between two parallel-faced plates.

Flattened Hem

A flange that is folded back over upon itself. It is used primarily for appearance and removal of dangerous sheared edges. Also called closed hem.

Flattening Dies

Dies used to flatten sheet metal hems; that is, dies that can flatten a bend by closing it. These dies consist of a top and bottom die with a flat surface that can close one section (flange) to another (hem, seam).

Flex Roll

A movable roll designed to push up against a sheet as it passes through a roller leveler. The flex roll can be adjusted to deflect the sheet any amount up to the roll diameter.

Flex Rolling

Passing sheets through a flex roll unit to minimize yield-point elongation in order to reduce the tendency for stretcher strains to appear during forming.

Floating Die

A die mounted in a die holder or a punch mounted in its holder such that a slight amount of motion compensates for tolerance in the die parts, the work, or the press. A die mounted on heavy springs to allow vertical motion in some trimming, shearing, and forming operations.

Floating Fastener

Hardware which allows the threaded portion to move within its particular confines without rotating, to compensate for misalignment.

Floating Form Punch

A draw die punch that is supported by air cylinders or other means instead of being tied to the inner press ram. This allows adjustment for the amount of preform desired and helps to eliminate binding between the punch and the die.

Flow Lines

Texture showing the direction of metal flow during hot or cold working. Flow lines can often be revealed by etching the surface or a section of a metal part.

Flower Diagram

A drawing which superimposes the cross section contour of a roll formed part at each roll station, starting with the flat incoming material and ending with the desired profile. It depicts the anticipated flow of material in the forming process.

Fluid Forming

A modification of the Guerin process, fluid forming differs from the fluid-cell process in that the die cavity, called a pressure dome, is not completely filled with rubber, but with hydraulic fluid retained by a cup-shaped rubber diaphragm. See also rubber-pad forming.

Fluid-Cell Process

A modification of the Guerin process for forming sheet metal, the fluid-cell process uses higher pressure and is primarily designed for forming slightly deeper parts, using a rubber pad as either the die or punch. A flexible hydraulic fluid cell forces an auxiliary rubber pad to follow the contour of the form block and exert a nearly uniform pressure at all points on the workpiece. See also fluid forming and rubber-pad forming.

Fluting

Series of rounded parallel grooves that shows on the surface of metals.
top |▴|
   Flying Cam

A cam attached to the upper half of the die with a driver on the bottom half of the die. Also called an aerial cam, dog leg cam, or walking cam.

Flying Die Cutoff

The system used in roll forming to cut the formed shape to length in a continuous operation. Similar in action to a punch press, but designed to allow the die to move in line with the roll formed shape during the cutoff cycle, and to make a cut on the fly based on a signal from a trigger mechanism.

Flying Cut-Off Device

A cutting die, saw, or wheel that cuts work to length while it is moving.

Flying Shear

A machine for cutting continuous rolled products to length that does not require a halt in rolling, but rather moves along the runout table at the same speed as the product while performing the cutting, and then returns to the starting point in time to cut the next piece.

Foil

Metal in sheet form that is less than 0.15 mm (0.006 in.) thick.

Folds

Defects caused in metal by continued fabrication of overlapping surfaces.

Follow Die

A progressive die consisting of two or more parts in a single holder, used with a separate lower die to perform more than one operation (such as piercing and blanking) on a part in two or more stations.

Follower Block (Tail Block)

This serves to clamp the workpiece to the tool.

Form

A bend, or the process of bending a metal formed part.

Form Block

Tooling, usually the male part, used for forming sheet metal contours. Form blocks are generally used in rubber-pad forming.

Form Die

A die used to change the shape of a sheet metal blank with minimal plastic flow.

Form Lifter

A cam-operated motion used for lifting the mandrel or forming in an opposite plane.
top|▴|
   Formability

The ease with which a metal can be shaped though plastic deformation. Evaluation of the formability of a metal involves measurement of strength, ductility, and the amount of deformation required to cause fracture. The term workability is used interchangeably with formability; however, formability refers to the shaping of sheet metal, while workability refers to shaping materials by bulk forming.

Formed

A material, metal for this purpose, has undergone plastic deformation between tools (dies) to obtain the final configuration.

Formed Tab

Small flange bent at an angle from the body of a metal workpiece.

Forming

The plastic deformation of a billet or a blanked sheet between tools (dies) to obtain the final configuration. Metalforming processes are typically classified as bulk forming and sheet forming. Also referred to as metalworking. Making any change in the shape of a metal piece which does not intentionally reduce the metal thickness and which produces a useful shape.

Forming Die

A die in which the shape of the punch and die is directly reproduced in the metal with little or no metal flow.

Forming Limit Diagram (FLD)

A bending operation in which a narrow strip at the edge of a sheet is bent up or down along a straight or curved lin. It is used for edge strengthening, appearance, rigidity and the removal of sheared edges. A flange is often used as a fastening surface.

Forming Slides

Can operated units used to drive tools on a slide forming machine.

Forming Tool

A slide mounted tool used for bending on a slide forming machine.

Form-To-Form

Dimension between two forms on a part.

Footage of Coil

The length of the steel strip that makes up a coil.

Fourslide Machine

A machine, either horizontal or vertical, used to fabricate formed metal stampings, and wire forms, by the action of four forming slides acting upon a stationary mandrel or center tool.

Fracture

The surface appearance of metals when they are broken.

Free-Shoe Die

A die constructed so the upper shoe is linked to the lower shoe and not secured in any way to the press ram. Used for blanking or secondary cutting operations. Also called bumper-actuated die.

French Cut/French Notch

A notch usually cut on one side of a stock strip in a progressive die to control stock width and progression of the stock. See pitch notch.

Friction Gouges or Scratches

A series of relatively short surface scratches variable in form and severity. See galling.

Front Cut-Off

A device driven by a cam that is mounted on the front shaft on a slide forming machine used to severe the blank from the strip before forming.

Functionality

The degree to which the designed part will perform to meet its intended purpose.

Fuse Welded Joint

Welding method without addition of a filler metal that is used to generate little, if any, eruption above the original surface level.

The thickness of sheet or the diameter of wire. The various standards are arbitrary and differ with regard to ferrous and non-ferrous products as well as sheet and wire. An aid for visual inspection that enables an inspector to determine more reliably whether the size or contour of a formed part meets dimensional requirements. The ability of a material to under go plastic deformation without fracture. A device used to position work in a die accurately. Another name for a checking fixture which is used to check parts. See gauge

Gage Pin

A round gage normally used to position work from the edge of the part.

Galfan

A galvanized product coated with 95% free 5% aluminum and traces of mish metal in the coating; provides extra corrosion protection with lighter coating weight, has improved formability over regular free zinc coatings (hot dipped galvanized regular products).

Galling

The damaging of one or both metallic surfaces by removal of particles from localized areas due to seizure curing sliding friction. See also scoring.

Galvaneal Coating

Coatings on hot-dipped galvanized steels processed to convert the coating completely to zinc-iron alloys. They are dull gray in appearance, have no spangle, and are after proper preparation, are well suited for painting.

Galvanize Coatings (G)

Free zinc coatings applied to a hot rolled or cold rolled steel to produce Galvanized steel. The coating can be applied by the hot-dip or electrodeposition process.

Galvannealed

An extra tight coat of galvanizing metal (zinc) applied to a soft steel sheet, after which the sheet is passed through an oven at about 1200° F. The resulting coat is dull gray without spangle that is especially suited for subsequent painting.

Gang-Die

A series of dies mounted on a die plate.

Ganaged

See nesting.

Gap-Frame Press

A general classification of press in which the uprights or housings are made in the form of a letter C, making three sides of the die space accessible. See C-frame press.

Gas Cylinder

A gas charged cylinder used in place of springs or die cushions in applications in which high initial pressure is required. Also called nitrogen die cylinder, nitro-dyne cylinder, and hyson cylinder.

Gas Metal Arc Welding (GMAW)

See MIG weld.

Gas Tungsten Arc Welding (GTAW)

See TIG weld.

Gas Welding

Melting and fusing metals together by use of an oxygen and flammable gas mixture.

Gauge

Instrument for measuring, testing, or registering. Numeric scale for metal thickness. See gage.

Gauge Tolerance

A range by which a product's gauge can deviate from those ordered and still meet the order's requirements.

Gibs

Guides or shoes that ensure the proper parallelism, squareness, and siding fit between press components such as the slide and the frame. They are usually adjustable to compensate for wear and to establish operating clearance.
top|▴|
   Go/No-Go Gauge

Measuring device with two registration elements which determine if a feature to be measured is between two established limits.

Gouge

Surface imperfection, deeper than a scratch, often with raised edges.

Grain

Refers to grain fiber following the direction of rolling and parallel to edges of metal strip or metal sheets. In steel, the ductility in the direction of rolling is almost twice that at right angles to the direction of rolling.

Grain Direction

Crystalline orientation of material in the direction of mill rolling. Orientation of a surface finish generated by abrasive method.

Grain Size

The average diameter of grains in the metal under consideration, or alternatively, the number of grains per unit area. Grain size is a significant issue since an increase in grain size is accompanied by lower ductility and impact resistance. The addition of certain metals to steel affects grain size. Vanadium and aluminum tend to give steel a fine grain when added. The ASTM has set up a grain size standard for steels.

Grid Analysis

A process used to measure the mechanical properties of a sheet metal part during a forming operation.

Grinding

Process of removing material by abrasion.

Grippers

Material clamping devices often serrated for additional holding force to restrain material during a die operation.

Ground Flat Stock

Annealed and preground (to close tolerances) tool steel flats in standard sizes ready for tool room use. These are three common grades; water hardening, oil hardening and air hardening quality.

Growing (Grow)

The outward change in outer panel size that occurs during the hemming process.

Guerin Process

A rubber-pad forming process for forming sheet metal.

Guide Pin

Pin or post usually fixed in the lower shoe and accurately fitted to bushings in the upper shoe to insure precise alignment of the two members of a die set. Also called a guide post, rider pin, or leader pin.

Guide Pin Bushing

A replaceable insert normally in the upper shoe to provide accurate alignment of both upper and lower die shoes. Also called bushing, guide post bushing, or rider pin bushing.

Guide Post

See guide pin.

Guide Post Bushing

See guide pin bushing.

Half-Hard Temper

Cold rolled steel produced to a Rockwell hardness range of 70 to 85 on the B scale. Product of this temper is intended for limited cold forming and will only withstand 90° bends made across the rolling direction.

Half Shearing

A partial penetration piercing, creating a locating button with a height of about ½ material thickness.

Hammer Steel

See hem steel.

Handling Core

Cast cores in upper and lower shoes used for handling purposes.

Handling Hook

See turnover.

Handling Ring

A device bolted to the side of a mold die for handling of the mold.

Hard tooling

Tooling made for a specific part commonly referred to as dedicated tooling.

Hardened and Tempered Spring Steel Strip

A medium or high carbon quality steel strip which has been subjected to the sequence of heating, quenching and tempering.

Hardening

Any process which increases the hardness of a metal. Usually heating and quenching certain iron base alloys from a temperature either within or above the critical temperature range.

Hardness

The degree to which a metal will resist cutting, abrasion, penetration, bending and stretching. The indicated hardness of metals will differ somewhat with the specific apparatus measuring hardness. (See Brinnell Hardness, Rockwell Hardness, Vickers Hardness, Scleroscope Hardness). Tensile strength also is an indication of hardness.

Hardware

Fasteners inserted into a sheet metal part.

Hardware List

Information that should be conveyed to the part supplier specifying part numbers, description and quality of fasteners.

Hartmann Lines

Long vein-like marks appearing on the surface of certain metals, in the direction of the maximum shear stress, when the metal is subjected to deformation beyond the yield point. See Luders lines.

Heat Treating

Subjecting metals to heat treatment.

Heat Treatment

Heating and cooling a solid metal or alloy in such a way that desired structures, conditions or properties are attained. Heating for the sole purpose of hot working is excluded from the meaning of this term. Heat treatment usually markedly affects strength, hardness, ductility, malleability, and similar properties of both metals and their alloys.

Heavy Coating

A condition caused by too much coating being applied to the strip.

Heavy Gauge

Product with a thickness above the customer's maximum gauge tolerance.

Heavy/Light Gauge

Steel plate that deviates both plus and minus by not meeting customer gauge specifications.

Heel Block

A block or plate usually mounted on or attached to a lower die and serving to prevent or minimize deflection of punches or cams. When heel blocks are used with a mating heel post, this assembly can be used alone or in conjunction with guide pins that help align the die to prevent damage when the press ram has too much play.

Heel Plate

A wear plate used on the heel block. See also wear plate and heel block.

Heel Post

A male member that has either a machined wear surface or wear plates mounted to it that mates with a heel block. It is incorporated in dies to hold the die alignment and absorbs lateral pressures produced within the die.

Hem (Also Called Dutch Bend)

Edge of material doubled over onto itself for the purpose of safe handling or to increase edge stiffness.

Hem Die

Die used in hemming.

Hem Die Plus

The amount of stock added to a part in an area to be hemmed to compensate for the amount the part reduces m size along the flange radius when hemmed. Also see creep.

Hem Edge Roll

When the outer panel rolls up off of the hem die during the hemming process.

Hem Flange Split

Usually observed in concave edge and concave surface flanging and hemming.

Hem Length

The length of the flange after final hemming.

Hem Out

Usually observed with wrinkling after flanging or pre-hemming. Severe wrinkles in convex edge hemming may develop hem-out.

Hem Steel

The steel in a hem die that finishes and flattens the hem. Also called hammer steel.

Hemming

A bend of 180° (made in two steps). First, a shape-angle bend is made and then the bend is closed using a flat punch and a die.

Hemming Die

A die which folds the edge of the part back over on itself. The edge may or may not be completely flattened to form a closed hem.

Herf

A common abbreviation for high-energy-rate forming.

High Collar Lock Washer

A special type of lock washer that is thicker than standard and smaller in diameter than standard. Designed to fit in a standard counterbored hole for a socket head cap screw.

High-Energy-Rate Forming

A group of forming processes that applies a high rate of strain to the material being formed through the application of high rates of energy transfer. See also explosive forming.

High Rockwell

A condition that occurs when the hardness of the steel is above the maximum limit as specified by the customer. See Rockwell hardness.

Hoist ring

See swivel ring.

Hold Down

An object used to secure a workpiece.

Hold-Down Marks

Slight indentations or scuff marks on one side of the stock which can result from the pressure of hold down devices during shearing operations.

Hold-Down Plate (Pressure Pad)

A pressurized plate designed to hold the workpiece down during a press operation. In practice, this plate often serves as a stripper and is also called a stripper plate.

Hole Diameter

Units: mm (SI). inch (Imperial) The minimum hole diameter which can be created by the process. Casting, stamping and molding impose limits on minimum hole size which can be overcome by creating the holes with a secondary process such as drilling or laser cutting.

Hole Flanging

The forming of an integral collar around the periphery of a previously formed hole in a sheet metal part. See extruding.

Hole Rollover

Rounding of the top edge of a pierced feature caused by the ductility of the metal, which flows in the direction of the applied force.

Hole-to-Feature

Dimension between the center of a hole and another feature.

Hole-to-Form

Distance from the center line of a hole to the edge of a formed feature.

Hole-to-Hole

Dimension between the centers of holes.

Homing the Die

Adjusting press ram/slide so die is on bottom or on the stop blocks at the bottom of the press stroke. Also called bottoming the die.

Homogenizing

An annealing treatment at a fairly high temperature designed to eliminate or reduce chemical segregation.

Hone

A fine grit stone used with a fluid for sharpening or smoothing a surface. Also see superior hone.

Hone Bucket

A container which holds cleaning and lubricant fluids for wet hones. Also called minnow bucket.

Hooke's Law

A material in which the stress is linearly proportional to strain is said to obey Hooke's law. See also modulus of elasticity.

Horizontal Cam

A cam that travels 90° to press stoke. See straight cam.

Horn

Lower section of the die on which the part nests. Horns are also called an adapter, boss, die post, locator, master, master plug, and stool. The portion of the die or part that protrudes.

Hot Developing

The development of a blank or part during the tryout of the die.

Hot Rolled Sheets

Manufactured by hot rolling slabs to the required thickness. Steel which was rollerformed from a hot plastic state into final shape and is characterized by a rough, scaly surface.

Hot Shear

A term used for a quick fix of a trim steel that should only be done in an emergency situation. It is done by welding the steel and roughing it back close to the original surface. Next the steel is reheated until it becomes molten red and then the press is cycled to get the location of the mating surface. Die clearance must be added after this location is obtained.

Hydraulic Press

A machine that exerts working pressure by hydraulic means.

Hydraulic Press Brake

A press brake in which the ram is activated directly by hydraulic cylinders.

Hydraulic Shear

A shear in which the crosshead is actuated by hydraulic cylinders.

Hydraulic-Mechanical Press Brake

A mechanical press brake that uses hydraulic cylinders attached to mechanical linkages to power the ram through its working stroke.

Hydraulics

If energy transfer is in the form of pressurized liquid flow then it is called hydraulics. The oil is kept in a reservoir and the pump draws it in and pushes it into the system. Because the oils can't escape, pressure builds up and the energy stored in the oil is then used to operate machinery, using high pressure hoses, valves and actuators.

Hyson cylinder

I.S.M.

Acronym for inside metal.

Impact Extrusion Die

A piece of precision-made mass production tooling used to impact extrude aluminum drink cans, and steel engine valves, axles, budders' nails and high tile steel bolts.

Impact Line

A blemish on a drawn sheet metal part caused by a slight change in metal thickness. The mark is called an impact time when it results from the impact of the punch on the blank, it is called a recoil line when it results from transfer of the blank from the die to the punch during forming, or from a reaction to the blank being pulled sharply through the draw ring.

Impact Resistance

Ability to resist deformation from impact.

Impression

A mark produced on a surface by pressure during common metal forming operations.

Inboard Mill

A roll forming machine with a housing only on one end of the roll tooling shaft.

Inching

A control process in which the motion of the working members is precisely controlled in short increments.

Inclinable Press

A press whose main frame may be tilted backward, usually up to a 45° angle to facilitate ejection of parts by gravity through an open back.

Incline Cam

A cam that travels at an angle, other than 90° to the press stroke.

Inclusion(s)

Particle(s) of impurities (usually oxides, sulphides, or silicates) which separate from the liquid steel and are mechanically held during solidification. In some grades of steel, inclusions are made intentionally high to aid machinability.

Indexable Tool Stations

Special tool positions in a turret press which are equipped with numerically controlled servo drives rotating the punch and die together to profile contours, nibble angles or for other special applications.

Inner Panel Burr

This type of burr causes read (or bleed) through.

Inner Panel Read Through

Also called as bleed through. It could be caused by the burr on the inner panel edge or a sharp feature on the inner panel flange.

Inner Panel Thickness

Thickness of the panel.

Insert

A separate steel which is mounted upon or into another section to aid in ease of repair or to extend wearability. It may be of similar or dissimilar metal than parent metal.

Inserted Fastener

A variety of pins including nuts, studs, standoffs, or special hardware which are installed in a workpiece by inserting it into a specifically punched hole.

Inside of Metal Flange Length

Distance of the outer panel from the trim edge to the inside of metal in the mating flange area.

Inside of Metal Outer Panel (ISM)

Punch side of the panel side that comes in contact with inner panel.

Inside Radius

See bend radius. Normally defined as Ri.

Inspection Criteria

Characteristics by which the part will be evaluated both dimensionally and cosmetically.

Interaction

Maximum pressure, usually in tons on the punch during drawing.

Intermediate Temper

A cold rolled hardness range specified with a 15-point Rockwell B spread. See half-hard temper.

Inverted Die

A die in which the conventional positions of the male and female members are reversed.

Iron Hand

A mechanism attached to a press for removing a part from a die.

Ironing

An operation used to increase the length of a tube or cup through reduction of wall thickness and outside diameter, the inner diameter remaining unchanged while the surface is smoothed. Thinning the walls of deep drawn articles by reducing the clearance between punch and die.

ISO Drafting Standard

Regulation for the creation of technical drawings published by the International Organization of Standards.

J-Hook

A type of turnover shaped like a “J” for lifting or turning over dies or die sections. Also see turnover.

Jig

See fixture.

Jig borer

A machine to locate and machine holes accurately. Also called a locator.

Jog

See inching.

Joggle

An offset surface of two adjacent, continuous, or nearly continuous short radius bends of opposite curvature.

Join

IMIS action type indicating that parts of two or more coils have been combined to produce a single unit.

JP

Fully alloyed galvanneal product. Also referred to as the Jet-Process.

Julian Date

A free digit number designating the day of the year. Examples: January 15th has 015 as its Julian date. November fifteenth is 319. Julian dates are often used for stamping date on workpiece parts.

Jumbo Coil

A single coil produced by welding two or more coils.

K-Plate

Tin plate with superior corrosion resistance to mild acid food products.

Keeper

A block, pin, or spool used to retain the stripper plate or pad for the designed range of travel. A block used to retain cams.

Kellering

See contouring.

Kellering aid

A model, skin, cast, or template used on a hydro-tel or keller for the tracer.

Kelly Screws

A socket head cap screw with the head and the upper portion of the body turned down, leaving a minimum number of threads on the end of the body. Used where the screw hole in the detail does not align with the threaded hole in the mounting surface. Also called Chicago screws, Eberly screws, or rubber screws.

Key (External)

A block partially mounted in a pocket at the perimeter of a die member to locate, add support, and/or back up that die member. It is accessible without removing the die member.

Key (Internal)

A block mounted in mating pockets between two die members to locate and/or add support to those die members. It is not accessible without removing the die members.

Kicker

A mechanism for removing a part from a die. Also called an ejector or knockout.

Kidney

A bulge outside of the finish form area on a draw punch or cavity to take up loose metal or to help control the draw process. Also called bologna or sausage.

King Post

See mandrel.

Kiss Off

The area of two mating surfaces of a mold that determines the parting line.

Knockout

A mechanism for releasing workpieces from a die.

Lace

Area where the strip is joined together with wire or bands after being broken.

Lanced and Formed Tab

See formed tab.

Lancing

Cutting along a line in the workpiece without producing a detached slug from the workpiece.

Land

Sharpening land the reduced area of a die block or punch that is reground when sharpening is needed. Cutting land—see die life.

Lane-Strain

A deformation pattern which occurs when the minor strain is zero. This is the most critical strain state of a material and is typically the lowest point on a forming limit curve.

Lap

See superior hone.

Lap Weld

Coil ends are “lapped” over one another and welded, doubling the thickness of the steel at the weld and are then marked by a hole punch.

Lap-Welded Joint

Welded seam in which the two metal pieces to be joined overlap one another.

Laser Beam Cutting

A cutting process that severs material with the heat obtained by directing a laser beam against a metal surface. The process can be used with or without an externally supplied shielding gas.

Laser Welding

Metal melting and fusing using the energy of a concentrated coherent light beam.

Lead Hit (Lead Shear)

A method of determining the location of the cutting edge on a steel by building approximately one-fourth inch of lead on top of the cutting edge and shearing lead with mating steel. A method of checking how much space is between mating form or flange steels.

Lead Screw

Drive system which converts 1 rotary to linear motion.

Lead Time

Time required to manufacture a product from order placement until availability.

Leader Pins

Pin or a post usually fixed in the lower shoe and accurately fitted to bushings in the upper shoe to insure precise alignment of the two members of a die set. Also called a guide pin, guide post, or rider pin.

Leg Size

Within and height of the filler bead of welding material.

Leveler Lines

Lines on sheet or strip running transverse to the direction of roller leveling. These lines may be seen upon stoning or light sanding after leveling (but before drawing) and can usually be removed by moderate stretching.

Leveling

The flattening of rolled sheet, strip, or plate by reducing or eliminating distortions. See stretcher leveling and roller leveling. The process whereby a coil of steel is flattened through several sets of opposing rollers which first overbend the blank and then progressively bend to true flatness.

Leveling Blocks

Blocks used to control the shut height and levelness of a die in a spotting press Also called stand-off blocks.

Lever Arms

A scissor-like apparatus used to apply pressure to the spinning blank.

Lifter

A mechanism for raising a part in a die to a height for advancing it to another station, as in a progressive die, or for ejecting it from the die. Also incorrectly called a kicker or ejector.

Liftout

The mechanism also known as knockout.

Limiting Dome Height

The greatest depth that a material can withstand under the pure stretching of a hemispherical punch. This is a standard measurement of stretchability.

Limiting Draw Ratio (LDR)

The greatest ratio of blank diameter to punch diameter that can be successfully cup-drawn to a particular depth. This is a standard measurement of drawability. See deformation limit.

Line Dies

A sequence of stamping dies to perform operations for completing a part.

Linear Slide Machine

A vertical side forming machine with the ability to place several opposing slides arranged in a linear fashion on both the front and back sides of the tooling area providing the ability to produce complicated stampings as well as assemblies.

Lines

A straight line segment between two points.

Load Up

Accumulation and compaction of metal particles between the abrasive grit of a grinding belt disc or wheel rendering it ineffective.

Locating Pin

A pin or projection provided for locating work in a die from a previously punched hole. Also called a pilot pin.

Locator

Lower section of a die on which the part nests. Also called an adaptor, boss, die post, horn, master, master plug, and stool.

Lock Bead

A ridge constructed around a die cavity to completely restrict metal flow into the die.

Lock Seam Tube

A hollow (closed) roll form shape mechanically fastened using the roll form tooling.

Locking Bead

A bead or projection designed to prevent metal flow in a forming operation Also called lock spleen.

Loose Wrap

A coil that is not wound tight. Winding using too little tension causes this condition.

Low Profile Screw

A special socket head cap screw which has a head height approximately one-half that of a nominal socket head cap screw.

Low Spot

Generally, a local inboard condition on a panel which is usually in a high stress area. Also called birdbath or shadow.

Lubricant

Any substance interposed between two surfaces in relative motion for the purpose of reducing the friction and/or wear between them.

Louder Lines

Elongated surface markings or depressions, often visible with the unaided eye, that form along the length of a round or sheet metal tension specimen at an angle of approximately 55° to the loading axis. Caused by localized plastic deformation, they result from discontinuous (inhomogeneous) yielding. Also known as Luders bands, Hartmann lines, Piobert lines, or stretcher strains.

Luster Finish

Refer to finishes.

Machinability

The relative ease of machining a metal.

Machining

This is the group of processes in which a shape is generated by removing unwanted material. Machining can be used to make a component from stock material but more often it is used as a secondary process to impart a shape or a level of precision to a manufactured component that cannot be achieved otherwise. Shape restrictions exist for some machining processes.

Mahogany Stick

See spotting stick.

Malleability

The property that determines the ease of deforming a metal when the metal is subjected to rolling or hammering. The more malleable metals can be hammered or rolled into thin sheet more easily than others.

Mandrel

Usually a fixed tool on a slide forming machine that metal formed against by the action of a glide mounted form tool.

Manufacturability

The degree to which a product can be efficiently and accurately produced using modern manufacturing methods. See prototype.

Map

A simplified detail print or sketch usually showing just the location and sizes of holes in a detail or steel.

Manforming Process

A rubber-pad forming process developed to form wrinkle-free shrink flanges and deep-drawn shells. It differs from the Guerin process in that the sheet metal blank is clamped between the rubber pad and the blank holder before forming begins.

Marriage Gap

Space between the trim edge of the inner panel and the inside of metal of the outer panel flange before hemming.

Martensitic Stainless Steel

Select group of 400 or 500 Series stainless steels that are magnetic and hardenable by heat treating.

Masking

Temporary shielding of a portion of a product to selectively prevent the application of a coating.

Master

Lower section of a die on which the part nests. Also called a master plug, adapter, boss, die post, horn, locator, and stool. Section of die used to govern the form or contour of the mating die sectional. It is usually male shape or inside metal. Also, a wood model or die aid.

Master Adapter

Lower section of a die on which the part nests.

Master Die

Universal tool receptacle for holding changeable tool systems.

Master Plug

Lower section of a die on which the part nests.

Match

A condition in which a point in one die half is aligned properly with the corresponding point in the opposite die half within specified tolerance.

Material Utilization

Extent to which optimal use of material is approached. The material utilization is the mass-fraction of primary material entering the process which remains in the final product. It is measured on a scale of 0-1. Machining from solid leads to low material utilization. Near net-shape processes allow a utilization approaching 1.

Mating Flange Area

Area of inner panel covered by flange of outer panel.

Mating Surface

Area of inner panel that is in contact with outer panel.

Matte Finish

A dull or grit surface appearance achieved by rolling on rolls which have been roughened by mechanical, chemical, or electrical means to various degrees of surface texture.

Matte Surface

A dull surface appearance on a tin plate product; non-reflowed tinplate.

Maximum Dimension

Units: mm (SI) inch (Imperial). The largest dimension of a component which can be created by the process. In batch processes it is limited by the capacity of the machine, but it can be increased by joining. In cases where there is no defined limit, a cut-off of 10,000 mm has been used. Continuous processes like rolling, extrusion or wire-drawing have no real upper limit on length so, instead, maximum width is stored.

Maximum Elongation

It is the maximum engineering strain the material can take until fracture. Also called fracture strain. Shown as emax.

Master Strength

The maximum stress (tensile, compressive, or shear) a material can sustain without fracture; determined by dividing maximum load by the original cross-sectional area of the specimen. Also known as nominal strength or ultimate strength.

Measuring and Inspection Gauges

Precision-made mass production tooling used by semi-skilled factory workers to test and/or check mass produced components for conformance to engineering requirements and specifications, often to very high levels of dimensional and/or form accuracy.

Mechanical Assemblies

Part combinations attached by mechanical means through the use of hardware.

Mechanical Fastener

Device clamping two or more components together by mechanical force, such as rivets, screws, ere.

Mechanical Press

A forging press with an inertia flywheel, a crank and clutch, or other mechanical device to operate the ram.

Mechanical Press Brake

A press brake using a mechanical drive consisting of a motor, flywheel, crankshaft, clutch, and eccentric to generate vertical motion.

Mechanical Properties

Properties of a material that reveal the elastic and inelastic reaction when force is applied, or that involve the relationship between stress and strain such as the modulus of elasticity, tensile strength, and fatigue limit. These properties are oftentimes referred to as “physical properties”.

Mechanical Working

Plastic deformation or other physical change to which metal is subjected, by rolling, hammering, drawing, etc. to change its shape, properties or structure.

Metal

The material subjected to an operation of a forming class type. An elemental metal or alloy of metal mixture in a self-shape-sustaining state (this excludes molten, gaseous, or powdered).

Metal Arc Weld

Metal melting and fusing process using a continuous metal consumable electrode with an inert gas around the electrode to shield against oxidation.

Metal Clearance

The running clearance on bottom of press stroke between flange steels or male and female form steels.

Metal Forming

Solid metal and molten metal process such as casting, forging, stamping and machining.

Metal Thinning

Thickness reduction during any forming operation.

Metalworking

See forming.

Metameric Match

See conditional match.

Micro Ties

Thin bridges of metal which are left to hold parts in place during turret punch fabrication.

Midget Mill

See carburr.

MIG or MIG Weld

MIG stands for Metal Inert Gas welding and is often referred to as wire-feed welding. MIG welding is a commonly used high deposition rate welding process. During the welding process, wire is continuously fed from a spool. MIG welding is sometimes referred to as a semi-automatic welding process.

Mill

A factory in which metals are hot worked, cold worked, or melted and cast into standard shapes suitable for secondary fabrication into commercial products. A production line, usually of four or more stands, for hot or cold rolling metal into standard shapes such as bar, rod, plate, sheet, or strip. A single machine for hot rolling, cold rolling, or extruding metal.

Mill Edge

The edge of strip, sheet or plate in the as-rolled state. It is unsheared.

Mill Finish

A surface finish produced without being subjected to a special surface treatment (other than a corrosion-preventive treatment) after the final working or heat-treating step on sheet and plate.

Mill Product

Any commercial product of a mill.

Mill Scale

The heavy oxide layer that forms during the hot fabrication or heat treatment of metals.

Minimum Corner Radius

Units: mm (SI), inch (Imperial). The minimum radius of curvature at a corner that can be created by the process. Casting, stamping and molding impose limits on minimum corner radius.

Minnow Bucket

See hone bucket.

Model

Pre-production sample made with limited emphasis on tolerance to test a design concept. Also referred to as a prototype.

Modified Flat Hem

Modified flat hem is believed to create better reflection characteristics on the finished panel assembly.

### Modulus of Elasticity

The number that represents the relative springiness of a given type of metal. All steels have the same modulus of elasticity or springiness regardless of the tensile or yield strengths. That is, until the yield point is reached they all stretch the same amount for a given load.

Mold

A hollow form, matrix or cavity into which materials are placed to produce goods of desired shapes.

Mold Lines

Lines in a drawing connecting the inner radius and outer radius of a bend and showing the extent of bend.

Mult

A “mult” is the term used to describe the slitting of a coil into multiple smaller strips. If a coil is slit into strips less than 9″, each strip is referred to as a “mult” and does not receive an individual IPM number. Mults are not removed from the line individually, but as a whole coil unit.

Multiple Die

A die used for producing two or more identical parts at one press stroke.

Multiple Level Forming

A sequence of slide forming operations at different elevations of the center tool.

Multiple-Slide Press

A press with individual slides, built into the main slide or connected to individual eccentrics on the main shaft, that can be adjusted to vary the length of stroke and the timing. See also slide.

Multi-Tooth Cutter

See roughing cutter.

N/C Press

Numerically controlled press. See CNC turret press.

NC

Numerically controlled. See CNC.

N-Value

See strain-hardening exponent.

Necking

Strip condition caused by the application of too much tension that causes the metal strip to become narrower (or stretched).

Nest

To stack like parts within one another to occupy a minimum space. A plate having an opening to confirm to the counter of a part used to locate the part in a die. To lay out a blank so that the outlines of parts produced will interlock with each following and each preceding part and require the minimum amount of material.

Nesting

Grouping of identical or different parts in multiples within a workpiece to conserve material. The process of accurately locating and holding the part in a die or fixture by using gages or the part's form.

Nibble Marks

Slight irregularities at the edge of the stock surface after progressive punching (“nibbling”) operations in a turret press.

Nickel Steel

steel containing nickel as an alloying element. Varying amounts are added to increase the strength in the normalized condition to enable hardening to be performed in oil or air instead of water.

Nitrogen Die Cylinder

See gas cylinder.

Nitrogen Pressure

The nitrogen pressure in cylinders which are used to cushion the dies.

No Stock Movement

On progressive dies this is the bottom portion of the press stroke during which the coil feed cannot move the strip.

Nominal

The targeted value for a dimension that defines the size of an ideal part.

Nominal Strength

The maximum stress (tensile, compressive, or shear) a material can sustain without fracture; determined by dividing maximum load by the original cross-sectional area of the specimen. Also known as maximum strength or ultimate strength.

Non-Ferrous Metal

Elements and their alloys without iron as a major constituent.

Non-Geometrical

Information other than that directly related to the shape of the product such as notes, part numbers, material lists, tolerances, and others.

Non-Refractory Alloy

A term opposed to refractory alloy. A non-refractory alloy has malleability, that is, ease of flattening when subjected to rolling or hammering.

Non-Scalloping Quality Strip Steel

Strip steel ordered or sold on the basis of absence of unevenness, or ears, on the edges of the steel, when subjected to deep drawings.

Notching

A metalworking operation in which the punch removes material from the edge or corner of a strip or blank or part.
Error! Unknown switch argument.
   Nugget

Area melted together during resistance welding.

O.S.M.

Designation for outside of metal. See outside of metal outer panel.

Obround

Contraction of the words oblong and round denoting a punched slot with semicircular ends and straight sides.

Off Gauge

A defect referring to a variation of offset of the thickness of the plate from the designated aim gauge thickness and tolerance.

Offset

The distance along the strain coordinate between the initial portion of a stress-strain curve and a parallel line that intersects the stress-strain curve at a value of stress (commonly 0.2%) that is used as a measure of the yield strength. Used for materials that have no obvious yield point.

Offset Yield Strength

The stress at which the strain exceeds by a specific amount (the offset) an extension of the initial proportional portion of the stress-strain curve that is expressed in force per unit area.

Oil Canning

The distortion of a flat or nearly flat surface by finger pressure and its reversion to normal. Same as canning. See elastic instabilities.

Oil Hardening

A process used in which tool or alloy steels are quenched in oil as the quenching medium in the hardening process.

Olsen Ductility Test

A cupping test in which a piece of sheet metal, restrained except at the center, is deformed by a standard steel ball until fracture occurs. The height of the cup at the time of fracture is a measure of the ductility.

Olsen (Tester)

A device used to indicate the draw quality of the steel and to detect breakage caused by contamination or peeling of the zinc coating.

Open (Radius Flat) Hem

Also called as radius flat hem or loose hem. A flange that is folded back over upon itself with the edge of a mating part between the fold. This fastens the mating parts together.

Open Surface

Rough surface on black plate, sheet or strip, resulting from imperfections in the original steel bars from which the plate was rolled.

Open-Back Inclinable Press

An inclinable press in which the opening at the back between the uprights is usually slightly more than the left-to-right dimension of the 1 side flange.

Orange Peel

Surface condition characterized by an irregular waviness of a paint finish, resembling an orange skin texture. A surface roughening (defect) encountered in forming products from metal stock that has a course grain size. It is due to uneven flow or to the appearance of the overly large grains usually the result of annealing at too high a temperature.

Orbital Sanding

Non-straight-line abrasive finish with irregular circular marks.

Organic Coating

Designation of any chemical finish containing carbon.

Orthographic Drawing

A drawing showing a projection of a part which all the features are visible.

Oscillated Wound or Scroll Wound

A method of even winding metal strip or wire on to a reel or mandrel wherein the strands are uniformly overlapped. Sometimes termed stagger wound or vibrated wound. It is the opposite of ribbon wound.

Oscillating Die

A universal die which contains a cutoff type sub-die that pivots in a horizontal plane with each press stroke. This allows the blanking of rectangular, triangular, or trapezoid shaped blanks of various angles and sizes.

Outboard Mill

A roll forming machine with housings that support both ends of the roll tooling shafts.

Outer Panel Thickness

Thickness of the outer panel.

Outer Ram (Binder) Load

Maximum pressure, usually in tons on the binder surface.

Outside of Metal Flange Length

Distance of the outer panel from the trim edge to the outside of metal in the mating flange area.

Outside of Metal Outer Panel (OSM)

Side of panel that lays on the hem die.

Outside Radius

Formed outside radius of a bend.

Overbending

Bending metal a greater amount than called for in the finished piece to allow for springback.

Overcrown

The term used to signify that the curvature of a surface is too high. Used for the overbending of a curved surface to compensate for spring back.

Overhanger

A gap press in which the frame overhangs the bed.

Overhanging Press

A gap press in which the frame overhangs the bed. See also C-frame press. Also called overhanger.

Overhaul

To overhaul a piece of equipment is to pull it apart, inspect it for damage, repair or replace damaged parts, then assemble the equipment and adjust so that it operates just as if it was new.

Oxidation

A common form of chemical reaction which is the combining of oxygen with various elements and compounds. The corrosion of metals is a form of oxidation, rust on iron for example is iron oxide.

Oxidation Scale

Stained, discolored and flaky surface condition.

Pad

The pad is a spring or air operated plate used in forming dies. The pad is used to grip the sheet metal against the punch or die steel. The functions of the pad are as follows: (1) To hold the sheet metal in proper location during forming. (2) To hold the sheet metal flat. During forming, the areas not being formed tend to bow or otherwise distort. Therefore, these areas are held in their original contour by pad pressure. (3) The pad acts as a hold-down.

Pad Drivers

Blocks used to compress the pad ahead of the stock while blanking or trimming. Also to equilize pressure on the pad to eliminate the cocking of the pad.

Pad Retainer Pins

The pins that go in the side of a stripper plate or pad to retain it for the designed range of travel.

Pad Window

See window.

Pancake Die

Simple push through die for blanking or piercing.

Parametrics

Defining a feature's size by establishing a geometric relationship between it and other features, instead of defining it with a dimension.

Parting

A specific kind of cutting operation in which complete severance of the stock strip is achieved by punching out a piece of stock material (scrap) from between the piece parts.

Pattern Direction

Orientation of features or surface patterns on sheets and coils.

Patterned or Embossed Sheet

A sheet product on which a raised or indented pattern has been impressed on either one or both surfaces by the use of rolls.

Pedestal

A block of steel or welded construction to which punch steels or punch retainers are mounted. Also called a punch rise or riser.

Pem Fastener

Self-clinging inserted fastener (nut, stud, standoff, pin. blind stand off, etc.) made by Penn Engineering & Manufacturing Corp.

Penetration

Depth of a cutting operation before breakout occurs. In welding, the depth of material through which fusion occurs.

Percent Strain Safety

This is a measure of how close a strain state is to failure with regards to a forming limit diagram. Percent strain safety is calculated by dividing the difference between the major strain to failure and the actual major strain by the major strain to failure. Thus, a zero percent strain safety indicates material failure.

Percent Total Elongation

The amount of extension a material can withstand prior to fracture in a tensile test.

Percent Uniform Elongation

The amount of extension a material can withstand prior to necking in a tensile test.

Perforating

The punching of many holes, usually identical and arranged in a regular pattern, in a sheet, workplace blank, or previously formed part. The holes are usually round, but may be any shape. The operation is also called multiple punching. See also piercing.

Perforator

A specific name for a punch that falls in the cutting punch category. See punch. Also called a pierce punch.

Periphery

The extreme outer edge of part or drawing.

Permanent Set

The deformation or strain remaining in a previously stressed body after release of the load.

Perpendicularity

Dimensional relationship of a part or datum located at right angles (90°) to a given feature.

Phosphor Bronze

Copper base alloy with 3.5 10% of tin to which phosphorus has been added in a molten state in varying amounts of less than 1% for deoxidizing and strengthening purposes.

Pick-&-Place

An electrically or mechanically driven mechanism, attached to and, controlled by a press, for loading and removing a part from a die.

Pickled and Oiled

Hot rolled steel with the scale removed through immersion in acid and a follow up rinsing and oiling process for oxidation protection. Also referred to as P&O and HRPO.

Pickoff

An automatic device for removing the finished part from a die after it has been stripped or released from the die.

Pick-Up

See scoring.

Pickup

Small particles of oxidized metal adhering to the surface of a mill product.

Pierce

To cut, shear, or punch an opening in sheet metal, strip, plate or parts such as a slot or a hole.

Pierce Block

An individual die part that contains one or more pierce holes or die buttons.

Pierce Button

A small cylindrical die steel with an opening larger than the punch point size, generally by a percentage of the thickness of the material being pierced. It is also called a button or a die button.

Pierce Punch

A specific name for a punch that falls in the cutting punch category. It is also referred to as a perforator.

Piercing

The general term for cutting (shearing or punching) openings, such as holes and slots, in sheet material, plate, or parts.

Piercing Die

A die which cuts out a slug, which is usually scrap, in sheet or plate material.

Piggy Back Cam

A cam which is actually two cams. The bottom cam is normally a dwell cam and the top cam is normally a straight cam.

Pilot

A pin or projection provided for locating work in a die from a previously punched hole. Also called locating pin or pilot pin.

Pinch Pass

A term applied when, after annealing, sheet or strip is lightly rolled with the object of preventing stretcher lines or kinks on subsequent cold working.

Pinch Trim

Trimming excess material from a drawn part at the bottom of the stroke. Leaves drawn shell without an inside burr, but with an outside burr and a thinned edge.

Pinch Trimming

Trimming the edge of a part by punching or pushing the flange or lip of the part over the cutting edge of a draw or stationary punch.

Pinchers

Long fern like creases usually diagonal to the direction of rolling.

Pinhole

A coating defect consisting of the randomly spaced small round holes (as a straight pin would make in the cured film) which quite often occur in large numbers. The open area (pinhole) usually exposes bare substrate. Contaminated substrate or improperly dispersed lubricant or additive may cause pinholes. Pinholes are typically caused by laminations, inclusions, scratches or gouges.

Piobert Lines

Elongated surface markings or depressions caused by localized plastic deformation that results from discontinuous (in homogeneous) yielding. Also known as Luders lines, Hartmann lines, or stretcher strains.

Pitch

See progression.

Pitch Notch

A notch usually cut on one side of a stock strip in a progressive die to control stock width and progression of the stock. Also called French cut and French notch.

Pitting

A coating defect consisting of randomly spaced small depressions in the cured film. Pitting is similar to pinholing, except that pits do not expose the bare substrate.

Plasma Arc Welding (PAW)

Specialized process utilizing a non-consumable electrode ionizing an inert gas and increasing temperature to melt the material being welded.

Plastic Anisotropy

This is the concept that a material has a preferred strain direction. In sheet material, plastic anistropy is measure as the ration of width strain to thickness strain. This value is called the r-value and measure the tendency of the sheet to thin under deformation. It also is an indicator of the directional differences in a rolled material like sheet.

Plastic Deformation

Permanent deformation occurring in forming of metal after elastic limits have been exceeded under the action of applied stresses. The ability of metals to flow in a plastic manner without fracture is the fundamental basis for all metalforming processes.

Plastic Flow

The phenomenon that takes place when metals or other substances are stretched or compressed permanently without rupture.

Plastic Hit

A method of determining the cutting edge of a steel from the mating steel by assembling the die so the trim steels are just short of entering. Then applying epoxy plastic to the top of the steel and against the mating steel which has a parting agent on it and allowing it to harden before disassembling. This is sometimes called shooting plastic.

Plastic Working

The processing of a substance by causing a permanent change in its shape without rupture. See plastic deformation.

Plasticity

The property of a substance that permits it to undergo a permanent change in shape without rupture. See plastic deformation.

Plastic-Strain Ratio (Revalue)

The ratio of the true width strain to the true thickness strain in a sheet tensile test. A formability parameter that relates to drawing, it is also known as the anisotropy factor. A high revalue indicates a material with good drawing properties.

Plate

A flat-rolled metal product of some minimum thickness and width arbitrarily dependent on the type of metal. Sheet steel thicker than 7 gauge 0.179 in. (4.55 mm) or sheet aluminum thicker than 3/16 in. (4.76 mm).

Plates

See plate.

Plating

A thin coating of metal laid on another metal.

Plunger

See press slide.

Pneumatic Spring

A one way air cylinder having a large hollow shaft and a check valve on the air supply at the cylinder which eliminates the need for a surge tank.

Pneumatics

If energy transfer is in the form of compressed airflow then it is known as pneumatics. In industry compressed air is generated by using a machine called a compressor, which draws in normal air, squeezes it to increase its pressure and then passes it through a moisture separator and stores it in the reservoir for later use in the factory.

Pogo Stick

An adjustable rod which holds an indicator for checking the level of a press ram.

Point

A piece of geometry at an exact location. Polishing Abrasive process in which the surface created takes on a bright reflective finish, scratch free to the unaided eye.

Point of Origin

A point from which other dimensions are taken. See also construction hole.

Poisson'Ratio

The ratio of the second principal strain 2 in the transverse direction to the principal strain 1 in the axial direction when a uniaxial tension or compression is applied.

Polishing Bob or Cone

See sanding bob.

Post-Paint

To paint a manufactured part after at it has been formed.

Postcut Roll Forming

A process whereby the raw material is fed into the roll forming mill in coil form with the formed part cut to length. This is the most common roll forming material feeding process. See precut roll forming.

Powder Coating

100% solids coating applied as a dry powder and subsequently converted into a film with heal.

Power Spinning

The art of forming metal over a mold in one pass using hand or hydraulic pressure.

Precision Lead Screw

See lead screw.

Precut Roll Forming

A process whereby the raw material is cut to length prior to entering the roll forming mill and fed into the mill as blanks. It is primarily used for low-volume applications. See postcut roll forming.

Prefinished Material

Stock which has been painted or plated prior to fabrication or stamping.

Prenotch/Prepunch Press

A device used to stamp a hole or notch pattern in incoming material on a roll forming line prior to roll forming.

Preformed Part

A partially formed part which will be subjected to one or more subsequent operations. Usually done after a blank die and prior to going into a draw die.

Pre-Hem Contact Path

Angle between a line (formed by a point on the pre-hem steel at first contact with flange to the same point at end of pre-hem) and the mating surface.

Pre-Hem Face Geometry

Angle of the pre-hem steel measure relative to the mating flange area.

Pre-Hem Flange Angle

Angle measured from the mating flange area to the pre-hemmed flange.

Pre-Hem Force

Maximum force required to bend flange to pre-hem position.

Pre-Hem Springback

Elastic recovery that follows plastic deformation when the pre-hem load is removed.

Pre-Hem Steel

The steel in a hem die that bends the 90° flange to approximately a 45° flange so the hem steel can finish hemming the flange. Also called angle steel, starting steel, or starting ring.

Press

A machine having a stationary bed or anvil and a slide (ram or hammer) which has a controlled reciprocating motion toward and away from the bed surface and at right angle to it. The slide is guided in the frame of the machine to give a definite path of motion.

Press Attachment

A bed mounted device on a slide forming machine used for punching, piercing and other press operations.

Press Bed

The stationary and usually horizontal part of a press that serves as a table to which a bolster plate or lower die assembly is mounted.

Press Brake

An open-frame single-action press used to bend, blank, corrugate, curl, notch, perforate, pierce, or punch sheet metal or plate.

Press Capacity

The rated force a press is designed to exert at a predetermined distance above the bottom of the stroke of the slide.

Press Forming

Any sheet metal forming operation performed with tooling by means of a mechanical press or hydraulic press.

Press Hemmer

Ballscrew driven press hemmer.

Press Load

The amount of force exerted in a given forging of forming operation.

Press Ram

See press slide.

Press Section

A device that is built into a slide forming machine used for punching, piercing and other press operations.

Press Slide

The main reciprocating member of a press, guided in the press frame, to which the punch or upper die is fastened. Sometimes called the ram, press ram, slide, plunger, or platen. See slide.

Press Tool (Metal Stamping Die)

A piece of precision-made, mass production, tooling used to cut, bend and shape metal components from flat, strip, coil or sheet material. The components produced could range in size from car roof panels, door skins or bonnets, to small clockwork gears in mechanical watches and timepieces.

Pressure Pad Read Through

It occurs in rare cases where the inner panel is help using excessive force on a pressure pad.

Pressure Pin

A pin used in conjunction with a die cushion to transfer pressure from the cushion to the bottom of a die pad. Also called cushion pins, air pins, and transfer pins.

Pressure Plate

A plate located beneath the bolster that acts against the resistance of a group of cylinders mounted to the pressure plate to provide uniform pressure throughout the press stroke when the press is symmetrically loaded.

Prime Coil

Any coil produced by the line that is not held for any out-of-spec or quality reasons.

Primes

Metal products, such as sheet and plate, of the highest quality and free from visible surface defects.

Process Class

Each process is assigned a group of process classes. Primary processes take unshaped material (liquid metal, a powder or a solid ingot) and give it shape. Thus casting processes are primary, though they can be discrete or continuous. Secondary processes modify, refine or add features to an already-shaped body. As an example: fine machining is a secondary process, and it is one that can modify, refine and add features.

Product

The object or material that has had an operation of the class type performed upon it.

Production Jigs and Fixtures

Precision-made mass production tooling used to safely and accurately position and hold components during a production line process, to allow follow-on operations such as machining, welding, painting, assembly and/or packaging to be undertaken on the component.

Production Rate

Units: kg/hr (SI) lb/hr (Imperial); or m/min (SI), ft/min (Imperial). The production rate is the output-rate of the process. For batch processes, it is measured in number of units per hour, or in total mass per hour of product. For continuous processes, it is measured in total mass or length per hour. Automated processes have higher output rates than their manual counterparts.

Profile Grinder

A machine used to grind contour on a steel. Can be used with mounted wheels or carburrs. Also called a diemaker's friend or helper.

Profiling

Machining or grinding the outline of die members.

Programmable Back Gauges

Stops on metalforming machines which can be adjusted during and between cycles by computer numeric control. Progressive Tool-Die using multiple stations or operation to produce a variety of options that can incorporate piercing, forming, extruding and drawing, and is usually applied to high quantity production runs.

Progression

The precise linear travel of the stock strip at each press stroke and is equal to the interstation distance. Also called pitch, advance, or feed.

Progressive Die

A die with two or more stations arranged in line for performing two or more operations on a part one operation usually being performed at each station. The parts are connected by a carrier strip until final parting or cutoff operation.

Progressive Forming

Sequential forming at consecutive stations with a single die or separate dies.

Progressive Tool

Die using multiple stations or operations to produce a variety of options. Can incorporate piercing, forming, extruding and drawing, and is usually applied to high quantity production runs.

Project Number

Numbers used to identify special accounts to cover the cost of new work, engineering changes, and service work on past model dies. Numbers can be found in books in supervisor's office.

Projection Welding

Using protrusions on one of the two parts to be resistance welded, creating a positive conductance path.

Proof

Any reproduction of a die impression in any material; often a lead or plaster cast. See also die proof.

Proof Load

A predetermined load, generally some multiple of the service load, to which a specimen or structure is submitted before acceptance for use.

Proof Stress

The stress that will cause a specified small permanent set in a material. A specified stress to be applied to a member or structure to indicate its ability to withstand service loads.

Proportional Limit

The greatest stress a material is capable of developing without a deviation from straight-line proportionality between stress and strain. See also elastic limit and Hooke's law.

Prototype

First part of a design which is made to test tolerance capability, tooling concepts and manufacturability.

Puckering

A wavy condition in the walls of a deep drawn part.

Pull Down

Area of material next to the penetrating edge of a piercing punch, or die edge of the blanking station, where the material yields, i.e. flows in the direction of the applied force, creating a rounded edge.

Pulse Mode

Intermittant surging of laser cutting power action.

Punch

The male part of a die—as distinguished from the female part, which is called the die. The punch is usually the upper member of the complete die assembly and is mounted on the slide or in a die set for alignment (except in the inverted die). In double-action draw dies, the punch is in the inner portion of the upper die, which is mounted on the plunger (inner side) and does the drawing. The act of piercing or punching a hole. Also referred to as punching. The punch is the movable part that forces the metal into the die in equipment for sheet drawing, blanking, coining, embossing and the like.

Punch Direction

The direction from which a tool or punch enters the workpiece.

Punch Line

The outline of the draw punch in the plan view of a blueprint.

Punch Press

Machine supplying compression force for reshaping materials.

Punch Radii

The punch corner radius and/or the punch nose radius.

Punch Riser

A block of steel or welded construction to which punch steels or punch retainers are mounted. Also called stool, pedestal, or riser. A cast spacer between the inner ram and the draw punch in a toggle draw tie. Also called a riser.

Punch Shoe

The upper section of a die set. Bushings and punch steels are usually mounted to this section.

Punch Side

Opposite side from burr side for pierced features; side on which the punch enters the material. The punch side is the burr side for blanked outside contours.

Punch Steel (or Punch)

The male steel is commonly called the punch steel.

Punching

(1) Shearing holes in sheet metal with punch and die. (2) The die shearing of a closed contour in which the sheared out sheet metal part is scrap. (3) Forming metal components using a punch.

Quality Factor—Dimensionless

Quality is difficult to quantify. Processes prone to porosity (certain sand-casting processes, for example) or other defects are assigned a low value. Processes which minimize the probability of defects (closed-die forging and Cosworth casting are examples) are given a high value.

Quick Change Inserts

Tool sections or parts that may be changed without removing the entire tool from the press.

Rabbit Ear

A recess in a die corner to allow for wrinkling or folding of the part.

Radial Draw Forming

The forming of sheet metals by the simultaneous application of tangential stretch and radial compression forces. The operation is done gradually by tangential contact with the die member. This type of forming is characterized by very close dimensional control.

Ram

Driven (movable) part of a metalforming machine.

Rapid Prototyping

This includes a number of rapidly evolving techniques for making prototypes and models quickly thus allowing designers to check their designs and make any necessary changes before investing in expensive tooling. A CAD model of the part is required and the model is usually built layer by layer.

Ready Hemmer

A type of flat surface-straight edge hemming process where pre-hemming and final hemming operations are combined by the use of a rocker (rotary) die set.

Rear Cut Off

A device on a slide forming machine driven by a cam that is mounted on the rear shaft allowing the removal of a slug from the strip, thus providing the ability to produce a blank with special end shapes.

Recoil

As opposed to hem curved outboard and hem deflection recoil is the term used for the local curve at the hem edge.

Recoil Line

See impact line.

Redrawing

The second and successive deep-drawing operations in which cuplike shells are deepened and reduced in cross-sectional dimensions.

Reduction

In cupping and deep drawing, a measure of the percentage of decrease from blank diameter to cup diameter, or of the diameter reduction in redrawing. In forging, extrusion, rolling, and drawing, either the ratio of the original to the final cross-sectional area or the percentage of decrease in cross-sectional area.

Reduction in Area

The difference between the original cross-sectional area and the smallest area at the point of rupture in a tensile test that is usually stated as a percentage of the original area.

Register

When the workpiece is brought into the required position by the pilots.

Relief

Clearance obtained by removing metal either behind or beyond the cutting edge of a punch or die. Also called undercut or back-off.

Repositioning

Operation in turret press fabrication denoting the release of the workholders, movement of the X axis to a new position on the workpiece, and the regripping of the workpiece so that a sheet larger than the X axis table travel can be fabricated, all under computer numeric control (CNC).

Reproducibility

Extent to which parts from multiple lots are identical.

Rerolling

Final cold rolling operation, usually done to achieve specific thickness control and improved finish.

Reservoirs

A tank used to store fluid for a hydraulic system—this maintains the fluid an even temperature by allowing circulation and cooling from the tank sides.

Reset

The realigning or adjusting of dies or tools during a production run; not to be confused with the operation setup that occurs before a production run.

Residual Stress

Macroscopic stresses that are set up within a metal as the result of non-uniform plastic deformation. This deformation may be caused by cold working or by drastic gradients of temperature from quenching or welding.

Resistance Projection Weld (RPW)

See projection weld.

Resistance Spot Welding (RSW)

Melting and joining action of two adjoining metal surfaces created by the thermal reaction of the metal to the flow of an electrical current forming a weld nugget.

Restrike

To sharpen radii, form, or detail in previously formed area of a part. Also used to eliminate spring back. Also called spank.

Reverse Drawing

Redrawing of a sheet metal part in a direction opposite to that of the original drawing.

Reverse Flange

A sheet metal flange made by shrinking, as opposed to one formed by stretching.

Reverse Redrawing

(Inside-out Redrawing) A second or subsequent redrawing operation performed in the opposite direction to the original drawing.

Revision

A subsequent part drawing usually denoting new corrected or improved version.

Revision Description

A written notice describing the nature of changes to a drawing.

Rib

A long V-shaped or radiused indentation used to strengthen large sheet metal panels. A long, usually thin protuberance used to provide flexural strength to a forging (as in a rib-web forging).

Ribbing

A coating defect consisting of a flow mark defect with an appearance similar to corduroy fabric. Ribbing usually occurs when the flow marks (ribs) from application on the coater do not flow out and level the surface of the coating.

Ribbon Wound

A term applied to a common method of winding strip steel layer upon layer around an arbor or mandrel.

Rider Pin

The pin or post, usually fixed in the lower shoe of a die and accurately fitted to bushings in the upper shoe to insure precise alignment of the two members of a die set. See guide pin.

Ring

That part of a forming die, which holds the blank by pressure against a mating surface of the die to control metal flow and prevent wrinkling. See blank holder.

Riser

A sub plate on which die steels are mounted. A block of steel or welded construction to which punch steels or punch retainers are mounted. Also called pedestal, punch riser, or stool. A plate, welded construction, or casting mounted to the bottom of the lower die shoe to facilitate scrap removal, regulate feed height, obtain shut height, etc. A cast spacer between the inner ram and the draw punch in a toggle draw die.

Riser Block

A plate inserted between the top of the press bed and the bolster.

Rivet Nut

Internally threaded fastener designed to be used as a rivet from one side of a workpiece or assembly and to provide threads for a screw or bolt to be used in assembly of a mating part.

Rockwell Hardness

An indentation hardness test based on the depth of penetration.

Rockwell (Hardness Tester)

A device used to determine the hardness of the steel strip.

Rod

A solid round section 9.5 mm (⅜″) or greater in diameter, whose length is great in relation to its diameter.

Roll Bending

The curving of sheets, bars, and sections by means of rolls.

Roll Flattening

The flattering of sheets that have been rolled in packs by passing them separately through a two-high cold mill with virtually no deformation. Not to be confused with roller leveling.

Roll Form

A metal shape that has been processed using roll forming.

Roll Formed Shape, Hollow

A roll formed shape which is closed by mechanically fastening or a welding the two strip edges together.

Roll Formed Shape, Open

A roll formed shape with a linear or curved contour in which the two ends of the shape are not brought together.

Roll Forming

A continuous bending operation in the metal forming process, which sheet or strip metal is plastically deformed along a linear axis by being passed through a series of roller dies and progressively shaped to the desired contour.

Roll Over

The area of material next to the penetrating edge of a piercing punch, or die edge of the blanking station, where the material yields, i.e. flows in the direction of the applied force, creating a rounded edge. Also known as pull down.

Roll Stations

Tandem sets of rolls used in roll forming to shape the metal stock in a series of progressive stages to form the desired cross-sectional configuration.

Roll Straightener

A mechanism equipped with rolls to straighten sheet or strip stock. Usually used with a feed mechanism for press working.

Roll Straightening

The straightening of metal stock of various shapes by passing it through a series of staggered rolls (the rolls usually being in horizontal and vertical planes) or by reeling in two-roll straightening machines.

Roller

A deforming instrument having a work-engaging, work deforming, peripheral surface which is generated by a line revolving about an axis. The roller will cyclically move into and out of contact with a work surface during deformation of the work, relative movement occurring, during deformation.

Roller Level

A staggered system of rolls used to flatten the steel without any appreciable reduction in gauge.

Roller Leveler Breaks

Obvious transverse breaks on sheet metal usually about 3 to 6 MM (⅛″ to ¼″) apart that are caused by the sheet fluting during roller leveling. These will not be removed by stretching.

Rolling

A term applied to the operation of shaping and reducing metal in thickness by passing it between rolls which compress, shape and lengthen it following the roll pattern.

Rolling Direction (in Rolled Metal)

The direction, in the plane of the sheet, perpendicular to the axes of the rolls during rolling.

Rolling Mills

Equipment used for rolling down metal to a smaller size or to a given shape employing sets of rolls tie contours of which determine or fashion the product into numerous intermediate and final shapes, e.g., blooms, slabs, rails, bars, rods, sections, plates, sheets and strip.

Roll-Over

The radius on the outside edge of a hemmed part where the diameter of this edge is at least four times stock thickness. The rope is used for materials with insufficient ductility to form an open hem.

Rope Hem

Preferred for lower strength materials.

Rose Bud

The result of cutting or tearing (piercing) and flanging of a hole in one operation without generating a slug. Referring to extruding or spearing.

Rotary File

See carburr.

Rotary Shear

A sheet metal cutting machine with two rotating-disk cutters mounted on parallel shafts driven in unison.

Rotary Slide Machine

A vertical forming machine with the ability to place several forming slides radially around the center tool and produce intricately formed stampings and wire forms.

Rough Blank

A blank for a forming or drawing operation, usually of irregular outline, with necessary stock allowance for process metal, which is trimmed after forming or drawing to the desired size.

Roughing Cutter

A milling cutter with serrated flutes or teeth. Also called corn-cobs.

Roughness (Normal and Extreme)

Units: mm (SI), mils (Imperial) The ‘normal‘ range of RMS (root mean square) surface roughness which lies within the capacity of the process. As with mass, and ‘extreme’ range is also stored. Surface roughness is determined by the nature of the process: the smoothness of mold surfaces in casting and molding or the depth of cut in machining. It can usually be refined by machining, grinding and polishing.

Roundness

Extent to which a feature is circular.

Rubber Duck

A flexible skin of a part made out of latex covered fiberglass and used in the designing of a die.

Rubber Forming

A sheet metal forming process in which rubber is used as a functional die part.

Rubber Screw

A socket head cap screw with the head and the upper portion of the body turned down, leaving a minimum number of threads on the end of the body. Used where the screw hole in the detail does not align with the threaded hole in the mounting surface. Also called Chicago screws, Eberly screws, or Kelly screws.

Rubber-Pad Forming

A sheet metal forming operation for shallow parts in which a confined, pliable rubber pad attached to the press slide (ram) is forced by hydraulic pressure to become a mating die for a punch or group of punches placed on the press bed or baseplate. Developed in the aircraft industry for the limited production of a large number of diversified parts, the process is limited to the forming of relatively shallow parts, normally not exceeding 40 mm (1.5 in.) deep. Also known as the Guefin process. Variations of the Guerin process include the Marforming process, the fluid-cell process, and fluid forming.

Run Marker

See run stamps.

Run Numbers

See run stamps.

Run Out Flange

Feature on a formed part which is designated by the designer to absorb the tolerance accumulations created by multiple forming operations.

Run Stamps

Stamps used in a die to stamp the date the part was run. Normally this is a Julian date (see Julian date). Also called run marker, run numbers, or date of run.

Running Clearance

The amount of, clearance designed in a die between two mating steels to allow for stock thickness at bottom of press stroke.

Safety Pin

A pin which is used to prevent the movement of an object while working on or near that object. Used on incline cams, iron hands, etc.

Salt Spray Test

An accelerated corrosion test in which the metal specimens usually coated steel are exposed to a fine mist of salt water solution either continuously or intermittently. Spray is usually 5% NaCl.

Sanding Bob

A small tightly rolled and glued emery cloth designed to be mounted on a mandrel and used on a hand grinder for polishing.

Sausage

A bulge outside of the finish form area on a draw punch or cavity to take up loose metal or to help control the draw process. Also called a bologna or kidney.

Saxaphone

Five-eighth inch hand grinder that is big and cumbersome to use. Used for rough-grinding where there is a large amount of stock to be removed.

Scale

Thick oxide coating on material normally associated with hot working. Deposit formed from solution directly in place upon a confining surface.

Scale Weight

Used alternately with actual weight.

Scaling

A process used for spotting large contoured areas by using a spotting stick. See also spotting stick.

Scallop

Edge condition resulting from nibbling a feature in a turret press. See earing.

Scleroscope Hardness

Measure of a material's resistance to localized plastic deformation. Most hardness tests involve indentation, but hardness may be reported as resistance to scratching (file test), or rebound of a projectile bounced off the material (scleroscope hardness). The Scleroscope test consists of dropping a diamond tipped hammer, which falls inside a glass tube under the force of its own weight from a fixed height, onto the test specimen. The height of the rebound travel of the hammer is measured on a graduated scale. The scale of the rebound is arbitrarily chosen and consists on Shore units, divided into 100 parts, which represent the average rebound from pure hardened high-carbon steel. The scale is continued higher than 100 to include metals having greater hardness.

Scoring

The marring or scratching of any formed part by metal pickup on the punch or die. The reduction in thickness of a material along a line to weaken it intentionally along that line.

Scrap

Leftover, unused material relegated to recycling.

Scrap Cutter

A shear or cutter operated by the press or built into a die for cutting scrap into sizes for convenient removal from the die or disposal.

Scrap Strip

See skeleton.

Screw Press

A high-speed press in which the ram is activated by a large screw assembly powered by a drive mechanism.

Secant Modulus

The slope of the secant drawn from the origin to any specified point on the stress-strain curve. See also modulus of elasticity.

Section (Normal and Extreme)

Units: mm (SI), inches (Imperial) The ‘normal’ range of section thickness which lies within the capacity of the process. As with mass, an ‘extreme’ range is also stored. Minimum section is determined by consideration of fluid flow in castings, of plastic constraint in forgings and so on. It can usually be reduced by machining.

Sections

See details.

Seediness

Coating defects consisting of the randomly spaced undissolved particles, usually resin particles, which are immersed in the coating. They are raised up in the coating and appear somewhat like fine sand sprinkled throughout the film.

Segment Die

Same as split die.

Selective Perforation

Hole or slot pattern over a specific portion of a workpiece, normally used for ventilation purposes.

Self Fixturing

Part designed to be self-locating into proper position to another part with the use of built-in locators.

Self Locking Fastener

Fastener which is machined with interference threads or which has a nylon insert or other locking mechanism to securely hold mating fasteners in high torque or vibration applications.

Semi-Perfs

See half shear.

Service Order Number (S.O.#)

Number used to identify special accounts to cover the cost of service work on past model dies only. Numbers can be usually be found in a book in the supervisor's office or work area. They are also called tool order numbers and project numbers.

Sever

To forcibly part or separate a discrete portion from a body of material. See cut.

Shadow

Generally, a local inboard condition on a metal panel which is usually in a high stress area. Also called a birdbath or low spot.

Shake Aparts

Term designating a family of parts on a sheet which are held by micro ties so small that the parts can be removed from the sheet after CNC punching by simply shaking the sheet.

Shaker Parts

See shaker parts.

Shape Class

Like other researchers in this field, we have explored alternative approached to the characterization of ‘shape’ and ‘complexity’, some based on ideas of symmetry, other on information theory, still others based on an amalgam of experience and intuition. There is not universal agreement. Prismatic shapes result from extrusion, rolling and drawing and turning. Products made from sheet are flat or dished, with or without cut-outs; they are made by processes such as pressing, stamping, rolling and spinning.

Shape Control

Ability to produce material to a given geometric flatness standard. See flatness.

Shape Defect

Geometric non-uniformity of a strip, such as bent strip, coil set, center buckle, wavy edge, etc.

Shaving

A secondary shearing or cutting operation in which the surface of a previously cut edge is finished or smoothed by removing a minimal amount of stock.

Shear

A type of cutting operation in which the metal object is cut by means of a moving blade and fixed edge or by a pair of moving blades that may be either flat or curved. The type of force that causes, or tends to cause, two contiguous parts of the same body to slide relative to each other in a direction parallel to their plane of contact.

Shear Crack

A diagonal, transgranular track caused by shear stresses.

Shear Form

See formed tab.

Shear Knives

Sheets used for lancing the part in a forming operation to control fracturing of the part while forming.

Sheer Spinning

The art of forming metal over a mold in one pass using hand or hydraulic pressure.

Shear Strength

The maximum shear stress a material can sustain. Shear strength is calculated from the maximum load during a shear or torsion test and is based on the original dimensions of the cross section of the specimen.

Shear Stress

A stress that exists when parallel planes in metal crystals slide across each other. The stress component tangential to the plane on which the forces act.

Shear-to-Feature

Shearing of an edge of stock to an exact dimension from an already existing feature.

Shearing

Cutting force applied perpendicular to material causing the material to yield and break.

Error! Unknown switch argument.

Shedder

A pin, rod, ring, or plate operated by mechanical means, air, or a rubber cushion that either ejects blanks, parts, or scrap from a die or releases them from punch, die, or pad surface.

Sheet

Any material or piece or uniform thickness and of considerable length and width as compared to its thickness. With regard to metal, such pieces under 6.5 mm (¼ in.) thick are called sheets, and those 6.5 MM (¼″) thick and over are called plates. Occasionally, the limiting thickness for steel to be designated as sheet steel is No. IO Manufacturer's Standard Gage for sheet steel, which is 3.42 mm (0.1345″) thick.

Sheet Forming

The plastic deformation of a piece of sheet metal by tensile loads into a three-dimensional shape, often without significant changes in sheet thickness or surface characteristics. Compare with bulkforming.

Sheet Products

Hot Roll (01) Uncoated, heavy gauge, fully processed in Strip Steel, never cold reduced at Tandem Mill. Cold Roll (02) Uncoated, heavy gauge, primarily processed in Strip Steel, although some goes to the Tin Mill, always cold reduced at Tandem Mill. Galvanized (05,06) “Bath” coated with zinc, heavy gauge, primarily processed thru Strip Steel & Sheet Mill, majority is cold reduced at Tandem Mill.

Shell

Another word for a formed cup. A sheet metal part that is the product of the first drawing operation. Also, any cylindrical part of shell closed at one end.

Shielding Gas

Inert gas used for oxidation protection during welding.

Shim Steel

Steel which has been rolled thin to a hard condition and very close tolerance.

Shim

A thin piece of material used between two surfaces to obtain a proper fit, adjustment, or alignment. Shims are also thin metal sheets that are inserted between the die and press to align the binder surface of the die and alter binder pressure.

Shimmy Cam

A cam designed to move in one direction land then reverse direction during the down stroke of the press so work is done in both directions.

Shoe

A generic term referring to the upper or lower component of a die set.

Shot Blasting

Cleaning surface of metal by air blast, using metal shot as an abrasive.

Shoulder Bolts

Bolts that are used most commonly for accurate locating or pivot/slide mounting points.

Shoulder Screw

A socket head screw with a larger machined body than the threaded end. Made to bottom on the body's shoulder. Used to contain pads or springs and for other tasks. Sometimes referred to as should or stripper bolts.

Shunting

Short circuiting of a (weld) current thought a previously applied weld nearby.

Shut Height

Clearance in a press between ram and bed with ram down and adjustment up.

Shute

See chute.

Silicon Carbide

Mineral used for abrasive metal removal.

Single Action

Press utilizing one moving element.

Single-Action Die

A form die that has no blank holder action since it is used with a single-action press without the use of a draw cushion.

Single-Action Press

A forming press that operates with a single function, such as moving a punch into a die with no simultaneous action for holding down the clank or ejecting the formed work.

Sinkhole

In welding, a dimple on the surface of stock caused by shrinking of the weld during cooling.

Sizing

Secondary forming or squeezing operations needed to square up, set down, flatten, or otherwise correct surfaces to produce specified dimensions and tolerances. See restriking. Some burnishing, broaching, drawing, and shaving operations are also called sizing. A finishing operation for correcting ovality in tubing. Final pressing of a sintered powder metallurgy part.

Skeleton

The strip of stock from a progressive die starting at the point of entry through the last station. Also called stock strip, scrap strip, or carrier strip. Also see web.

Skid Lines

Line seen on the finished part when the stock slips on a draw punch. This is caused by the die not being timed correctly or when the forming of a shape is at such an off angle.

Skid Marks (Roll Slip)

Polished or burnished streaks across the stock surface resulting from improperly set roller driven material processing equipment. Skid marks are transverse to the direction of rolling.

Skin

A thin reproduction of the outside surface of a part detail, or model. Normally made of fiberglass and/or a plastic material. Used for spotting, machining, etc.

Sled Runner

An adjustable tripper for activating an air-operated valve that controls automation. Also called striker.

Slide

The main reciprocating member of a press, guided in the press frame, to which the punch or upper die is fastened; sometimes called the ram. The inner slide of a double-action press is called the plunger or punch-holder slide while the outer slide is called the blank holder slide. The third slide of a triple-action press is called the lower slide, and the slide of a hydraulic press is often called the platen.

Slide Adjustment

The distance that a press slide position can be altered to change the shut height of the die space. The adjustment can be made by hand or by power mechanism.

Slide Counterbalance

A device used on the slide of large and small presses to reduce vibration and to assist the brake and clutch in functioning properly. Counterbalances are actuated by springs or air pressure. They relieve much of the load of the slide and punch from the press connection and shaft, thereby reducing the friction on the brake.

Slide Counterbalance Pressure (Counterbalance Pressure)

A device used on the slide of large and small presses to reduce vibration and to assist the brake and clutch in functioning properly. Counterbalances are actuated by springs or air pressure. They relieve much of the load the slide and punch from the press connection and shaft, thereby reducing the friction on the brake.

Slide Forming

A high-volume stamping process in which a machine with multiple slides sequentially performs various operations (i.e. blanking, piercing, forming, etc.)

Slide Hammer

A weight that slides along a rod with a head on one end and threads on the other end. Normally used to pull dowels and details. Commonly called a dowel puller.

Slit Edge

The relatively smooth edge produced from side trimming or slitting. See mill edge.

Slitter

Area on the Pickier where the strip is side trimmed (slit) to its proper width. Side trims the edges of the strip to certain width in the customer's specifications, or the vertical cutting of coil material to form narrow strip product.

Slitting

Cutting or shearing along single lines to cut strips from a sheet or to cut along lines of a given length or contour in a sheet or workpiece. Cutting sheet or strip metal to width by rotary slitters.

Slot-to-Form

Distance from a slot edge to the inside edge of a formed feature.

Slug

The metal removed when punching a hole in a forging; also termed punchout. The forging stock for one workpiece cut to length. See also blank.

Slug Marks

Surface defects caused by scrap being indented into the metal surface.

Slug Trails

Passage ways for slugs to fall out of trim and pierce dies. Slug marks in draw and form dies.

Soft Tooling

A term generally applied to the fabrication of metal parts using computer controlled technology incorporating CNC turret presses, laser profilers and press brakes.

Solids

The ability of the CAD software to realize that a volume is filled with solid matter. These CAD systems can display a design so that it looks like a solid object. Includes recognition of surfaces and wireframes.

Spalling

The breaking off of flake—like metal particles from a metal surface.

Spangle Free

A galvanized product in which the spangle formation has been suppressed; accomplished by eliminating Antimony and Lead in the molten zinc bath during the production of Hot Dipped Galvanized. Galvannealed is always spangle free.

Spank

Fabricating activity to sharpen radii, form, or detail in previously formed area of a part. See restrike.

Spares

See back-ups.

Spatter

In welding, droplets of matter deposited as contaminants.

Spear Punching

The process of cutting or tearing a hole in metal, which does not generate a slug. Instead, the metal is pushed back to form a jagged flange on the backside of the hole. Also called spearing.

Spearing

The process of cutting or tearing a hole in metal, which does not generate a slug. Instead, the metal is pushed back to form a jagged flange on the backside of the hole. See spear punching or extruding.

Special Purpose Work Holding Devices and Machinery

Precision-made mass production tooling such as jigs and fixtures, but also includes robotic arm end effectors (grippers/holders) for use on industrial robots. Special purpose machines/equipment may also be manufactured to carry-out specific tasks on a mass production line such as winding electric motors, assembling bearing assemblies, filling bottles and cans, or any other automated process.

Spider

A plate that bridges two or more transfer pins and distributes force equally. Commonly used for lifter, light weight pads, and positive knockouts.

Spinning

The forming of a seamless hollow metal part by forcing a rotating blank to conform to a shaped mandrel that rotates concentrically with the blank. In the typical application, a flat-rolled metal blank is forced against the mandrel by a blunt, rounded tool; however, other stock (notably, welded or seamless tubing) can be formed. A roller is sometimes used as the working end of the tool. The procedure of making sheet metal discs into hollow shapes by pressing the metal against a rotating form (spinning chuck) by a tool.

Spinning Blank

A circular disk made from sheet or plate metal.

Spleen

See draw bead.

Split Die

A die made of parts that can be separated for ready removal of the workpiece. Also known as segment die.

Splits

Failure and localized separation of a sheet metal, also known as tears or fractures.

Spool

A cylindrical headed keeper fastened by one or more socket head screws used to retain and control pad travel.

Spooled Coil

A coil having edges that are turned up (like a spool of thread).

Spot Face

Circular flat surface as a bearing area for hardware. Also refers to the smooth area around a hole for a fastener. Also called sump.

Spotting

The fitting of one part of a die to another by applying an oil or water color to the surface. Also refers to the smooth area around a hole for a fastener marked by the transferred color.

Spotting Aid

See skin or cast.

Spotting Rack

See skin or cast.

Spotting Scale

A thin hardened steel rule type material used to locate high points or areas when spotting large form areas such as hood punches.

Spotting Stick

A thin strip of wood used to locate high points or areas when spotting large form areas such as hood punches. The stick is usually made of mahogany. Also called mahogany stick. See also scaling.

Spring Back

Partial rebounding of formed material caused by its elasticity.

Spring Can

A sheet metal cylinder open at one end and closed at the other. Used to retain the various segments of a spring in the event that it breaks.

Spring Loaded Panel Fasteners

Inserted fastener which is equipped with a floating captive screw, spring and retainer such that the hardware will remain in the panel, ready for use, when the panel has been disassembled from its mating component.

Spring Plate

A separately mounted plate used to retain and provide access to die springs.

Spring Steel Strip

Any of a number of strip steels produced for use in the manufacture of steel springs or where high tensile properties are requires marketed in the annealed state, hard rolled or as hardened and tempered strip.

Spring-Back Allowance

The allowance designed into a die for bending metal a greater amount than specified for the finished piece, to compensate for spring-back.

Squareness

Measure of perpendicularity of adjacent edges or surfaces.

Squeeze Block

A piece of steel with a spring-loaded pin held under tension by a screw. Used to check distance between two parallel surfaces or press ram adjustment.

Stack-Ups

Tolerance accumulations.

Stainless Steel

Various terrific alloys exhibiting high oxidation resistance through the alloying with chromium and nickel. Corrosion resistant steel of a wide variety, but always containing a high percentage of chromium. Stainless steels are highly resistant to corrosion attack by organic acids, weak mineral acids, atmospheric oxidation, etc.

Stains

Discoloration on the surface of sheet metal, caused during mill processing.

Staking

Method of fastening using displaced material for retention.

Stamp

The general term to denote all press workings. To impress lettering or designs by pressure into the surface of a material, often metal.

Stamping

A term used to refer to various press forming operations in coining, embossing, blanking, and pressing. Forming metals using pressure into the surface of a metal, usually strip or sheet.

Stamping Flange Angle

Angle measured from the mating flange area to the upturned flange formed by the flanging operation.

Standard Vee Die

See v die.

Standoff Blocks

Blocks normally located near each rider pin to prevent the die from closing too far. Used to determine the proper ram adjustment. See stop blocks and leveling blocks.

Starting Ring

See pre-hem steel.

Starting Steel

See pre-hem steel.

Steel Rule Die

A die employing a thin strip of steel formed to the outline of a part and a flat metal plate or block of wood for the punch. Used to cut non-metallic material, soft metals, and low run prototype sheet metal parts. Also called cookie cutter die.

Steels

See details.

Stiffening Rib

Embossed feature in a sheet metal workpiece which is added to make the part more rigid.

Stitch and Run Die

Staking same size blanks together with each stroke of the press forming a continuous strip. Then feeding this staked strip through the die as in a coil.

Stock

snape and also to an individual piece of metal that is formed, forged, or machined to make parts.

Stock Check

A device used to grip the material as the feed retracts, preventing movement of the material during the forming cycle.

Stock Guide

A device used to direct a strip or sheet material thru the die.

Stock Reel

A powered or non-powered device used to support a coil of material as it is fed into the machine.

Stock Straightener

A machine mounted device consisting of a series of adjustable rolls used to straighten wire or strip stock as it comes off the coil.

Stock Strip

See skeleton.

Stone

A coarse grit hone that is used dry.

Stool

Lower section of a die on which the part nests. Also called lower adapter, boss, die post, horn, locator, master, or master plug. A base for a punch retainer to enable the punch to reach thru the, pad or stripper. Also called a pedestal, punch riser, and riser.

Stop

A device for positioning stock or parts in a die.

Stop, Automatic

A device for positioning stock in a die. A mechanism that initiates the stopping action of a press after its complete cycle. A device which initiates the stopping action of a press at the start of operating troubles for protecting either the die or the operator, such as misfeeding, buckling of strip stock, or non-discharge of blanks.

Stop Blocks

Blocks normally located near each rider pin to prevent the die from closing too far. Used to determine the proper ram adjustment. Also called stand off blocks and bottoming blocks.

Stop Pin

A device for positioning stock or parts in a die.

Storage Blocks

Urethane blocks generally used in trim and pierce dies to prevent chipping of steels during storage and handling. Also aids in noise reduction, leveling the press ram, and reducing die shock.

Straight Cam

A cam that travels 90° to press stroke. Also called horizontal cam.

Straight Perimeter Contour

Curvature of the peripheral edge that has no radius.

Straightener Rolls

See roll straightener.

Straight-Side Press

An upright press open at front and back with the columns (uprights) at the ends of the bed.

Strain

The amount of elongation or compression that occurs in a metal at a given stress or load produced by an outside force. Generally in terms of inches elongation per inch of material. Strains may be either positive (elongation) or negative (compression), and may be either elastic (recoverable) or plastic (permanent).

Strain Aging

The changes in ductility, hardness, yield point, and tensile strength that occur when a metal or alloy that has been cold worked is stored for some time. In steel, strain aging is characterized by a loss of ductility and a corresponding increase in hardness, yield point, and tensile strength.

Strain Hardening

An increase in hardness and strength caused by plastic deformation at temperatures below the recrystallization range. Also known as work hardening.

Strain Hardening Coefficient

See strain hardening exponent.

Strain Hardening Exponent

The value n in the relationship=KEn, where is the true stress; E is the true strain; and K, which is called the strength coefficient, is equal to the true stress at a true strain of I.O. The strain-hardening exponent, also called n-value, is equal to the slope of the true stress/true strain curve up to maximum load, when plotted on log-log coordinates. The n-value relates to the ability of a sheet material to be stretched in metalworking operations. The higher the n-value, the better the formability (stretchability).

Strain-Rate Sensitivity (m Value)

The increase in stress ( ) needed to cause a certain increase in plastic strain rate (i) at a given level of plastic strain (E) and a given temperature (T). Strain-rate sensitivity=m=A log a@ (A log i). T stress. The intensity of the internally distributed forces or components of forces that resist a change in the volume or shape of a material that is or has been subjected to external forces. Stress is expressed in force per unit area. Stress can be normal (tension or compression) or shear.

Stress

The internal force or forces set up within a metal body by outside applied forces or loads.

Stress Cracking

The fracturing of parts which have retained residual stresses from cold forming, heat treating, or rapid cooling.

Stress Raisers

Design features (such as sharp corners) or mechanical defects (such as notches) that act to intensify the stress at these locations.

Stress-Strain Curve

See stress-strain diagram.

Stress-Strain Diagram

A graph in which corresponding values of stress and strain from a tension, compression, or torsion test are plotted against each other. Values of stress are usually plotted vertically (ordinates or y-axis) and values of strain horizontally (abscissas or x-axis). Also known as deformation curve and stress-strain curve.

Stretch Drawing

The process of holding a blank with an upper and lower ring, the lower ring being mounted on a nitrogen actuated pressure pad. Both upper and lower rings are lowered to a dwell position stretching the material over the lower die. The upper die then closes to complete the forming operation of this die.

Stretch Former

A machine used to perform stretch forming operations. A device adaptable to a conventional press for accomplishing stretch forming.

Stretch Forming

The shaping of a sheet or part, usually of uniform cross section, by first applying suitable tension or stretch and then wrapping it around a die of the desired shape. This method is more rapid than hammering and beating.

Stretcher Leveled

A flattening process in which a material is stretched to achieve a desired flatness tolerance.

Stretcher Leveling

The leveling of a piece of sheet metal (that is, removing warp and distortion) by gripping it at both ends and subjecting it to a stress higher than its yield strength.

Stretcher Straightening

A process for straightening rod, tubing, and shapes by the application of tension at the ends of the stock. The products are elongated a definite amount to remove warpage.

Stretcher Strains

Elongated markings that appear on the surface of some sheet materials when deformed just past the yield point. These markings lie approximately parallel to the direction of maximum shear stress and are the result of localized yielding. See also Luders lines.

Stretching

The extension of the surface of a sheet in all directions. In stretching, the flange of the flat blank is securely clamped. Deformation is restricted to the area initially within the die. The stretching limit is the onset of metal failure. The “n” in the equation=Kn which equates the true stress to the true strain of a material under plastic deformation. The n-value is measured from a tensile test by finding the slope of the true-stress to true-strain in the plastic region. It is also referred to as the n-value.

Striker

See sled runner.

Striking Surface

Those areas on the faces of a set of dies that are designed to meet when the upper die and lower die are brought together. The striking surface helps protect impressions from impact shock and aids in maintaining longer die life.

Strip

A flat-rolled metal product of some maximum thickness and width arbitrarily dependent on the type of metal; narrower than sheet. A sheet of metal whose length is many times its width.

Strip Edge Forming

The use of a rolling technique to edge roll slit strip with shaped edge rolls to provide an edge finish equal to the material's surface finish. Also called edge conditioning.

Strip Steel (Cold Rolled)

A flat cold rolled steel product (Other than Flat Wire) 23 15/16 and narrower; under 0.250 in thickness, which has been cold reduced to desired decimal thickness and temper on single stand, single stand reversing, or tandem cold mills in coil form from coiled hot rolled pickled strip steel.

Stripper

A plate designed to remove, or strip, sheet metal stock from the punching members during the punching process. Strippers are also used to guide small precision punches in close-tolerance dies, to guide scrap away from dies, and to assist in the cutting action. Strippers are made in two types: fixed and movable.

Stripper Bolts

A socket head screw with a larger machined body than the threaded end. Stripper bolts are made to bottom on the body's shoulder. They are used to contain pads or springs and for other tasks and are also called shoulder bolts or shoulder screws.

Stripper Insert

See window.

Stripper Marks

Imprints on one side of the stock around pierced holes, caused by punch strippers.

Stripper Plate

A plate (solid or moveable) used to strip the workpiece or part from the punch. It may also guide the stock.

Stripper Punch

A punch that serves as the top or bottom of the shoulder screw cavity and later moves farther into the die to eject the part or compact. See also ejector rod and knockout.

Stripping

Process of disengaging tooling from the workpiece.

Strips

Sheet material, sheared into narrow long pieces.

Stroke

Ram travel from top dead center (TDC) to bottom dead center (BDC).

Stroke (Up or Down)

The vertical movement of a ram during half of the cycle, from the full open to the full closed position or vice versa.

Stroke of a Press

The reciprocating motion of a press slide, specified as the number of inches between the terminal points of the motion.

Structural Quality

Material applicable to the various classes of structures, indicated by the standard specifications, which is suitable for the different mechanical operations employed for the fabrication of such structures. Structural quality (the characteristics of which are defined in the standard specifications of the American Society for Testing Materials) represents the quality of steel produced under regular or normal manufacturing conditions.

Substrate

Original material surface to which a coating is applied.

Sump

A formed recess area of a part usually for clearance. See spot face.

Superior Hone

A tool which employs bonded abrasive stones in a special holder to remove stock and improve surface finish of holes.

Superplasticity

The ability of certain metals to develop extremely high tensile elongations at elevated temperatures and under controlled rates of deformation.

Support Plate

A plate that supports a draw ring or draw plate. It also serves as a spacer.

Surface

The ability of the CAD software to recognize that a closed geometric shape represents a surface of a part. Includes recognition of wireframes.

Surface Distortion

Surface distortions are wrinkles formed on the grade-A surfaces of panels due to improper hemming operation.

Surface Inclusions

Debris rolled into the skin of material causing a depression or thinly coated pocket.

Surge Tank

A tank designed to accept a volume of air, gas on the compression stroke of a cylinder and to provide an extra volume of air, gas, or oil on the power stroke of the cylinder. Also prevents excess pressure buildup in a cylinder and/or lines.

Surgical Stainless Steel Types

Any of the 300 series stainless steels with an 18% chromium and 8% nickel content. Also includes the PH type of stainless steels.

Swift Cup Test

A simulative test in which circular blanks of various diameter are clamped in a die ring and deep drawn into a cup by a flat-bottomed cylindrical punch. The ratio of the largest blank diameter that can be drawn successfully to the cup diameter is known as the limiting draw ratio (LDR) or deformation limit.

Swivel Ring

A load-centering eye bolt that allows the eye to pivot 180° and the base to swivel 360° that allows the bolt to be pulled at any angle without fear of bending or breaking the bolt.

T Missing

U-Bend Die

A die, commonly used in press-brake forming, that is machined horizontally with a square or rectangular cross-sectional opening that provides two edges over which metal is drawn into a channel shape.

Ultimate Strength

The maximum stress (tensile, compressive, or shear) a material can sustain without fracture; determined by dividing maximum load by the original cross-sectional area of the specimen. Also known as nominal strength or maximum strength.

Ultrasonic Gage

A parameter measured in a tensile test used as a measure of ductility defined by: Final Gauge Length-Original Gauge Length×100 Original Gauge Length.

Undercrown

The term used to signify that the surface does not have enough height to the curvature.

Undercut

Condition of the stock resulting from welding or grinding below a desired plane. See relief.

Underdrive Press

A press in which the driving mechanism is located within or under the press bed or below the floor line.

Unfolded

The act of developing a fiat pattern.

V Die

Tool used in conjunction with a V punch.

V Punch

Vee shaped tool used for angle forming.

V-Bend Die

A die commonly used in press-brake forming, usually machined with a triangular cross-sectional opening to provide two edges as fulcrums for accomplishing three-point bending.

Velocity of Final Hem Steel

Speed at which the final hem steel travel during final hem.

Vent Mark

A small protrusion resulting from the entrance of metal into die vent holes.

Vent

A small hole in a punch or die for admitting air to avoid suction holding or to relieve pockets of trapped air which would prevent proper die closure or action, and also reduces press tonnage required.

Vibratory Finishing

Burr removal process in which an appropriate number of parts, depending on part size and abrasive material, is accelerated and decelerated by mechanical means inside of a drum-like enclosure.

Viscosity

Internal friction within a fluid which makes it resistant to flow.

Void

Area in a weld in which insufficient filler material is deposited.

Walking Cam

A cam attached to the upper half of the die with a driver on the bottom half of the die. Also called an aerial cam, dog leg cam, or flying cam

Warp

As opposed to hem curved outboard and hem deflection warp is the term used for the local curve at the hem edge.

Water-Borne

Generic designation for a variety of organic finishes which indicates that they are compounded with water as a dilutant rather than a volatile organic solvent.

Water-Soluble

Substance, which dissolves in water.

Watts Per Square Inch

Measure of speed based on power level of laser cutting machine.

Wave

A condition of non-flatness. A fabricated piece of metal that is not completely flat and has a slight wave following the direction of rolling and beyond the standard limitation for flatness.

Wavy

Not flat. A slight wave following the direction of rolling and beyond the standard limitation for flatness.

Wear Plates

Plates made of hardened tool, steel, or bronze. Used where dies receive the greatest wear to enable resurfacing and shimming of the plates to renew wear surfaces. Normally they are used in pairs, one steel and the mating one bronze.

Web

A narrow strip, which connects the part to the skeleton or adjoining part. The center, along the axis, of a twist drill. Any narrow section of a die connecting one section to another.

Webs

Material between two openings or edges. See micro ties. In some industries, thin material to be punched.

Weld Accessibility

Ease of reaching the weld area with the torch or electrode.

Weld Distortion

Depression or bulge on surface, caused by thermal expansion.

Weld Nut

Internally threaded hardware designed to be spot or projection welded onto sheet metal parts.

Weld Stud

Externally threaded hardware in various lengths in headed and head-less version, welded in place.

Weldability

Ability of a material to be fused successfully without special processing.

Weld-to-Edge Distance

Minimum distance from a spot weld to the material edge to create an acceptable spot weld.

Weld-to-Form Distance

Minimum distance from a formed area to electrodes to avoid shorting.

Weld-to-Weld Spacing

Minimum distance between spot welds to avoid shunting through the existing weld spot.

Welding

Welding is a process for joining similar metals. Welding joins metals by melting and fusing the base metals being joined and the filler metal applied. Welding employs pinpointed, localized heat input. Most welding involves ferrous-based metals such as steel and stainless steel. Welding covers a temperature range of 1500° F.-3000° F. Weld joints are usually stronger than, or as strong as, the base metals being joined. Typically, welding is used for forging, blacksmithing, oil pipelines, and food equipment applications. See electrode, MIG, and TIG.

Window

A separately mounted steel used to gain access to perishable details or other die components. Also called pad window, stripper insert, or insert.

Wipe Die

Forming tool using two opposing edges, separated by one material thickness, moving past each other to form material.

Wiping Steel

A steel used in various forming operations in which a narrow metal strip at the edge of a sheet or metal part is bent down along a straight or curved line. It is also referred to as flange steel.

Wire Form

A formed metal part made from wire that is usually fabricated on a slide forming machine.

Wire Line

A standard dimension from the bed of the slide forming machine to the material used in tool layout.

Wire-Drawing

A metal-reducing process in which a wire rod is pulled or drawn through a single die or a series of continuous dies, thereby reducing its diameter. Because the volume of the wire remains the same, the length of the wire changes according to its new diameter.

Wireframe

The capability of the CAD software to represent a design as a three dimensional arrangement of lines and arcs.

Work (Strain) Hardening Coefficient

Shown as n. It is a mathematical value in the generalized (Swift's or Krupkowski's) power law.

Work Hardening

Increase in tensile strength of material resulting from cold working process. See strain hardening.

Work Hole

See tooling hole.

Work to Tight Fitting Tolerances

Skilled trade-persons are often called upon to assemble, produce and repair components to close tolerances. This means that they have to work to a specified size and make the components as stated in the drawing of the part. If parts are not made to close tolerance the clearance or lack of clearance may cause the equipment to fail prematurely.

Workability

See formability.

Workholder

Mechanical device which holds a workpiece.

Workholder Mark

Marring of material through the use of clamping device.

Workpiece

That piece of metal or object that is intended to be subjected to, or is being subjected to, any of the metal forming processes such as casting, forging, stamping and machining.

Worldscan

An instrument that employs ultrasonic sound waves to measure the thickness of steel.

Wrap Forming

See stretch forming.

Wring Fit

Class of fit which is between a slip fit and a press fit. Usually requiring a slight twisting action to put the parts together.

Wrinkling

A coating defect consisting of the formation of small ridges or folds in the coating which resemble the surface of a prune, but are usually smaller in size.

Wrought

Describes material which has been plastically deformed into shape as by mill rolling.

Yield

Evidence of plastic deformation in structural materials. Also known as plastic flow or creep.

Yield Point

The first stress in a material, usually less than the maximum attainable stress, at which an increase in strain occurs without an increase in stress during tensile testing. Only certain metals-those which exhibit a localized, heterogeneous type of transition from elastic to plastic deformation, produce a yield point. If there is a decrease in stress after yielding, a distinction can be made between upper and lower yield points.

Yield Point Elongation

The extension associated with discontinuous yield which occurs at approximately constant load following the onset of plastic flow. It is associated with the propagation of Luder lines or bands.

Yield Strength

The stress at which a material exhibits a specified limiting deviation from the proportionality of stress to strain during tensile testing. An offset of 0.2% is used for many metals. Compare with tensile strength and yield stress. The stress level of highly ductile materials, such as structural steels, at which large strains take place without further increase in stress.

Yield Stress

A stress at which a steel exhibits the first measurable permanent plastic deformation. The level of stress when plastic flow begins during a uniaxial tensile test.

Young's Modulus or Elastic Modulus

The stress at which a material initially exhibits permanent plastic deformation in a tensile test.

Second to establishing the proper terminology but no less important is to provide the fundamental standards and classification of metal work/production to include the products and treatments for completing fabrication and applications. This essential information is provided for easy use by those skilled in the art and those learning the art to determine the exact materials, process and machinery to be used in the production of a device, part or in this case implement via these unique production innovations.

For the most part material properties and qualities are well documented as industry standards by the National Institute Of Standards. The forming of component parts, include forging striking, stamping, milling, braking, bending powdering, painting and plating to manufacture and construct a device like the exemplary “Willy grip” the standards and fabricated metal classifications are provided to the reader/engineer as parT of this teaching before the unique modalities are taught

NAIC Standard Classification 332 Fabricated Metal Product Manufacturing

The technical innovations apply to industries in the fabricated metal product manufacturing sub sector transform metal into or treating metals and metal formed products fabricated elsewhere. The important fabricated metal processes are forging, milling rolling, Jul. 14, 2005 stamping, bending, forming, and machining, used to shape individual pieces of metal; and other processes, such as welding and assembling, used to join separate parts together to include standard forms of fasteners. A Sub sector may use one of these processes or a combination of these processes. The NAICS structure for this sub sector distinguishes the forging and stamping processes in a single industry. The remaining industries, in the sub sector, group establishments based on similar combinations of processes used to make products.

3321 Forging and Stamping

The manufacturing performed in the fabricated metal product manufacturing sub sector begins with manufactured metal shapes. The establishments in this sector further fabricate the purchased metal shapes into a product. For instance, the spring and wire product manufacturing industry starts with wire and fabricates such items.

Within manufacturing there are other establishments that make the same products made by this sub sector; only these establishments begin production further back in the production process. These establishments have a more integrated operation. For instance, one establishment may manufacture steel, draw it into wire, and make wire products in the same establishment. Such operations are classified in the Primary Metal Manufacturing sub sector.

33211 Forging and Stamping

This industry comprises establishments primarily engaged in one or more of the following: (1) manufacturing forgings from purchased metals; (2) manufacturing metal custom roll forming products; (3) manufacturing metal stamped and spun products (except automotive, cans, coins); and (4) manufacturing powder metallurgy products. Establishments making metal forgings, metal stampings, and metal spun products and further manufacturing (e.g., machining, assembling) a specific manufactured product are classified in the industry of the finished product. Metal forging, metal stamping, and metal spun products establishments may perform surface finishing operations, such as cleaning and deburring, on the products they manufacture.

Cross-references. Establishments primarily engaged in
Manufacturing metal forgings in integrated primary metal establishments—are classified in Sub sector 331, Primary Metal Manufacturing;
Stamping automotive stampings-are classified in Industry 336370, Motor Vehicle Metal Stamping;
Manufacturing and installing rolled formed seamless gutters at construction sites—are classified in Industry 238390, Other Building Finishing Contractors; and
Stamping coins—are classified in Industry 33991, Jewelry and Silverware Manufacturing.
   332111 Iron and Steel Forging

This U.S. industry comprises establishments primarily engaged in manufacturing iron and steel forgings from purchased iron and steel by hammering mill shapes. Establishments making iron and steel forgings and further manufacturing (e.g., machining, assembling) a specific manufactured product are classified in the industry of the finished product. Iron and steel forging establishments may perform surface finishing operations, such as cleaning and deburring, on the forgings they manufacture.

Cross-References. Establishments primarily engaged in
Manufacturing iron and steel forgings in integrated iron and steel mills—are classified in U.S. Industry 331111, Iron and Steel Mills; and
Manufacturing nonferrous forgings—are classified in U.S. Industry 332112, Nonferrous Forging.
   332112 Nonferrous Forging

This U.S. industry comprises establishments primarily engaged in manufacturing nonferrous forgings from purchased nonferrous metals by hammering mill shapes. Establishments making nonferrous forgings and further manufacturing (e.g., machining, assembling) a specific manufactured product are classified in the industry of the finished product. Nonferrous forging establishments may perform surface finishing operations, such as cleaning and deburring, on the forgings they manufacture.

Cross-References. Establishments primarily engaged in
Manufacturing iron and steel forgings—are classified in U.S. Industry 332111, Iron and Steel Forging; and
   Manufacturing nonferrous forgings in integrated primary or secondary nonferrous metal production facilities-are classified in Subsector 331, Primary Metal Manufacturing.
   332114 Custom Roll Forming

This U.S. industry comprises establishments primarily engaged in custom roll forming metal products by use of rotary motion of rolls with various contours to bend or shape the products.

Cross-References. Establishments primarily engaged in manufacturing and installing rolled formed seamless gutters at construction sites are classified in Industry 238390, Other Building Finishing Contractors.

332115 Crown and Closure Manufacturing

This U.S. industry comprises establishments primarily engaged in stamping metal crowns and closures, such as bottle caps and home canning lids and rings.

332116 Metal Stamping

This U.S. industry comprises establishments primarily engaged in manufacturing unfinished metal stampings and spinning unfinished metal products (except crowns, cans, closures, automotive, and coins). Establishments making metal stampings and metal spun products and further manufacturing (e.g., machining, assembling) a specific product are classified in the industry of the finished product. Metal stamping and metal spun products establishments may perform surface finishing operations, such as cleaning and deburring, on the products they manufacture.

Cross-References. Establishments primarily engaged in
Stamping automotive stampings-are classified in Industry 336370, Motor Vehicle Metal Stamping;
Stamping metal crowns and closures-are classified in U.S. Industry 332115, Crown and Closure Manufacturing;
Manufacturing metal cans-are classified in U.S. Industry 332431, Metal Can Manufacturing; and
   Stamping coins—are classified in U.S. Industry 339911, Jewelry (except Costume) Manufacturing.
   332117 Powder Metallurgy Part Manufacturing

This U.S. industry comprises establishments primarily engaged in manufacturing powder metallurgy products by compacting them in a shaped die and sintering. Establishments in this industry generally make a wide range of parts on a job or order basis.

3322 Cutlery and Handtool Manufacturing

33221 Cutlery and Handtool Manufacturing

This industry comprises establishments primarily engaged in one or more of the following: (1) manufacturing nonprecious and precious plated metal cutlery and flatware; (2) manufacturing nonpowered hand and edge tools; (3) manufacturing nonpowered handsaws; (4) manufacturing saw blades, all types (including those for sawing machines); and (5) manufacturing metal kitchen utensils (except cutting-type) and pots and pans (except those manufactured by casting (e.g., cast iron skillets) or stamped without further fabrication).

Cross-References. Establishments primarily engaged in
Manufacturing precious (except precious plated) metal cutlery and flatware—are classified in Industry 33991, Jewelry and Silverware Manufacturing;
Manufacturing electric razors and hair clippers for use on humans—are classified in Industry 33521, Small Electrical Appliance Manufacturing;
Manufacturing power hedge shears and trimmers and electric hair clippers for use on animals—are classified in Industry 33311, Agricultural Implement Manufacturing;
Manufacturing metal cutting dies, attachments, and accessories for machine tools—are classified in Industry 33351, Metalworking Machinery Manufacturing;
Manufacturing handheld power-driven handtools—are classified in Industry 33399, All Other General Purpose Machinery Manufacturing; and
Manufacturing finished cast iron kitchen utensils (i.e., cast iron skillets) and castings for kitchen utensils, pots, and pans—are classified in Industry Group 3315, Foundries.
   332211 Cutlery and Flatware (except Precious) Manufacturing

This U.S. industry comprises establishments primarily engaged in manufacturing nonprecious and precious plated metal cutlery and flatware.

Cross-References. Establishments primarily engaged in
Manufacturing precious (except precious plated) metal cutlery and flatware—are classified in U.S. Industry 339912, Silverware and Hollowware Manufacturing;
Manufacturing electric razors and hair clippers for use on humans and housewares—are classified in U.S. Industry 335211, Electric Housewares and Household Fan Manufacturing;
Manufacturing power hedge shears and trimmers and electric hair clippers for animal use—are classified in U.S. Industry 333112, Lawn and Garden Tractor and Home Lawn and Garden Equipment Manufacturing; and
   Manufacturing nonelectric hair clippers for use on animals—are classified in U.S. Industry 332212, Hand and Edge Tool Manufacturing.
   332212 Hand and Edge Tool Manufacturing

This industry comprises establishments primarily engaged in manufacturing nonpowered hand and edge tools (except saws).

Cross-References. Establishments primarily engaged in
Manufacturing saw blades and handsaws—are classified in U.S. Industry 332213, Saw Blade and Handsaw Manufacturing;
Manufacturing metal cutting dies, attachments, and accessories for machine tools—are classified in Industry 33351, Metalworking Machinery Manufacturing;
Manufacturing handheld power-driven handtools—are classified in U.S. Industry 333991, Power-Driven Handtool Manufacturing;
Manufacturing electric razors and hair clippers for use on humans—are classified in U.S. Industry 335211, Electric Housewares and Household Fan Manufacturing;
Manufacturing electric hair clippers for use on animals—are classified in U.S. Industry 333111, Farm Machinery and Equipment Manufacturing; and
   Manufacturing nonelectric household-type scissors and shears—are classified in U.S. Industry 332211, Cutlery and Flatware (except Precious) Manufacturing.
   332213 Saw Blade and Handsaw Manufacturing

This U.S. industry comprises establishments primarily engaged in (1) manufacturing nonpowered handsaws and/or (2) manufacturing saw blades, all types (including those for power sawing machines).

Cross-References. Establishments primarily engaged in manufacturing handheld powered saws are classified in U.S. Industry 333991, Power-Driven Handtool Manufacturing.

3323 Architectural and Structural Metals Manufacturing

33231 Plate Work and Fabricated Structural Product Manufacturing

This industry comprises establishments primarily engaged in manufacturing one or more of the following: (1) prefabricated metal buildings, panels and sections; (2) structural metal products; and (3) metal plate work products.

Cross-References. Establishments primarily engaged in
Making manufactured homes (i.e., mobile homes) and prefabricated wood buildings—are classified in Industry 32199, All Other Wood Product Manufacturing;
Constructing buildings, bridges, and other heavy construction projects on site—are classified in Sector 23, Construction;
Building ships, boats and barges—are classified in Industry 33661; Ship and Boat Building;
Manufacturing power boilers and heat exchangers—are classified in Industry 332410, Power Boiler and Heat Exchanger Manufacturing;
Manufacturing heavy gauge tanks—are classified in Industry 332420, Metal Tank (Heavy Gauge) Manufacturing;
Manufacturing metal plate cooling towers—are classified in Industry 33341, Ventilation, Heating, Air-Conditioning, and Commercial Refrigeration Equipment Manufacturing; and
Manufacturing metal windows, doors, and studs—are classified in Industry 33232, Ornamental and Architectural Metal Products Manufacturing.
   332311 Prefabricated Metal Building and Component Manufacturing

This U.S. industry comprises establishments primarily engaged in manufacturing prefabricated metal buildings, panels, and sections.

Cross-References. Establishments primarily engaged in
Making manufactured homes (i.e., mobile homes) and prefabricated wood buildings—are classified in Industry 32199, All Other Wood Product Manufacturing;
Constructing prefabricated buildings on site—are classified in Subsector 236, Construction of Buildings; and
   Manufacturing metal windows and doors—are classified in U.S. Industry 332321, Metal Window and Door Manufacturing.
   332312 Fabricated Structural Metal Manufacturing

This U.S. industry comprises establishments primarily engaged in fabricating structural metal products, such as concrete reinforcing bars and fabricated bar joists.

Cross-References. Establishments primarily engaged in
Manufacturing metal windows and doors—are classified in U.S. Industry 332321, Metal Window and Door Manufacturing;
Manufacturing metal studs—are classified in U.S. Industry 332322, Sheet Metal Work Manufacturing;
Constructing buildings, bridges, and other heavy construction projects on site—are classified in Sector 23, Construction;
Building ships, boats and barges—are classified in Industry 33661, Ship and Boat Building; and
   Prefabricating metal buildings, panels, and sections—are classified in U.S. Industry 332311, Prefabricated Metal Building and Component Manufacturing.
   332313 Plate Work Manufacturing

This industry comprises establishments primarily engaged in manufacturing fabricated metal plate work by cutting, punching, bending, shaping, and welding purchased metal plate.

Cross-References. Establishments primarily engaged in
Manufacturing power boilers and heat exchangers—are classified in Industry 332410, Power Boiler and Heat Exchanger Manufacturing;
Manufacturing heavy gauge tanks—are classified in Industry 332420, Metal Tank (Heavy Gauge) Manufacturing; and
   Manufacturing metal plate cooling towers—are classified in U.S. Industry 333415, Air-Conditioning and Warm Air Heating Equipment and Commercial and Industrial Refrigeration Equipment Manufacturing.
   33232 Ornamental and Architectural Metal Products Manufacturing

This industry comprises establishments primarily engaged in manufacturing one or more of the following: (1) metal framed windows (i.e., typically using purchased glass) and metal doors; (2) sheet metal work; and (3) ornamental and architectural metal products.

Cross-References. Establishments primarily engaged in
Manufacturing metal covered (i.e., clad) wood windows and doors—are classified in Industry 32191, Millwork;
Manufacturing bins, cans, vats, and light tanks of sheet metal—are classified in Industry 33243, Metal Can, Box, and Other Metal Container (Light Gauge) Manufacturing;
Manufacturing prefabricated metal buildings, panels, and sections—are classified in Industry 33231, Plate Work and Fabricated Structural Product Manufacturing;
Fabricating sheet metal work on site—are classified in Subsector 238, Specialty Trade Contractors;
Manufacturing metal stampings (except automotive, coins) and custom roll forming products—are classified in Industry 33211, Forging and Stamping;
Manufacturing automotive stampings—are classified in Industry 336370, Motor Vehicle Metal Stamping; and
Stamping coins—are classified in Industry 33991, Jewelry and Silverware Manufacturing.
   332321 Metal Window and Door Manufacturing

This U.S. industry comprises establishments primarily engaged in manufacturing metal framed windows (i.e., typically using purchased glass) and metal doors. Examples of products made by these establishments are metal door frames; metal framed window and door screens; and metal molding and trim (except automotive).

Cross-References. Establishments primarily engaged in
Manufacturing wood or metal covered (i.e., clad) wood framed windows and doors—are classified in U.S. Industry 321911, Wood Window and Door Manufacturing; and
   Manufacturing metal automotive molding and trim—are classified in Industry 336370, Motor Vehicle Metal Stamping.
   332322 Sheet Metal Work Manufacturing

This U.S. industry comprises establishments primarily engaged in manufacturing sheet metal work (except stampings).

Cross-References. Establishments primarily engaged in
Manufacturing sheet metal bins, vats, and light tanks of sheet metal—are classified in U.S. Industry 332439, Other Metal Container Manufacturing;
Manufacturing metal cans, lids, and ends—are classified in U.S. Industry 332431, Metal Can Manufacturing;
Fabricating sheet metal work on site—are classified in Subsector 238, Specialty Trade Contractors;
Manufacturing metal stampings (except automotive, coins) and custom roll forming products—are classified in Industry 33211, Forging and Stamping;
Manufacturing automotive stampings—are classified in Industry 336370, Motor Vehicle Metal Stamping; and
   Stamping coins—are classified in U.S. Industry 339911, Jewelry (except Costume) Manufacturing.
   332323 Ornamental and Architectural Metal Work Manufacturing

This U.S. industry comprises establishments primarily engaged in manufacturing ornamental and architectural metal work, such as staircases, metal open steel flooring, fire escapes, railings, and scaffolding.

Cross-References. Establishments primarily engaged in manufacturing prefabricated metal buildings, panels, and sections are classified in U.S. Industry 332311, Prefabricated Metal Building and Component Manufacturing.

3324 Boiler, Tank, and Shipping Container Manufacturing

33241 Power Boiler and Heat Exchanger Manufacturing

See industry description for 332410 below.

332410 Power Boiler and Heat Exchanger Manufacturing

This industry comprises establishments primarily engaged in manufacturing power boilers and heat exchangers. Establishments in this industry may perform installation in addition to manufacturing power boilers and heat exchangers.

Cross-References. Establishments primarily engaged in
Manufacturing heavy gauge metal tanks—are classified in Industry 332420, Metal Tank (Heavy Gauge) Manufacturing;
Manufacturing steam or hot water low pressure heating boilers—are classified in U.S. Industry 333414, Heating Equipment (except Warm Air Furnaces) Manufacturing; and
   Installing power boilers and heat exchanges without manufacturing—are classified in Industry 238220, Plumbing, Heating, and Air-Conditioning Contractors.
   33242 Metal Tank (Heavy Gauge) Manufacturing

See industry description for 332420 below.

332420 Metal Tank (Heavy Gauge) Manufacturing

This industry comprises establishments primarily engaged in cutting, forming, and joining heavy gauge metal to manufacture tanks, vessels, and other containers.

Cross-References. Establishments primarily engaged in
Manufacturing power boilers—are classified in Industry 332410, Power Boiler and Heat Exchanger Manufacturing;
Manufacturing light gauge metal containers—are classified in Industry 33243, Metal Can, Box, and Other Metal Container (Light Gauge) Manufacturing; and
   Installing heavy gauge metal tanks without manufacturing—are classified in Industry 238120, Structural Steel and Precast Concrete Contractors.
   33243 Metal Can, Box, and Other Metal Container (Light Gauge) Manufacturing

This industry comprises establishments primarily engaged in forming light gauge metal containers.

Cross-References. Establishments primarily engaged in
Manufacturing foil containers—are classified in Industry 33299, All Other Fabricated Metal Product Manufacturing;
Reconditioning barrels and drums—are classified in Industry 811310, Commercial and Industrial Machinery and Equipment (except Automotive and Electronic) Repair and Maintenance; and
Manufacturing heavy gauge metal containers—are classified in Industry 332420, Metal Tank (Heavy Gauge) Manufacturing.
   332431 Metal Can Manufacturing

This U.S. industry comprises establishments primarily engaged in manufacturing metal cans, lids, and ends.

Cross-References. Establishments primarily engaged in
Manufacturing foil containers—are classified in U.S. Industry 332999, All Other Miscellaneous Fabricated Metal Product Manufacturing; and
Manufacturing light gauge metal containers (except cans)—are classified in U.S. Industry 332439, Other Metal Container Manufacturing.
   332439 Other Metal Container Manufacturing

This U.S. industry comprises establishments primarily engaged in manufacturing metal (light gauge) containers (except cans).

Cross-References. Establishments primarily engaged in
Manufacturing foil containers—are classified in U.S. Industry 332999, All Other Miscellaneous Fabricated Metal Product Manufacturing;
Manufacturing metal cans—are classified in U.S. Industry 332431, Metal Can Manufacturing;
Reconditioning barrels and drums—are classified in Industry 811310, Commercial and Industrial Machinery and Equipment (except Automotive and Electronic) Repair and Maintenance; and
   Manufacturing heavy gauge metal containers—are classified in Industry 332420, Metal Tank (Heavy Gauge) Manufacturing.
   3326 Spring and Wire Product Manufacturing
   33261 Spring and Wire Product Manufacturing

This industry comprises establishments primarily engaged in (1) manufacturing steel springs by forming, such as cutting, bending, and heat winding, metal rod or strip stock and/or (2) manufacturing wire springs and fabricated wire products from wire drawn elsewhere (except watch and clock springs).

Cross-References. Establishments primarily engaged in
Manufacturing watch and clock springs from purchased wire—are classified in Industry 334510, Navigational, Measuring, Electromedical, and Control Instruments Manufacturing;
Drawing wire and manufacturing wire products—are classified in Subsector 331, Primary Metal Manufacturing; and
Manufacturing nonferrous insulated wire from wire drawn elsewhere—are classified in Industry 33592, Communication and Energy Wire and Cable Manufacturing.
   332611 Spring (Heavy Gauge) Manufacturing

This U.S. industry comprises establishments primarily engaged in manufacturing heavy gauge springs by forming, such as cutting, bending, and heat winding, rod or strip stock.

Cross-References. Establishments primarily engaged in
Manufacturing light gauge springs from purchased wire or strip—are classified in U.S. Industry 332612, Spring (Light Gauge) Manufacturing; and
   Drawing wire and manufacturing wire spring—are classified in Subsector 331, Primary Metal Manufacturing.
   332612 Spring (Light Gauge) Manufacturing

This U.S. industry comprises establishments primarily engaged in manufacturing light gauge springs from purchased wire or strip.

Cross-References. Establishments primarily engaged in
Manufacturing watch and clock springs—are classified in U.S. Industry 334518, Watch, Clock, and Part Manufacturing;
Manufacturing heavy gauge springs—are classified in U.S. Industry 332611, Spring (Heavy Gauge) Manufacturing; and
   Drawing wire and manufacturing wire spring—are classified in Subsector 331, Primary Metal Manufacturing.
   3325 Hardware Manufacturing
   33251 Hardware Manufacturing

See industry description for 332510 below.

332510 Hardware Manufacturing

This industry comprises establishments primarily engaged in manufacturing metal hardware, such as metal hinges, metal handles, keys, and locks (except coin-operated, time locks).

Cross-References. Establishments primarily engaged in
Manufacturing bolts, nuts, screws, rivets, washers, hose clamps, and turn-buckles—are classified in U.S. Industry 332722, Bolt, Nut, Screw, Rivet, and Washer Manufacturing;
Manufacturing nails and spikes from wire drawn elsewhere—are classified in U.S. Industry 332618, Other Fabricated Wire Product Manufacturing;
Manufacturing metal furniture parts (except hardware)—are classified in U.S. Industry 337215, Showcase, Partition, Shelving, and Locker Manufacturing;
Drawing wire and manufacturing nails and spikes—are classified in Subsector 331, Primary Metal Manufacturing;
Manufacturing pole line and transmission hardware—are classified in U.S. Industry 335932, Noncurrent-Carrying Wiring Device Manufacturing;
Manufacturing coin-operated locking mechanisms—are classified in U.S. Industry 333311, Automatic Vending Machine Manufacturing;
Manufacturing time locks—are classified in U.S. Industry 334518, Watch, Clock, and Part Manufacturing;
Manufacturing fireplace fixtures and equipment, traps, handcuffs and leg irons, ladder jacks, and other like metal products—are classified in U.S. Industry 332999, All Other Miscellaneous Fabricated Metal Product Manufacturing;
Manufacturing fire hose nozzles and couplings—are classified in U.S. Industry 332919, Other Metal Valve and Pipe Fitting Manufacturing; and
   Manufacturing luggage and utility racks—are classified in U.S. Industry 336399, All Other Motor Vehicle Parts Manufacturing.
   332618 Other Fabricated Wire Product Manufacturing

This U.S. industry comprises establishments primarily engaged in manufacturing fabricated wire products (except springs) made from purchased wire.

Cross-References. Establishments primarily engaged in
Drawing wire and manufacturing wire products—are classified in Subsector 331, Primary Metal Manufacturing;
Manufacturing heavy gauge springs—are classified in U.S. Industry 332611, Spring (Heavy Gauge) Manufacturing;
Manufacturing light gauge springs from purchased wire or strip—are classified in U.S. Industry 332612, Spring (Light Gauge) Manufacturing; and
   Insulating nonferrous wire from wire drawn elsewhere—are classified in U.S. Industry 335929, Other Communication and Energy Wire Manufacturing.
   3327 Machine Shops; Turned Product; and Screw, Nut, and Bolt Manufacturing
   33271 Machine Shops

See industry description for 332710 below.

332710 Machine Shops

This industry comprises establishments, known as machine shops primarily engaged in machining metal parts on a job or order basis. Generally machine shop jobs are low volume using machine tools, such as lathes (including computer numerically controlled); automatic screw machines; and machines for boring, grinding, and milling.

Cross-References. Establishments primarily engaged in
Repairing industrial machinery and equipment—are classified in Industry 811310, Commercial and Industrial Machinery and Equipment (except Automotive and Electronic) Repair and Maintenance; and
   Manufacturing parts (except on a job or order basis) for machinery and equipment—are generally classified in the same manufacturing industry that makes complete machinery and equipment.
   33272 Turned Product and Screw, Nut, and Bolt Manufacturing

This industry comprises establishments primarily engaged in (1) machining precision turned products or (2) manufacturing metal bolts, nuts, screws, rivets, and other industrial fasteners. Included in this industry are establishments primarily engaged in manufacturing parts for machinery and equipment on a customized basis.

Cross-References. Establishments primarily engaged in manufacturing plastics fasteners are classified in Industry 32619, Other Plastics Product Manufacturing.

332721 Precision Turned Product Manufacturing

This U.S. industry comprises establishments known as precision turned manufacturers primarily engaged in machining precision products of all materials on a job or order basis. Generally precision turned product jobs are large volume using machines, such as automatic screw machines, rotary transfer machines, computer numerically controlled (CNC) lathes, or turning centers.

Cross-References. Establishments primarily engaged in manufacturing metal bolts, nuts, screws, rivets, washers, and other industrial fasteners on machines, such as headers, threaders, and nut forming machines, are classified in U.S. Industry 332722, Bolt, Nut, Screw, Rivet, and Washer Manufacturing.

332722 Bolt, Nut, Screw, Rivet, and Washer Manufacturing

This U.S. industry comprises establishments primarily engaged in manufacturing metal bolts, nuts, screws, rivets, and washers, and other industrial fasteners using machines, such as headers, threaders, and nut forming machines.

Cross-References. Establishments primarily engaged in
Manufacturing precision turned products—are classified in U.S. Industry 332721, Precision Turned Product Manufacturing; and
   Plastics fasteners—are classified in U.S. Industry 326199, All Other Plastics Product Manufacturing.
   3328 Coating, Engraving, Heat Treating, and Allied Activities
   33281 Coating, Engraving, Heat Treating, and Allied Activities

This industry comprises establishments primarily engaged in one or more of the following: (1) heat treating metals and metal products; (2) enameling, lacquering, and varnishing metals and metal products; (3) hot dip galvanizing metals and metal products; (4) engraving, chasing, or etching metals and metal products (except jewelry; personal goods carried on or about the person, such as compacts and cigarette cases; precious metal products (except precious plated flatware and other plated ware); and printing plates); (5) powder coating metals and metal products; (6) electroplating, plating, anodizing, coloring, and finishing metals and metal products; and (7) providing other metal surfacing services for the trade. Establishments in this industry coat engravings and heat treat metals and metal formed products fabricated elsewhere.

Cross-References. Establishments primarily engaged in
Engraving, chasing or etching jewelry, metal personal goods, or precious (except precious plated) metal flatware and other plated ware—are classified in Industry 33991, Jewelry and Silverware Manufacturing;
Engraving, chasing or etching printing plates—are classified in Industry 32312, Support Activities for Printing; and
Both fabricating and coating, engraving, and heat treating metals and metal products—are classified in manufacturing according to the product made.
   332811 Metal Heat Treating

This U.S. industry comprises establishments primarily engaged in heat treating, such as annealing, tempering, and brazing, metals and metal products for the trade.

Cross-References. Establishments primarily engaged in both fabricating and heat treating metal products are classified in the Manufacturing sector according to the product made.

332812 Metal Coating, Engraving (except Jewelry and Silverware), and Allied Services to Manufacturers

This U.S. industry comprises establishments primarily engaged in one or more of the following: (1) enameling, lacquering, and varnishing metals and metal products; (2) hot dip galvanizing metals and metal products; (3) engraving, chasing, or etching metals and metal products (except jewelry; personal goods carried on or about the person, such as compacts and cigarette cases; precious metal products (except precious plated flatware and other plated ware); and printing plates); (4) powder coating metals and metal products; and (5) providing other metal surfacing services for the trade.

Cross-References. Establishments primarily engaged in
Both fabricating and coating and engraving products—are classified in the Manufacturing sector according to the product made;
Engraving, chasing or etching jewelry, metal personal goods, or precious metal products (except precious plated metal flatware and other plated ware)—are classified in Industry 33991, Jewelry and Silverware Manufacturing; and
Engraving, chasing or etching printing plates—are classified in U.S. Industry 323122, Prepress Services.
   3329 Other Fabricated Metal Product Manufacturing

This industry group comprises establishments primarily engaged in manufacturing fabricated metal products (except forgings and stampings, cutlery and handtools, architectural and structural metals, boilers, tanks, shipping containers, hardware, spring and wire products, machine shop products, turned products, screws, and nuts and bolts).

33291 Metal Valve Manufacturing

This industry comprises establishments primarily engaged in manufacturing one or more of the following metal valves: (1) industrial valves; (2) fluid power valves and hose fittings; (3) plumbing fixture fittings and trim; and (4) other metal valves and pipe fittings.

Cross-References. Establishments primarily engaged in
Manufacturing fluid power cylinder and pumps—are classified in Industry 33399, All Other General Purpose Machinery Manufacturing;
Manufacturing intake and exhaust valves for internal combustion engines—are classified in Industry 33631, Motor Vehicle Gasoline Engine and Engine Parts Manufacturing;
Manufacturing metal shower rods and metal couplings from purchased metal pipe—are classified in Industry 33299, All Other Fabricated Metal Product Manufacturing;
Manufacturing plastics aerosol spray nozzles—are classified in Industry 32619, Other Plastics Product Manufacturing;
Casting iron pipe fittings and couplings without machining—are classified in Industry 33151, Ferrous Metal Foundries; and
Manufacturing plastics pipe fittings and couplings—are classified in Industry 32612, Plastics Pipe, Pipe Fitting, and Unlaminated Profile Shape Manufacturing.
   332911 Industrial Valve Manufacturing

This U.S. industry comprises establishments primarily engaged in manufacturing industrial valves and valves for water works and municipal water systems.

Cross-References. Establishments primarily engaged in
Manufacturing fluid power valves—are classified in U.S. Industry 332912, Fluid Power Valve and Hose Fitting Manufacturing; and
Manufacturing plumbing and heating valves—are classified in U.S. Industry 332919, Other Metal Valve and Pipe Fitting Manufacturing.
   332813 Electroplating, Plating, Polishing, Anodizing, and Coloring

This U.S. industry comprises establishments primarily engaged in electroplating, plating, anodizing, coloring, buffing, polishing, cleaning, and sandblasting metals and metal products for the trade.

Cross-References. Establishments primarily engaged in both fabricating and electroplating, plating, polishing, anodizing, and coloring products are classified in the Manufacturing sector according to the product made.

332912 Fluid Power Valve and Hose Fitting Manufacturing

This U.S. industry comprises establishments primarily engaged in manufacturing fluid power valves and hose fittings.

Cross-References. Establishments primarily engaged in
Manufacturing fluid power cylinders—are classified in U.S. Industry 333995, Fluid Power Cylinder and Actuator Manufacturing;
Manufacturing fluid power pumps—are classified in U.S. Industry 333996, Fluid Power Pump and Motor Manufacturing;
Manufacturing intake and exhaust valves for internal combustion engines—are classified in U.S. Industry 336311, Carburetor, Piston, Piston Ring, and Valve Manufacturing;
Manufacturing industrial-type valves—are classified in U.S. Industry 332911, Industrial Valve Manufacturing; and
Manufacturing plumbing and heating valves—are classified in U.S. Industry 332919, Other Metal Valve and Pipe Fitting Manufacturing.
   332913 Plumbing Fixture Fitting and Trim Manufacturing

This U.S. industry comprises establishments primarily engaged in manufacturing metal and plastics plumbing fixture fittings and trim, such as faucets, flush valves, and shower heads.

Cross-References. Establishments primarily engaged in
Manufacturing metal shower rods—are classified in U.S. Industry 332999, All Other Miscellaneous Fabricated Metal Product Manufacturing; and
   Manufacturing fire hose nozzles, lawn hose nozzles, water traps, and couplings—are classified in U.S. Industry 332919, Other Metal Valve and Pipe Fitting Manufacturing.
   332919 Other Metal Valve and Pipe Fitting Manufacturing

This U.S. industry comprises establishments primarily engaged in manufacturing metal valves (except industrial valves, fluid power valves, fluid power hose fittings, and plumbing fixture fittings and trim).

Cross-References. Establishments primarily engaged in
Manufacturing fluid power valves and hose fittings—are classified in U.S. Industry 332912, Fluid Power Valve and Hose Fitting Manufacturing;
Manufacturing industrial valves—are classified in U.S. Industry 332911, Industrial Valve Manufacturing;
Manufacturing plastics aerosol spray nozzles—are classified in U.S. Industry 326199, All Other Plastics Product Manufacturing;
Casting iron pipe fittings and couplings without machining—are classified in U.S. Industry 331511, Iron Foundries;
Manufacturing metal couplings from purchased metal pipe—are classified in U.S. Industry 332996, Fabricated Pipe and Pipe Fitting Manufacturing; and
   Manufacturing plastics pipe fittings and couplings—are classified in U.S. Industry 326122, Plastics Pipe and Pipe Fitting Manufacturing.
   33299 All other Fabricated Metal Product Manufacturing

This industry comprises establishments primarily engaged in manufacturing fabricated metal products (except forgings and stampings, cutlery and handtools, architectural and structural metal products, boilers, tanks, shipping containers, hardware, spring and wire products, machine shop products, turned products, screws, nuts and bolts, and metal valves).

Cross-References. Establishments primarily engaged in
Manufacturing forging and stamping and powder metallurgy parts—are classified in Industry 33211, Forging and Stamping;
Manufacturing cutlery and handtools—are classified in Industry 33221, Cutlery and Handtool Manufacturing;
Manufacturing architectural and structural metals—are classified in Industry Group 3323, Architectural and Structural Metals Manufacturing;
Manufacturing boilers, tanks, and shipping containers—are classified in Industry Group 3324, Boiler, Tank, and Shipping Container Manufacturing;
Manufacturing hardware and safe and vault locks—are classified in Industry 332510, Hardware Manufacturing;
Manufacturing spring and wire products—are classified in Industry 33261, Spring and Wire Product Manufacturing;
Manufacturing machine shop products, turned products, screws, and nuts and bolts—are classified in Industry Group 3327, Machine Shops; Turned Product; and Screw, Nut, and Bolt Manufacturing;
Coating, engraving, heat treating and allied activities—are classified in Industry 33281, Coating, Engraving, Heat Treating, and Allied Activities;
Manufacturing plain bearings—are classified in Industry 33361, Engine, Turbine, and Power Transmission Equipment Manufacturing;
Manufacturing military tanks—are classified in Industry 33699, Other Transportation Equipment Manufacturing;
Manufacturing guided missiles—are classified in Industry 33641, Aerospace Product and Parts Manufacturing;
Manufacturing cast iron pipe and fittings—are classified in Industry 33151, Ferrous Metal Foundries;
Manufacturing pipe system fittings (except cast iron couplings and couplings made from purchased pipe) and metal aerosol spray nozzles—are classified in Industry 33291, Metal Valve Manufacturing;
Manufacturing welded and seamless steel pipes from purchased steel—are classified in Industry 331210, Iron and Steel Pipe and Tube Manufacturing from Purchased Steel;
Manufacturing plastics plumbing fixtures and plastics portable chemical toilets—are classified in Industry 32619, Other Plastics Product Manufacturing;
Manufacturing vitreous and semivitreous pottery sanitary ware—are classified in Industry 32711, Pottery, Ceramics, and Plumbing Fixture Manufacturing;
Manufacturing blasting caps, detonating caps, and safety fuses—are classified in Industry 325920, Explosives Manufacturing;
Manufacturing fireworks—are classified in Industry 32599, All Other Chemical Product and Preparation Manufacturing;
Manufacturing metal furniture frames—are classified in Industry 33721, Office Furniture (including Fixtures) Manufacturing;
Manufacturing nonprecious metal trophies—are classified in Industry 33991, Jewelry and Silverware Manufacturing;
Manufacturing metal mechanically refrigerated drinking fountains—are classified in Industry 33341, Ventilation, Heating, Air-Conditioning, and Commercial Refrigeration Equipment Manufacturing;
Manufacturing metal foil bags—are classified in Industry 32222, Paper Bag and Coated and Treated Paper Manufacturing;
Manufacturing aluminum foil—are classified in Industry 33131, Alumina and Aluminum Production and Processing;
Manufacturing metal foil (except aluminum)—are classified in Industry Group 3314, Nonferrous Metal (except Aluminum) Production and Processing; and
Manufacturing metal burial vaults—are classified in Industry 33999, All Other Miscellaneous Manufacturing.
   332991 Ball and Roller Bearing Manufacturing

This U.S. industry comprises establishments primarily engaged in manufacturing ball and roller bearings of all materials.

Cross-References. Establishments primarily engaged in manufacturing plain bearings are classified in U.S. Industry 333613, Mechanical Power Transmission Equipment Manufacturing.

332992 Small Arms Ammunition Manufacturing

This U.S. industry comprises establishments primarily engaged in manufacturing small arms ammunition.

Cross-References. Establishments primarily engaged in
Manufacturing ammunition (except small arms)—are classified in U.S. Industry 332993, Ammunition (except Small Arms) Manufacturing;
Manufacturing blasting and detonating caps and safety fuses—are classified in Industry 325920, Explosives Manufacturing; and
Manufacturing fireworks—are classified in U.S. Industry 325998, All Other Miscellaneous Chemical Product and Preparation Manufacturing.
   332993 Ammunition (except Small Arms) Manufacturing

This U.S. industry comprises establishments primarily engaged in manufacturing ammunition (except small arms). Examples of products made by these establishments are bombs, depth charges, rockets (except guided missiles), grenades, mines, and torpedoes.

Cross-References. Establishments primarily engaged in
Manufacturing small arms ammunition—are classified in U.S. Industry 332992, Small Arms Ammunition Manufacturing;
Manufacturing blasting and detonating caps and safety fuses—are classified in Industry 325920, Explosives Manufacturing;
Manufacturing fireworks—are classified in U.S. Industry 325998, All Other Miscellaneous Chemical Product and Preparation Manufacturing; and
   Manufacturing guided missiles—are classified in U.S. Industry 336414, Guided Missile and Space Vehicle Manufacturing.
   332996 Fabricated Pipe and Pipe Fitting Manufacturing

This U.S. industry comprises establishments primarily engaged in fabricating, such as cutting, threading and bending metal pipes and pipe fittings made from purchased metal pipe.

Cross-References. Establishments primarily engaged in
Manufacturing cast iron pipe and fittings—are classified in U.S. Industry 331511, Iron Foundries;
Manufacturing pipe system fittings (except cast iron couplings)—are classified in U.S. Industry 332919, Other Metal Valve and Pipe Fitting Manufacturing; and
Manufacturing welded and seamless steel pipes from purchased steel—are classified in Industry 331210, Iron and Steel Pipe and Tube Manufacturing from Purchased Steel.
   332999 All Other Miscellaneous Fabricated Metal Product Manufacturing

This U.S. industry comprises establishments primarily engaged in manufacturing fabricated metal products (except forgings and stampings, cutlery and handtools, architectural and structural metals, boilers, tanks, shipping containers, hardware, spring and wire products, machine shop products, turned products, screws, nuts and bolts, metal valves, ball and roller bearings, ammunition, small arms and other ordnances, fabricated pipes and pipe fittings, industrial patterns, and enameled iron and metal sanitary ware).

Cross-References. Establishments primarily engaged in
Manufacturing forgings and stampings—are classified in Industry 33211, Forging and Stamping;
Manufacturing cutlery and handtools—are classified in Industry 33221, Cutlery and Handtool Manufacturing;
Manufacturing architectural and structural metals—are classified in Industry Group 3323, Architectural and Structural Metals Manufacturing;
Manufacturing boilers, tanks, and shipping containers—are classified in Industry Group 3324, Boiler, Tank, and Shipping Container Manufacturing;
Manufacturing hardware and safe and vault locks—are classified in Industry 332510, Hardware Manufacturing;
Manufacturing spring and wire products—are classified in Industry 33261, Spring and Wire Product Manufacturing;
Manufacturing machine shop products, turned products, screws, and nut and bolt—are classified in Industry Group 3327, Machine Shops; Turned Product; and Screw Nut, and Bolt Manufacturing;
Coating, engraving, heat treating and allied activities—are classified in Industry 33281, Coating, Engraving, Heat Treating, and Allied Activities;
Manufacturing ball and roller bearings—are classified in U.S. Industry 332991, Ball and Roller Bearing Manufacturing;
Manufacturing small arms ammunition—are classified in U.S. Industry 332992, Small Arms Ammunition Manufacturing;
Manufacturing ammunition (except small arms)—are classified in U.S. Industry 332993, Ammunition (except Small Arms) Manufacturing;
Manufacturing small firearms that are carried and fired by the individual—are classified in U.S. Industry 332994, Small Arms Manufacturing;
Manufacturing ordnances (except small) and accessories—are classified in U.S. Industry 332995, Other Ordnance and Accessories Manufacturing;
Manufacturing metal pipes and pipe fittings from metal pipe produced elsewhere—are classified in U.S. Industry 332996, Fabricated Pipe and Pipe Fitting Manufacturing;
Manufacturing cast iron pipe and fittings—are classified in U.S. Industry 331511, Iron Foundries;
Manufacturing welded and seamless steel pipes from purchased steel—are classified in Industry 331210, Iron and Steel Pipe and Tube Manufacturing from Purchased Steel;
Manufacturing metal furniture frames—are classified in U.S. Industry 337215, Showcase, Partition, Shelving, and Locker Manufacturing;
Manufacturing powder metallurgy parts—are classified in U.S. Industry 332117, Powder Metallurgy Part Manufacturing;
Manufacturing metal boxes—are classified in U.S. Industry 332439, Other Metal Container Manufacturing;
Manufacturing metal nozzles, hose couplings, and aerosol valves—are classified in U.S. Industry 332919, Other Metal Valve and Pipe Fitting Manufacturing;
Manufacturing nonprecious metal trophies—are classified in U.S. Industry 339914, Costume Jewelry and Novelty Manufacturing;
Manufacturing metal foil bags—are classified in U.S. Industry 322223, Plastics, Foil, and Coated Paper Bag Manufacturing;
Manufacturing aluminum foil—are classified in Industry 33131, Alumina and Aluminum Production and Processing;
Manufacturing metal foil (except aluminum)—are classified in Industry Group 3314, Nonferrous Metal (except Aluminum) Production and Processing; and
   Manufacturing metal burial vaults—are classified in U.S. Industry 339995, Burial Casket Manufacturing
   332997 Industrial Pattern Manufacturing

This U.S. industry comprises establishments primarily engaged in manufacturing industrial patterns.

332994 Small Arms Manufacturing

This U.S. industry comprises establishments primarily engaged in manufacturing small firearms that are carried and fired by the individual.

Cross-References. Establishments primarily engaged in manufacturing firearms (except small) are classified in U.S. Industry 332995, Other Ordnance and Accessories Manufacturing.

The above categories are to expand the manufacturing technology into more application. The category taken out of context one is the standard classification applicable to the unique reproduction of the exemplary device he gilhoolie (AKA the Willy Grip)

332214 Kitchen Utensil, Pot, and Pan Manufacturing

This U.S. industry comprises establishments primarily engaged in manufacturing metal kitchen utensils (except cutting-type), pots, and pans (except those manufactured by casting (e.g., cast iron skillets) or stamped without further fabrication).

Cross-References. Establishments primarily engaged in
Manufacturing finished cast metal kitchen utensils or castings for kitchen utensils—are classified in Industry Group 3315, Foundries;
Manufacturing stampings for kitchen utensils, pots, and pans—are classified in U.S. Industry 332116, Metal Stamping; and
   Manufacturing metal cutting-type kitchen utensils—are classified in U.S. Industry 332211, Cutlery and Flatware (except Precious) Manufacturing.
   332998 Enameled Iron and Metal Sanitary Ware Manufacturing

This U.S. industry comprises establishments primarily engaged in manufacturing enameled iron and metal sanitary ware.

Cross-References. Establishments primarily engaged in
Manufacturing plastics plumbing fixtures—are classified in U.S. Industry 326191, Plastics Plumbing Fixture Manufacturing;
Manufacturing vitreous and semivitreous pottery sanitary ware—are classified in U.S. Industry 327111, Vitreous China Plumbing Fixture and China and Earthenware Bathroom Accessories Manufacturing;
Manufacturing plastics portable chemical toilets—are classified in U.S. Industry 326199, All Other Plastics Product Manufacturing; and
   Manufacturing metal mechanically refrigerated drinking fountains—are classified in U.S. Industry 333415, Air-Conditioning and Warm Air Heating Equipment and Commercial and Industrial Refrigeration Equipment Manufacturing.
   332995 Other Ordnance and Accessories Manufacturing

This U.S. industry comprises establishments primarily engaged in manufacturing ordnance (except small arms) and accessories.

Cross-References. Establishments primarily engaged in
Manufacturing small arms—are classified in U.S. Industry 332994, Small Arms Manufacturing;
Manufacturing military tanks—are classified in U.S. Industry 336992, Military Armored Vehicle, Tank, and Tank Component Manufacturing; and
Manufacturing guided missiles—are classified in U.S. Industry 336414, Guided Missile and Space Vehicle Manufacturing.

The Following Thirty Pages are Standard Classification Charts for Easy Referral for those in the Arts to Identify Product to include agreed upon Specifications

| Go | No change | | | | |
|---|---|---|---|---|---|
| to: | 1997 to 2002 | | 2002 NAICS to | 1997 Economic | Bridge Between 1997 NAICS |
| 2002 | 1997 | 1987 | 1987 SIC | Census | and SIC |

| NAICS | NAICS | SIC | Corresponding Index Entries |
|---|---|---|---|
| 332994 | 332994 | 3484 | Ammunition carts (i.e., 30 mm or less, 1.18 inch or less) |
| | | | manufacturing |
| 332994 | 332994 | 3484 | Barrels, gun (i.e., 30 mm. or less, 1.18 inch or less), |
| | | | manufacturing |
| 332994 | 332994 | 3484 | BB guns manufacturing |
| 332994 | 332994 | 3484 | Belts, machine gun (i.e., 30 mm. or less, 1.18 inch or less), |
| | | | manufacturing |
| 332994 | 332994 | 3484 | Carbines manufacturing |
| 332994 | 332994 | 3484 | Clips, gun (i.e., 30 mm. or less, 1.18 inch or less), manufacturing |
| 332994 | 332994 | 3484 | Cylinders and clips, gun (i.e., 30 mm. or less, 1.18 inch or less), |
| | | | manufacturing |
| 332994 | 332994 | 3484 | Dart guns manufacturing |
| 332994 | 332994 | 3484 | Firearms, small, manufacturing |
| 332994 | 332994 | 3484 | Grenade launchers manufacturing |
| 332994 | 332994 | 3484 | Gun barrels (i.e., 30 mm. or less, 1.18 inch or less) manufacturing |
| 332994 | 332994 | 3484 | Gun magazines (i.e., 30 mm. or less, 1.18 inch or less) |
| | | | manufacturing |
| 332994 | 332994 | 3484 | Guns (i.e., 30 mm. or less, 1.18 inch or less) manufacturing |
| 332994 | 332994 | 3484 | Guns, BB and pellet, manufacturing |
| 332994 | 332994 | 3484 | Links, ammunition (i.e., 30 mm. or less, 1.18 inch or less), |
| | | | manufacturing |
| 332994 | 332994 | 3484 | Machine gun belts (i.e., 30 mm. or less, 1.18 inch or less) |
| | | | manufacturing |
| 332994 | 332994 | 3484 | Machine guns (i.e., 30 mm. or less, 1.18 inch or less) |
| | | | manufacturing |
| 332994 | 332994 | 3484 | Pellet guns manufacturing |
| 332994 | 332994 | 3484 | Pistols manufacturing |
| 332994 | 332994 | 3484 | Pyrotechnic pistols and projectors manufacturing |
| 332994 | 332994 | 3484 | Recoil mechanisms (i.e., 30 mm. or less, 1.18 inch or less), gun, |
| | | | manufacturing |
| 332994 | 332994 | 3484 | Revolvers manufacturing |
| 332994 | 332994 | 3484 | Rifles (except recoilless, toy) manufacturing |
| 332994 | 332994 | 3484 | Rifles, BB and pellet, manufacturing |
| 332994 | 332994 | 3484 | Rifles, pneumatic, manufacturing |
| 332994 | 332994 | 3484 | Shotguns manufacturing |
| 332994 | 332994 | 3484 | Submachine guns manufacturing |
| 332994 | 332994 | 3841 | Tranquilizer guns, manufacturing |
| 332111 | 332111 | 3462 | Cold forgings made from purchased iron or steel, unfinished |
| 332111 | 332111 | 3462 | Drop forgings made from purchased iron or steel, unfinished |
| 332111 | 332111 | 3462 | Ferrous forgings made from purchased iron or steel, unfinished |
| 332111 | 332111 | 3462 | Forgings made from purchased iron or steel, unfinished |
| 332111 | 332111 | 3462 | Gun forgings made from purchased iron or steel, unfinished |
| 332111 | 332111 | 3462 | Hammer forgings made from purchased iron or steel, unfinished |
| 332111 | 332111 | 3462 | Horseshoes, ferrous forged, made from purchased iron or steel |
| 332111 | 332111 | 3462 | Hot forgings made from purchased iron or steel, unfinished |
| 332111 | 332111 | 3462 | Iron forgings made from purchased iron, unfinished |
| 332111 | 332111 | 3462 | Press forgings made from purchased iron or steel, unfinished |
| 332111 | 332111 | 3462 | Steel forgings made from purchased steel, unfinished |
| 332111 | 332111 | 3462 | Upset forgings made from purchased iron or steel, unfinished |
| 332112 | 332112 | 3463 | Aluminum forgings made from purchased metals, unfinished |
| 332112 | 332112 | 3463 | Cold forgings made from purchased nonferrous metals, unfinished |
| 332112 | 332112 | 3463 | Copper forgings made from purchased metals, unfinished |
| 332112 | 332112 | 3463 | Hammer forgings made from purchased nonferrous metals, |
| | | | unfinished |
| 332112 | 332112 | 3463 | Hot forgings made from purchased nonferrous metals, unfinished |
| 332112 | 332112 | 3463 | Press forgings made from purchased nonferrous metals, |
| | | | unfinished |
| 332112 | 332112 | 3463 | Titanium forgings made from purchased metals, unfinished |
| 332112 | 332112 | 3463 | Upset forgings made from purchased nonferrous metals, |
| | | | unfinished |
| 332114 | 332114 | 3449 | Custom roll forming metal products |
| 332114 | 332114 | 3449 | Gutters and down spouts sheet metal, custom roll formed, |
| | | | manufacturing |
| 332115 | 332115 | 3466 | Bottle caps and tops, metal, stamping |
| 332115 | 332115 | 3466 | Caps and tops, bottle, metal, stamping |
| 332115 | 332115 | 3466 | Closures, metal, stamping |
| 332115 | 332115 | 3466 | Crowns, metal (e.g., bottle, can), stamping |
| 332115 | 332115 | 3466 | Home canning lids and rings, metal stamping |
| 332115 | 332115 | 3466 | Lids, jar, metal, stamping |
| 332116 | 332116 | 3469 | Metal stampings (except automotive, cans, cooking, closures, |
| | | | crowns), unfinished, |
| 332116 | 332116 | 3469 | Spinning unfinished metal products |
| 332116 | 332116 | 3469 | Stampings (except automotive, cans, cooking, closures, crowns), |
| | | | metal, unfinished |
| 332117 | 332117 | 3499 | Powder metallurgy products manufactured on a job or order basis |
| 332211 | 332211 | 3421 | Barber's scissors, manufacturing |
| 332211 | 332211 | 3421 | Blades, knife and razor, manufacturing |
| 332211 | 332211 | 3421 | Butcher's knives manufacturing |
| 332211 | 332211 | 3421 | Carving sets manufacturing |
| 332211 | 332211 | 3421 | Cleavers manufacturing |
| 332211 | 332211 | 3421 | Clippers, fingernail and toenail, manufacturing |
| 332211 | 332211 | 3421 | Cutlery, nonprecious and precious plated metal, manufacturing |
| 332211 | 332211 | 3421 | Fishing knives manufacturing |
| 332211 | 332211 | 3914 | Flatware, nonprecious and precious plated metal, manufacturing |
| 332211 | 332211 | 3421 | Forks, table, nonprecious and precious plated metal, |
| | | | manufacturing |
| 332211 | 332211 | 3999 | Hair clippers for human use, nonelectric, manufacturing |
| 332211 | 332211 | 3421 | Hunting knives manufacturing |
| 332211 | 332211 | 3421 | Kitchen cutlery, nonprecious and precious plated metal, |
| | | | manufacturing |
| 332211 | 332211 | 3421 | Knife blades manufacturing |
| 332211 | 332211 | 3421 | Knife blanks manufacturing |
| 332211 | 332211 | 3421 | Knives (e.g., hunting, pocket, table nonprecious, table precious |
| | | | plated) manufact |
| 332211 | 332211 | 3914 | Plated metal cutlery manufacturing |
| 332211 | 332211 | 3914 | Plated metal flatware manufacturing |
| 332211 | 332211 | 3421 | Pocket knives manufacturing |
| 332211 | 332211 | 3421 | Razor blades manufacturing |
| 332211 | 332211 | 3421 | Razors (except electric) manufacturing |
| 332211 | 332211 | 3421 | Safety razor blades manufacturing |
| 332211 | 332211 | 3421 | Safety razors manufacturing |
| 332211 | 332211 | 3421 | Scissors, nonelectric, manufacturing |
| 332211 | 332211 | 3421 | Shears, nonelectric, household-type (e.g., kitchen, barber, tailor) |
| | | | manufacturing |
| 332211 | 332211 | 3914 | Spoons, table, nonprecious and precious plated metal, |
| | | | manufacturing |
| 332211 | 332211 | 3421 | Straight razors manufacturing |
| 332211 | 332211 | 3421 | Swords, nonprecious and precious plated metal, manufacturing |
| 332211 | 332211 | 3421 | Table cutlery, nonprecious and precious plated metal, |
| | | | manufacturing |
| 332211 | 332211 | 3421 | Tailors' scissors, nonelectric, manufacturing |
| 332212 | 332212 | 3423 | Agricultural handtools (e.g., hay forks, hoes, rakes, spades), |
| | | | nonpowered, manufa |
| 332212 | 332212 | 3423 | Augers, nonpowered, manufacturing |
| 332212 | 332212 | 3423 | Awls manufacturing |
| 332212 | 332212 | 3423 | Axes manufacturing |
| 332212 | 332212 | 3423 | Bearing pullers, handtools, manufacturing |
| 332212 | 332212 | 3423 | Bits, edge tool, woodworking, manufacturing |
| 332212 | 332212 | 3423 | Blow torches manufacturing |
| 332212 | 332212 | 3545 | Calipers and dividers, machinists' precision tools, manufacturing |
| 332212 | 332212 | 3423 | Can openers (except electric) manufacturing |
| 332212 | 332212 | 3423 | Carpenter's handtools, nonelectric (except saws), manufacturing |
| 332212 | 332212 | 3423 | Caulking guns, nonpowered, manufacturing |
| 332212 | 332212 | 3423 | C-clamps manufacturing |
| 332212 | 332212 | 3423 | Chisels manufacturing |
| 332212 | 332212 | 3523 | Clippers for animal use, nonelectric, manufacturing |
| 332212 | 332212 | 3545 | Coordinate and contour measuring machines, machinists' |
| | | | precision tools, manufactu |
| 332212 | 332212 | 3423 | Counterbores and countersinking bits, woodworking, |
| | | | manufacturing |
| 332212 | 332212 | 3423 | Cutters, glass, manufacturing |
| 332212 | 332212 | 3423 | Cutting dies (e.g., paper, leather, textile) manufacturing |
| 332212 | 332212 | 3423 | Cutting dies (except metal cutting) manufacturing |
| 332212 | 332212 | 3545 | Dial indicators, machinists' precision tools, manufacturing |
| 332212 | 332212 | 3423 | Dies, cutting (except metal cutting), manufacturing |
| 332212 | 332212 | 3423 | Dies, steel rule (except metal cutting), manufacturing |
| 332212 | 332212 | 3545 | Dividers, machinists' precision tools, manufacturing |
| 332212 | 332212 | 3423 | Drawknives manufacturing |
| 332212 | 332212 | 3423 | Drill bits, woodworking, manufacturing |
| 332212 | 332212 | 3423 | Drills, hand held, nonelectric, manufacturing |
| 332212 | 332212 | 3423 | Edge tools, woodworking (e.g., augers, bits, countersinks), |
| | | | manufacturing |
| 332212 | 332212 | 3423 | Engraver' s handtools, nonpowered, manufacturing |
| 332212 | 332212 | 3423 | Files, handheld, manufacturing |
| 332212 | 332212 | 3644 | Fish wire (i.e., electrical wiring tool) manufacturing |
| 332212 | 332212 | 3423 | Forks, handtools (e.g., garden, hay, manure), manufacturing |
| 332212 | 332212 | 3545 | Gauge blocks, machinists' precision tools, manufacturing |
| 332212 | 332212 | 3545 | Gauges, machinists' precision tools (except optical), |
| | | | manufacturing |
| 332212 | 332212 | 3423 | Gear pullers, handtools, manufacturing |
| 332212 | 332212 | 3423 | Gouges, woodworking, manufacturing |
| 332212 | 332212 | 3524 | Grass mowing equipment, nonpowered lawn and garden, |
| | | | manufacturing |
| 332212 | 332212 | 3423 | Guns, caulking, nonpowered, manufacturing |
| 332212 | 332212 | 3523 | Hair clippers for animal use, nonelectric, manufacturing |
| 332212 | 332212 | 3423 | Hammers, handtools, manufacturing |
| 332212 | 332212 | 3423 | Handheld edge tools (except saws, scissors-type), nonelectric, |
| | | | manufacturing |
| 332212 | 332212 | 3423 | Handtools metal blades (e.g., putty knives, scrapers, screw drivers) |
| | | | manufacturing |
| 332212 | 332212 | 3545 | Handtools, machinists' precision, manufacturing |
| 332212 | 332212 | 3423 | Handtools, motor vehicle mechanics', manufacturing |
| 332212 | 332212 | 3423 | Hatchets manufacturing |
| 332212 | 332212 | 3421 | Hedge shears and trimmers, nonelectric, manufacturing |
| 332212 | 332212 | 3423 | Hoes, garden and mason's handtools, manufacturing |
| 332212 | 332212 | 3423 | Hooks, handtools (e.g., baling, bush, grass, husking), |
| | | | manufacturing |
| 332212 | 332212 | 3423 | Jacks (except hydraulic, pneumatic) manufacturing |
| 332212 | 332212 | 3423 | Jeweler's handtools, nonelectric, manufacturing |
| 332212 | 332212 | 3423 | Knives and bits for woodworking lathes, planers, and shapers |
| | | | manufacturing |
| 332212 | 332212 | 3421 | Lawn edgers, nonpowered, manufacturing |
| 332212 | 332212 | 3524 | Lawnmowers, nonpowered, manufacturing |
| 332212 | 332212 | 3423 | Leaf skimmers and rakes, nonpowered swimming pool, |
| | | | manufacturing |
| 332212 | 332212 | 3423 | Levels, carpenter's, manufacturing |
| 332212 | 332212 | 3423 | Machetes manufacturing |
| 332212 | 332212 | 3423 | Machine knives (except metal cutting) manufacturing |
| 332212 | 332212 | 3545 | Machinists' precision measuring tools (except optical) |
| | | | manufacturing |
| 332212 | 332212 | 3423 | Mallets (e.g., rubber, wood) manufacturing |
| 332212 | 332212 | 3423 | Mason's handtools manufacturing |
| 332212 | 332212 | 3423 | Mattocks (i.e., handtools) manufacturing |
| 332212 | 332212 | 3423 | Mauls, metal, manufacturing |
| 332212 | 332212 | | Measuring tools, machinist's (except optical), manufacturing |
| 332212 | 332212 | 3423 | Mechanic's handtools, nonpowered, manufacturing |
| 332212 | 332212 | 3545 | Micrometers, machinist's precision tools, manufacturing |
| 332212 | 332212 | 3423 | Miter boxes manufacturing |
| 332212 | 332212 | 3423 | Picks (i.e., handtools) manufacturing |
| 332212 | 332212 | 3423 | Planes, handheld, nonpowered, manufacturing |
| 332212 | 332212 | 3423 | Pliers, handtools, manufacturing |
| 332212 | 332212 | 3423 | plumbers' handtools, nonpowered, manufacturing |
| 332212 | 332212 | 3423 | Post hole diggers, nonpowered, manufacturing |
| 332212 | 332212 | 3545 | Precision tools, machinist's (except optical), manufacturing |
| 332212 | 332212 | 3423 | Pruners manufacturing |
| 332212 | 332212 | 3423 | Pry (i.e., crow) bars manufacturing |
| 332212 | 332212 | 3423 | Punches (except paper), nonpowered handtool, manufacturing |
| 332212 | 332212 | 3423 | Putty knives manufacturing |
| 332212 | 332212 | 3423 | Rakes, nonpowered handtool, manufacturing |
| 332212 | 332212 | 3423 | Rasps, handheld, manufacturing |
| 332212 | 332212 | 3423 | Ratchets, nonpowered, manufacturing |
| 332212 | 332212 | 3423 | Rulers, metal, manufacturing |
| 332212 | 332212 | 3423 | Scoops, metal (except kitchen-type), manufacturing |
| 332212 | 332212 | 3423 | Screw drivers, nonelectric, manufacturing |
| 332212 | 332212 | 3423 | Screwjacks manufacturing |
| 332212 | 332212 | 3423 | Scythes manufacturing |
| 332212 | 332212 | | Shears, nonelectric, tool-type (e.g., garden, pruners, tinsnip), |
| | | | manufacturing |
| 332212 | 332212 | 3423 | Shovels, handheld, manufacturing |
| 332212 | 332212 | 3423 | Sickles manufacturing |
| 332212 | 332212 | 3423 | Sledgehammers manufacturing |
| 332212 | 332212 | 3423 | Sockets and socket sets manufacturing |
| 332212 | 332212 | 3423 | Soldering guns and irons, handheld (including electric), |
| | | | manufacturing |
| 332212 | 332212 | 3423 | Soldering iron tips and tiplets manufacturing |
| 332212 | 332212 | 3423 | Spades and shovels, handheld, manufacturing |
| 332212 | 332212 | 3423 | Squares, carpenters', metal, manufacturing |
| 332212 | 332212 | 3423 | Stonecutters' handtools, nonpowered, manufacturing |
| 332212 | 332212 | 3999 | Tape measures, metal, manufacturing |
| 332212 | 332212 | 3421 | Tinners' snips manufacturing |
| 332212 | 332212 | 3423 | Tools, hand, metal blade (e.g., putty knives, scrapers, |
| | | | screwdrivers) |
| 332212 | 332212 | 3423 | Tools, handheld, nonpowered (except kitchen-type), |
| | | | manufacturing |
| 332212 | 332212 | 3423 | Tools, woodworking edge (e.g., augers, bits, countersinks), |
| | | | manufacturing |
| 332212 | 332212 | 3421 | Trimmers, hedge, nonelectric, manufacturing |
| 332212 | 332212 | 3423 | Trowels manufacturing |
| 332212 | 332212 | 3423 | Vises (except machine tool attachments) manufacturing |
| 332212 | 332212 | 3423 | Wheel pullers, handtools, manufacturing |
| 332212 | 332212 | 3423 | Wrenches, handtools, nonpowered, manufacturing |
| 332212 | 332212 | 3423 | Yardsticks, metal, manufacturing |
| 332213 | 332213 | 3425 | Blades, saw, all types, manufacturing |
| 332213 | 332213 | 3425 | Chain saw blades manufacturing |
| 332213 | 332213 | 3425 | Metal cutting saw blades manufacturing |
| 332213 | 332213 | 3425 | Saw blades, all types, manufacturing |
| 332213 | 332213 | 3425 | Saws, hand, nonpowered, manufacturing |
| 332213 | 332213 | 3425 | Stone cutting saw blades manufacturing |
| 332213 | 332213 | 3425 | Wood cutting saw blades manufacturing |
| 332311 | 332311 | 3448 | Buildings, prefabricated metal, manufacturing |
| 332311 | 332311 | 3448 | Carports, prefabricated metal, manufacturing |
| 332311 | 332311 | 3448 | Dwellings, prefabricated metal, manufacturing |
| 332311 | 332311 | 3448 | Farm buildings, prefabricated metal, manufacturing |
| 332311 | 332311 | 3448 | Garages, prefabricated metal, manufacturing |
| 332311 | 332311 | 3448 | Greenhouses, prefabricated metal, manufacturing |
| 332311 | 332311 | 3448 | Houses, prefabricated metal, manufacturing |
| 332311 | 332311 | 3448 | Panels, prefabricated metal building, manufacturing |
| 332311 | 332311 | 3448 | Portable buildings, prefabricated metal, manufacturing |
| 332311 | 332311 | 3448 | Prefabricated buildings, metal, manufacturing |
| 332311 | 332311 | 3448 | Prefabricated homes, metal, manufacturing |
| 332311 | 332311 | 3448 | Sections for prefabricated metal buildings manufacturing |
| 332311 | 332311 | 3448 | Sheds, (e.g., garden, storage, utility) prefabricated metal, |
| | | | manufacturing |
| 332311 | 332311 | 3448 | Silos, prefabricated metal, manufacturing |
| 332311 | 332311 | 3448 | Utility buildings, prefabricated metal, manufacturing |
| 332311 | 332311 | 3448 | Warehouses, prefabricated metal, manufacturing |
| 332312 | 332312 | 3441 | Barge sections, prefabricated metal, manufacturing |
| 332312 | 332312 | 3449 | Bars, concrete reinforcing, manufacturing |
| 332312 | 332312 | 3441 | Boat sections, prefabricated metal, manufacturing |
| 332312 | 332312 | 3441 | Bridge sections, prefabricated metal, manufacturing |
| 332312 | 332312 | 3449 | Concrete reinforcing bars manufacturing |
| 332312 | 332312 | 3441 | Dam gates, metal plate, manufacturing |
| 332312 | 332312 | 3441 | Expansion joints, metal, manufacturing |
| 332312 | 332312 | 3449 | Fabricated bar joists manufacturing |
| 332312 | 332312 | 3441 | Fabricated structural metal manufacturing |
| 332312 | 332312 | 3441 | Flood gates, metal plate, manufacturing |
| 332312 | 332312 | 3441 | Floor jacks, metal, manufacturing |
| 332312 | 332312 | 3441 | Floor posts, adjustable metal, manufacturing |
| 332312 | 332312 | 3441 | Highway bridge sections, prefabricated metal, manufacturing |
| 332312 | 332312 | 3441 | Joists, fabricated bar, manufacturing |
| 332312 | 332312 | 3449 | Landing mats, aircraft, metal, manufacturing |
| 332312 | 332312 | 3441 | Radio and television tower sections, fabricated structural metal, |
| | | | manufacturing |
| 332312 | 332312 | 3441 | Railway bridge sections, prefabricated metal, manufacturing |
| 332312 | 332312 | 3441 | Ship sections, prefabricated metal, manufacturing |
| 332312 | 332312 | 3441 | Steel joists manufacturing |
| 332312 | 332312 | 3441 | Steel railroad car racks manufacturing |
| 332312 | 332312 | 3441 | Structural steel, fabricated, manufacturing |
| 332312 | 332312 | 3441 | Television tower sections, fabricated structural metal, |
| | | | manufacturing |
| 332312 | 332312 | 3441 | Transmission tower sections, fabricated structural metal, |
| | | | manufacturing |
| 332313 | 332313 | 3443 | Airlocks, fabricated metal plate work, manufacturing |
| 332313 | 332313 | 3443 | Baffles, fabricated metal plate work, manufacturing |
| 332313 | 332313 | 3443 | Bins, fabricated metal plate work, manufacturing |
| 332313 | 332313 | 3443 | Breechings, fabricated metal plate work, manufacturing |
| 332313 | 332313 | 3443 | Buoys, fabricated plate work metal, manufacturing |
| 332313 | 332313 | 3443 | Casings, scroll, fabricated metal plate work, manufacturing |
| 332313 | 332313 | 3443 | Chutes, fabricated metal plate work, manufacturing |
| 332313 | 332313 | 3443 | Covers, annealing, fabricated metal plate work, manufacturing |
| 332313 | 332313 | 3443 | Covers, floating, fabricated metal plate work, manufacturing |
| 332313 | 332313 | 3443 | Culverts, fabricated metal plate work, manufacturing |
| 332313 | 332313 | 3443 | Cupolas, fabricated metal plate work, manufacturing |
| 332313 | 332313 | 3443 | Cyclones, industrial, fabricated metal plate work, manufacturing |
| 332313 | 332313 | 3443 | Ducting, fabricated metal plate work, manufacturing |
| 332313 | 332313 | 3443 | Fabricated plate work manufacturing |
| 332313 | 332313 | 3443 | Floating covers, fabricated metal plate work, manufacturing |
| 332313 | 332313 | 3443 | Flumes, fabricated metal plate work, manufacturing |
| 332313 | 332313 | 3443 | Fumigating chambers, fabricated metal plate work, manufacturing |
| 332313 | 332313 | 3443 | Hoods, industrial, fabricated metal plate work, manufacturing |
| 332313 | 332313 | 3443 | Hoppers, fabricated metal plate work, manufacturing |
| 332313 | 332313 | 3443 | Jackets, industrial, fabricated metal plate work, manufacturing |
| 332313 | 332313 | 3443 | Ladle bails, fabricated metal plate work, manufacturing |
| 332313 | 332313 | 3443 | Ladles, fabricated metal plate work, manufacturing |
| 332313 | 332313 | 3443 | Liners, industrial, fabricated metal plate work, manufacturing |
| 332313 | 332313 | 3443 | Nuclear shielding, fabricated metal plate work, manufacturing |
| 332313 | 332313 | 3443 | Penstocks, fabricated metal plate, manufacturing |
| 332313 | 332313 | 3443 | Pile shells, fabricated metal plate, manufacturing |
| 332313 | 332313 | 3443 | Pipe, fabricated metal plate, manufacturing |
| 332313 | 332313 | 3443 | Plate work (e.g., bending, cutting, punching, shaping, welding), |
| | | | fabricated metal |
| 332313 | 332313 | 3443 | Racks (e.g., trash), fabricated metal plate, manufacturing |
| 332313 | 332313 | 3443 | Reactor containment vessels, fabricated metal plate, |
| | | | manufacturing |
| 332313 | 332313 | 3443 | Rocket casings, fabricated metal work, manufacturing |
| 332313 | 332313 | 3443 | Smokestacks, fabricated metal boiler plate, manufacturing |
| 332313 | 332313 | 3443 | Space simulation chambers, fabricated metal plate work, |
| | | | manufacturing |
| 332313 | 332313 | 3443 | Sterilizing chambers, fabricated metal plate work, manufacturing |
| 332313 | 332313 | 3443 | Trash racks, fabricated metal plate work, manufacturing |
| 332313 | 332313 | 3443 | Troughs, industrial, fabricated metal plate work, manufacturing |
| 332313 | 332313 | 3443 | Truss plates, metal, manufacturing |
| 332313 | 332313 | 3443 | Tunnel lining, fabricated metal plate work, manufacturing |
| 332313 | 332313 | 3443 | Tunnels, wind, fabricated metal plate work, manufacturing |
| 332313 | 332313 | 3443 | Weldments manufacturing |
| 332321 | 332321 | 3442 | Baseboards, metal, manufacturing |
| 332321 | 332321 | 3442 | Casements, metal, manufacturing |
| 332321 | 332321 | 3442 | Door and jamb assemblies, metal, manufacturing |
| 332321 | 332321 | 3442 | Door frames and sash, metal, manufacturing |
| 332321 | 332321 | 3442 | Doors, metal, manufacturing |
| 332321 | 332321 | 3442 | Fire doors, metal, manufacturing |
| 332321 | 332321 | 3442 | Frames, door and window, metal, manufacturing |
| 332321 | 332321 | 3442 | Garage doors, metal, manufacturing |
| 332321 | 332321 | 3442 | Hangar doors, metal, manufacturing |
| 332321 | 332321 | 3442 | Jalousies, metal, manufacturing |
| 332321 | 332321 | 3442 | Louver windows, metal, manufacturing |
| 332321 | 332321 | 3442 | Molding and trim (except motor vehicle), metal, manufacturing |
| 332321 | 332321 | 3442 | Rolling doors for industrial buildings and warehouses, metal, |
| | | | manufacturing |
| 332321 | 332321 | 3442 | Sash, door and window, metal, manufacturing |
| 332321 | 332321 | 3442 | Screen doors, metal frame, manufacturing |
| 332321 | 332321 | 3442 | Screens, door and window, metal frame, manufacturing |
| 332321 | 332321 | 3442 | Shutters, door and window, metal, manufacturing |
| 332321 | 332321 | 3444 | Skylights, sheet metal, manufacturing |
| 332321 | 332321 | 3442 | Storm doors and windows, metal, manufacturing |
| 332321 | 332321 | 3442 | Trim and molding (except motor vehicle), metal, manufacturing |
| 332321 | 332321 | 3442 | Trim, metal, manufacturing |
| 332321 | 332321 | 3442 | Weatherstrip, metal, manufacturing |
| 332321 | 332321 | 3442 | Window frames and sash, metal, manufacturing |
| 332321 | 332321 | 3442 | Window screens, metal frame, manufacturing |
| 332321 | 332321 | 3442 | Windows, metal, manufacturing |
| 332322 | 332322 | 3444 | Air cowls, sheet metal (except stampings), manufacturing |
| 332322 | 332322 | 3444 | Awnings, sheet metal (except stampings), manufacturing |
| 332322 | 332322 | 3444 | Canopies, sheet metal (except stampings), manufacturing |
| 332322 | 332322 | 3444 | Casings, sheet metal (except stampings), manufacturing |
| 332322 | 332322 | 3444 | Coal chutes, sheet metal (except stampings), manufacturing |
| 332322 | 332322 | 3444 | Concrete forms, sheet metal (except stampings), manufacturing |
| 332322 | 332322 | 3444 | Cornices, sheet metal (except stampings), manufacturing |
| 332322 | 332322 | 3444 | Cowls, sheet metal (except stampings), manufacturing |
| 332322 | 332322 | 3444 | Culverts, sheet metal (except stampings), manufacturing |
| 332322 | 332322 | 3444 | Dampers, sheet metal (except stampings), manufacturing |
| 332322 | 332322 | 3444 | Door hoods, sheet metal (except stampings), manufacturing |
| 332322 | 332322 | 3444 | Downspouts, sheet metal (except stampings), manufacturing |
| 332322 | 332322 | 3444 | Ducts, sheet metal, manufacturing |
| 332322 | 332322 | 3444 | Eaves, sheet metal (except stampings), manufacturing |
| 332322 | 332322 | 3444 | Elbows for conductor pipe, hot air ducts, and stovepipe, sheet |
| | | | metal (except stam |
| 332322 | 332322 | 3444 | Flooring, sheet metal (except stampings), manufacturing |
| 332322 | 332322 | 3444 | Flues, stove and furnace, sheet metal (except stampings), |
| | | | manufacturing |
| 332322 | 332322 | 3444 | Flumes, sheet metal (except stampings), manufacturing |
| 332322 | 332322 | 3444 | Forms, concrete, sheet metal (except stampings), manufacturing |
| 332322 | 332322 | 3444 | Furnace casings, sheet metal (except stampings), manufacturing |
| 332322 | 332322 | 3444 | Furnace flues, sheet metal (except stampings), manufacturing |
| 332322 | 332322 | 3444 | Guardrails, highway, sheet metal (except stampings), |
| | | | manufacturing |
| 332322 | 332322 | 3444 | Gutters, sheet metal (except custom roll formed), manufacturing |
| 332322 | 332322 | 3444 | Hampers, laundry, sheet metal (except stampings), manufacturing |
| 332322 | 332322 | 3444 | Highway guardrails, sheet metal (except stampings), |
| | | | manufacturing |
| 332322 | 332322 | 3444 | Hoods, range (except household-type), sheet metal (except |
| | | | stampings), manufactur |
| 332322 | 332322 | 3444 | Irrigation pipe, sheet metal (except stampings), manufacturing |
| 332322 | 332322 | 3444 | Joists, sheet metal (except stampings), manufacturing |
| 332323 | 332323 | 3446 | Fences and gates (except wire), metal, manufacturing |
| 332323 | 332323 | 3446 | Fire escapes, metal, manufacturing |
| 332323 | 332323 | 3446 | Flagpoles, metal, manufacturing |
| 332323 | 332323 | 3446 | Flooring, open steel (i.e., grating), manufacturing |
| 332323 | 332323 | 3446 | Furring channels, sheet metal, manufacturing |
| 332323 | 332323 | 3523 | Gates, holding, sheet metal, manufacturing |
| 332323 | 332323 | 3446 | Gates, metal (except wire), manufacturing |
| 332323 | 332323 | 3446 | Gratings (i.e., open steel flooring) manufacturing |
| 332323 | 332323 | 3446 | Grills and grillwork, sheet metal, manufacturing |
| 332323 | 332323 | 3446 | Grillwork, ornamental metal, manufacturing |
| 332323 | 332323 | 3446 | Guards, bannisters, and railings, sheet metal, manufacturing |
| 332323 | 332323 | 3446 | Ladders, metal chain, manufacturing |
| 332323 | 332323 | 3446 | Ladders, permanently installed, metal, manufacturing |
| 332323 | 332323 | 3449 | Lath, expanded metal, manufacturing |
| 332323 | 332323 | 3446 | Ornamental metalwork manufacturing |
| 332323 | 332323 | 3446 | Partitions, ornamental metal, manufacturing |
| 332323 | 332323 | 3446 | Pipe bannisters, metal, manufacturing |
| 332323 | 332323 | 3446 | Pipe guards, metal, manufacturing |
| 332323 | 332323 | 3446 | Pipe railings, metal, manufacturing |
| 332323 | 332323 | 3446 | Purlins, metal, manufacturing |
| 332323 | 332323 | 3446 | Railings, metal, manufacturing |
| 332323 | 332323 | 3446 | Registers, metal air, manufacturing |
| 332323 | 332323 | 3446 | Scaffolds, metal, manufacturing |
| 332323 | 332323 | 3446 | Stair railings, metal, manufacturing |
| 332323 | 332323 | 3446 | Stair treads, metal, manufacturing |
| 332323 | 332323 | 3446 | Staircases, metal, manufacturing |
| 332323 | 332323 | 3446 | Stairs, metal, manufacturing |
| 332323 | 332323 | 3523 | Stalls, metal, manufacturing |
| 332323 | 332323 | 3446 | Treads, metal stair, manufacturing |
| 332410 | 332410 | 3443 | Aftercoolers (i.e., heat exchangers) manufacturing |
| 332410 | 332410 | 3443 | Barometric condensers manufacturing |
| 332410 | 332410 | 3443 | Boiler casings manufacturing |
| 332410 | 332410 | 3443 | Boilers, power, manufacturing |
| 332410 | 332410 | 3443 | Condenser boxes, metal, manufacturing |
| 332410 | 332410 | 3443 | Condensers, steam, manufacturing |
| 332410 | 332410 | 3443 | Economizers (i.e., power boiler accessory) manufacturing |
| 332410 | 332410 | 3443 | Exchangers, heat, manufacturing |
| 332410 | 332410 | 3443 | Heat exchangers manufacturing |
| 332410 | 332410 | 3443 | Intercooler shells manufacturing |
| 332410 | 332410 | 3443 | Marine power boilers manufacturing |
| 332410 | 332410 | 3443 | Nuclear reactor steam supply systems manufacturing |
| 332410 | 332410 | 3559 | Nuclear reactors control rod drive mechanisms manufacturing |
| 332410 | 332410 | 3443 | Nuclear reactors manufacturing |
| 332410 | 332410 | 3443 | Power boilers manufacturing |
| 332410 | 332410 | 3443 | Reactors, nuclear, manufacturing |
| 332410 | 332410 | 3443 | Stationary power boilers manufacturing |
| 332410 | 332410 | 3443 | Steam condensers manufacturing |
| 332420 | 332420 | 3443 | Absorbers, gas, heavy gauge metal, manufacturing |
| 332420 | 332420 | 3443 | Accumulators, industrial pressure vessels, heavy gauge metal, |
| | | | manufacturing |
| 332420 | 332420 | 3443 | Acetylene cylinders, heavy gauge metal, manufacturing |
| 332420 | 332420 | 3443 | Air receiver tanks, heavy gauge metal, manufacturing |
| 332420 | 332420 | 3443 | Annealing vats, heavy gauge metal, manufacturing |
| 332420 | 332420 | 3443 | Autoclaves, industrial-type, heavy gauge metal, manufacturing |
| 332420 | 332420 | 3443 | Bulk storage tanks, heavy gauge metal, manufacturing |
| 332420 | 332420 | 3443 | Caissons, underwater work, heavy gauge metal, manufacturing |
| 332420 | 332420 | 3443 | Columns, fractionating, heavy gauge metal, manufacturing |
| 332420 | 332420 | 3443 | Cryogenic tanks, heavy gauge metal, manufacturing |
| 332420 | 332420 | 3443 | Cylinders, pressure, heavy gauge metal, manufacturing |
| 332420 | 332420 | 3443 | Digesters, industrial-type, heavy gauge metal, manufacturing |
| 332420 | 332420 | 3443 | Farm storage tanks, heavy gauge metal, manufacturing |
| 332420 | 332420 | 3443 | Fermention tanks, heavy gauge metal tanks, manufacturing |
| 332420 | 332420 | 3443 | Gas storage tanks, heavy gauge metal, manufacturing |
| 332420 | 332420 | 3443 | Kettles, heavy gauge metal, manufacturing |
| 332420 | 332420 | 3443 | Liquefied petroleum gas (LPG) cylinders manufacturing |
| 332420 | 332420 | 3443 | Liquid oxygen tanks manufacturing |
| 332420 | 332420 | 3443 | Nuclear waste casks, heavy gauge metal, manufacturing |
| 332420 | 332420 | 3443 | Oil storage tanks, heavy gauge metal, manufacturing |
| 332420 | 332420 | 3443 | Petroleum storage tanks, heavy gauge metal, manufacturing |
| 332420 | 332420 | 3443 | Pots (e.g., annealing, melting, smelting), heavy gauge metal, |
| | | | manufacturing |
| 332420 | 332420 | 3443 | Retorts, heavy gauge metal, manufacturing |
| 332420 | 332420 | 3443 | Septic tanks, heavy gauge metal, manufacturing |
| 332420 | 332420 | 3443 | Smelting pots and retorts manufacturing |
| 332420 | 332420 | 3443 | Stills, heavy gauge metal, manufacturing |
| 332420 | 332420 | 3443 | Storage tanks, heavy gauge metal, manufacturing |
| 332420 | 332420 | 3443 | Tanks, heavy gauge metal, manufacturing |
| 332420 | 332420 | 3443 | Vacuum tanks, heavy gauge metal, manufacturing |
| 332420 | 332420 | 3443 | Vats, heavy gauge metal, manufacturing |
| 332420 | 332420 | 3443 | Vessels, heavy gauge metal, manufacturing |
| 332420 | 332420 | 3443 | Water tanks, heavy gauge metal, manufacturing |
| 332431 | 332431 | 3411 | Aerosol cans, light gauge metal, manufacturing |
| 332431 | 332431 | 3411 | Aluminum cans, light gauge metal, manufacturing |
| 332431 | 332431 | 3411 | Beer cans, light gauge metal, manufacturing |
| 332431 | 332431 | 3411 | Can lids and ends, light gauge metal, manufacturing |
| 332431 | 332431 | 3411 | Cans, aluminum, light gauge metal, manufacturing |
| 332431 | 332431 | 3411 | Cans, light gauge metal, manufacturing |
| 332431 | 332431 | 3411 | Cans, steel, light gauge metal, manufacturing |
| 332431 | 332431 | 3411 | Lids and ends, can, light gauge metal, manufacturing |
| 332431 | 332431 | 3411 | Metal cans, light gauge metal, manufacturing |
| 332431 | 332431 | 3411 | Soft drink cans manufacturing |
| 332431 | 332431 | 3411 | Soup cans, light gauge metal, manufacturing |
| 332431 | 332431 | 3411 | Steel cans, light gauge metal, manufacturing |
| 332431 | 332431 | 3411 | Tin plate cans, light gauge metal, manufacturing |
| 332439 | 332439 | 3537 | Air cargo containers, light gauge metal, manufacturing |
| 332439 | 332439 | 3499 | Ammunition boxes, light gauge metal, manufacturing |
| 332439 | 332439 | 3412 | Barrels, light gauge metal, manufacturing |
| 332439 | 332439 | 3412 | Beer kegs, light gauge metal, manufacturing |
| 332439 | 332439 | 3444 | Bins, light gauge metal, manufacturing |
| 332439 | 332439 | 3429 | Bottles, vacuum, light gauge metal, manufacturing |
| 332439 | 332439 | 3499 | Boxes, light gauge metal, manufacturing |
| 332439 | 332439 | 3469 | Cash boxes, light gauge metal, manufacturing |
| 332439 | 332439 | 3499 | Collapsible tubes (e.g., toothpaste, glue), light gauge metal, |
| | | | manufacturing |
| 332439 | 332439 | 3537 | Containers, air cargo, light gauge metal, manufacturing |
| 332439 | 332439 | 3412 | Containers, light gauge metal (except cans), manufacturing |
| 332439 | 332439 | 3412 | Drums, light gauge metal, manufacturing |
| 332439 | 332439 | 3412 | Fluid milk shipping containers, light gauge metal, manufacturing |
| 332439 | 332439 | 3469 | Garbage cans, light gauge metal, manufacturing |
| 332439 | 332439 | 3444 | Hoppers, light gauge metal, manufacturing |
| 332439 | 332439 | 3429 | Ice chests or coolers, light gauge metal, manufacturing |
| 332439 | 332439 | 3429 | Jugs, vacuum, light gauge metal, manufacturing |
| 332439 | 332439 | 3444 | Laundry hampers, light gauge metal, manufacturing |
| 332439 | 332439 | 3469 | Lunch boxes, light gauge metal, manufacturing |
| 332439 | 332439 | 3469 | Mailboxes, light gauge metal, manufacturing |
| 332439 | 332439 | 3412 | Shipping barrels, drums, kegs, and pails, light gauge metal, |
| | | | manufacturing |
| 332439 | 332439 | 3469 | Tool boxes, light gauge metal, manufacturing |
| 332439 | 332439 | 3429 | Vacuum bottles and jugs, light gauge metal, manufacturing |
| 332439 | 332439 | 3444 | Vats, light gauge metal, manufacturing |
| 332510 | 332510 | 3429 | Aircraft hardware, metal, manufacturing |
| 332510 | 332510 | 3429 | Appliance hardware, metal, manufacturing |
| 332510 | 332510 | 3429 | Automobile hardware, metal, manufacturing |
| 332510 | 332510 | 3429 | Brackets (i.e., builder's hardware-type), metal, manufacturing |
| 332510 | 332510 | 3429 | Builder's hardware, metal, manufacturing |
| 332510 | 332510 | 3429 | Cabinet hardware, metal, manufacturing |
| 332510 | 332510 | 3429 | Casket hardware, metal, manufacturing |
| 332510 | 332510 | 3429 | Casters, furniture, metal manufacturing |
| 332510 | 332510 | 3429 | Casters, industrial, metal, manufacturing |
| 332510 | 332510 | 3429 | Dead bolts, metal, manufacturing |
| 332510 | 332510 | 3429 | Door locks, metal, manufacturing |
| 332510 | 332510 | 3429 | Door opening and closing devices (except electrical), metal, |
| | | | manufacturing |
| 332510 | 332510 | 3429 | Furniture hardware, metal, manufacturing |
| 332510 | 332510 | 3429 | Gun trigger locks, metal, manufacturing |
| 332510 | 332510 | 3429 | Hinges, metal, manufacturing |
| 332510 | 332510 | 3429 | Key blanks, metal, manufacturing |
| 332510 | 332510 | | Locks (except coin-operated, time locks), metal, manufacturing |
| 332510 | 332510 | 3429 | Luggage hardware, metal, manufacturing |
| 332510 | 332510 | 3429 | Marine hardware, metal, manufacturing |
| 332510 | 332510 | 3429 | Motor vehicle hardware, metal, manufacturing |
| 332510 | 332510 | 3429 | Padlocks, metal, manufacturing |
| 332510 | 332510 | 3429 | Piano hardware, metal, manufacturing |
| 332510 | 332510 | 3429 | Suitcase hardware, metal, manufacturing |
| 332611 | 332611 | 3493 | Automobile suspension springs, heavy gauge metal, |
| | | | manufacturing |
| 332611 | 332611 | 3493 | Coiled springs, heavy gauge metal, manufacturing |
| 332611 | 332611 | 3493 | Disk and ring springs, heavy gauge metal, manufacturing |
| 332611 | 332611 | 3493 | Flat springs, heavy gauge metal, manufacturing |
| 332611 | 332611 | 3493 | Helical springs, hot wound heavy gauge metal, manufacturing |
| 332611 | 332611 | 3493 | Leaf springs, heavy gauge metal, manufacturing |
| 332611 | 332611 | 3493 | Springs, heavy gauge metal, manufacturing |
| 332611 | 332611 | 3493 | Torsion bar, heavy gauge metal, manufacturing |
| 332612 | 332612 | 3495 | Coiled springs (except clock, watch), light gauge, made from |
| | | | purchased wire or st |
| 332612 | 332612 | 3495 | Flat springs (except clock, watch), light gauge, made from |
| | | | purchased wire or stri |
| 332612 | 332612 | 3495 | Furniture springs, light gauge, unassembled, made from |
| | | | purchased wire or strip |
| 332612 | 332612 | 3495 | Gun springs, light gauge, made from purchased wire or strip, |
| | | | manufacturing |
| 332612 | 332612 | 3495 | Hairsprings (except clock, watch), light gauge, made from |
| | | | purchased wire or strip |
| 332612 | 332612 | 3495 | Helical springs, light gauge, made from purchased wire or strip, |
| | | | manufacturing |
| 332612 | 332612 | 3495 | Instrument springs, precision (except clock, watch), light gauge, |
| | | | made from purch |
| 332612 | 332612 | 3495 | Mattress springs and spring units, light gauge, made from |
| | | | purchased wire or strip |
| 332612 | 332612 | 3495 | Sash balance springs, light gauge, made from purchased wire or |
| | | | strip |
| 332612 | 332612 | 3495 | Springs and spring units for seats, light gauge, made from |
| | | | purchased wire or stri |
| 332612 | 332612 | 3495 | Springs, light gauge (except clock, watch), made from purchased |
| | | | wire or strip |
| 332612 | 332612 | 3495 | Springs, precision (except clock, watch), light gauge, made from |
| | | | purchased wire o |
| 332612 | 332612 | 3495 | Upholstery springs and spring units, light gauge, made from |
| | | | purchased wire or str |
| 332618 | 332618 | 3496 | Automobile skid chains made from purchased wire |
| 332618 | 332618 | 3496 | Bale ties made from purchased wire |
| 332618 | 332618 | 3496 | Barbed wire made from purchased wire |
| 332618 | 332618 | 3496 | Baskets, metal, made from purchased wire |
| 332618 | 332618 | 3496 | Belts, conveyor, made from purchased wire |
| 332618 | 332618 | 3496 | Belts, drying, made from purchased wire |
| 332618 | 332618 | 3496 | Brackets made from purchased wire |
| 332618 | 332618 | | Brads, metal, made from purchased wire |
| 332618 | 332618 | 3496 | Cable, noninsulated wire, made from purchased wire |
| 332618 | 332618 | 3496 | Cages made from purchased wire |
| 332618 | 332618 | 3496 | Can keys made from purchased wire |
| 332618 | 332618 | 3496 | Chain link fencing and fence gates made from purchased wire |
| 332618 | 332618 | 3496 | Chain made from purchased wire |
| 332618 | 332618 | 3496 | Chain, welded, made from purchased wire |
| 332618 | 332618 | 3496 | Chicken netting made from purchased wire |
| 332618 | 332618 | 3496 | Cloth, woven wire, made from purchased wire |
| 332618 | 332618 | 3496 | Coat hangers made from purchased wire |
| 332618 | 332618 | 3496 | Concrete reinforcing mesh made from purchased wire |
| 332618 | 332618 | 3496 | Crab traps made from purchased wire |
| 332618 | 332618 | 3496 | Cylinder wire cloth made from purchased wire |
| 332618 | 332618 | 3496 | Delivery cases made from purchased wire |
| 332618 | 332618 | 3496 | Diamond cloths made from purchased wire |
| 332618 | 332618 | 3496 | Fabrics, woven wire, made from purchased wire |
| 332618 | 332618 | 3496 | Fencing and fence gates made from purchased wire |
| 332618 | 332618 | 3496 | Fourdrinier wire cloth made from purchased wire |
| 332618 | 332618 | 3496 | Grilles and grillwork made from purchased wire |
| 332618 | 332618 | 3496 | Guards, wire, made from purchased wire |
| 332618 | 332618 | 3496 | Hardware cloth, woven wire, made from purchased wire |
| 332618 | 332618 | 3496 | Insect screening made from purchased wire |
| 332618 | 332618 | 3496 | Key rings made from purchased wire |
| 332618 | 332618 | 3496 | Lamp frames, wire, made from purchased wire |
| 332618 | 332618 | 3496 | Mats and matting made from purchased wire |
| 332618 | 332618 | 3496 | Mesh made from purchased wire |
| 332618 | 332618 | | Nails, brads, and staples made from purchased wire |
| 332618 | 332618 | 3496 | Netting, woven, made from purchased wire |
| 332618 | 332618 | 3496 | Paper clips made from purchased wire |
| 332618 | 332618 | 3496 | Paper machine wire cloth made from purchased wire |
| 332618 | 332618 | 3496 | Poultry netting made from purchased wire |
| 332618 | 332618 | 3496 | Racks, household-type, made from purchased wire |
| 332618 | 332618 | 3496 | Reinforcing mesh, concrete, made from purchased wire |
| 332618 | 332618 | 3496 | Rope, wire, made from purchased wire |
| 332618 | 332618 | 3496 | Shelving, wire, made from purchased wire |
| 332618 | 332618 | 3496 | Sieves, made from purchased wire, manufacturing |
| 332618 | 332618 | 3496 | Slings, lifting, made from purchased wire |
| 332618 | 332618 | | Spikes made from purchased wire |
| 332618 | 332618 | 3496 | Spiral cloth made from purchased wire |
| 332618 | 332618 | 3496 | Staples made from purchased wire |
| 332618 | 332618 | 3496 | Stranded wire, uninsulated, made from purchased wire |
| 332618 | 332618 | | Tacks, metal, made from purchased wire |
| 332618 | 332618 | 3496 | Tire chains made from purchased wire |
| 332618 | 332618 | 3496 | Traps, animal and fish, made from purchased wire |
| 332618 | 332618 | 3496 | Trays, wire, made from purchased wire |
| 332618 | 332618 | 3496 | Window screening, woven, made from purchased wire |
| 332710 | 332710 | 3599 | Chemical milling job shops |
| 332710 | 332710 | 3599 | Machine shops |
| 332721 | 332721 | 3451 | Precision turned product manufacturing |
| 332722 | 332722 | 3452 | Bolts, metal, manufacturing |
| 332722 | 332722 | 3452 | Cotter pins, metal, manufacturing |
| 332722 | 332722 | 3452 | Dowel pins, metal, manufacturing |
| 332722 | 332722 | 3452 | Hook and eye latches, metal, manufacturing |
| 332722 | 332722 | 3452 | Hooks (i.e., general purpose fasteners), metal, manufacturing |
| 332722 | 332722 | 3452 | Hooks, metal screw, manufacturing |
| 332722 | 332722 | 3429 | Hose clamps, metal, manufacturing |
| 332722 | 332722 | 3452 | Lock washers, metal, manufacturing |
| 332722 | 332722 | 3452 | Machine keys, metal, manufacturing |
| 332722 | 332722 | 3452 | Nuts, metal, manufacturing |
| 332722 | 332722 | 3452 | Rivets, metal, manufacturing |
| 332722 | 332722 | 3452 | Screw eyes, metal, manufacturing |
| 332722 | 332722 | 3452 | Screws, metal, manufacturing |
| 332722 | 332722 | 3452 | Spring pins, metal, manufacturing |
| 332722 | 332722 | 3452 | Spring washers, metal, manufacturing |
| 332722 | 332722 | 3452 | Toggle bolts, metal, manufacturing |
| 332722 | 332722 | 3429 | Turnbuckles, metal, manufacturing |
| 332722 | 332722 | 3452 | Washers, metal, manufacturing |
| 332811 | 332811 | 3398 | Annealing metals and metal products for the trade |
| 332811 | 332811 | 3398 | Brazing (i.e., hardening) metals and metal products for the trade |
| 332811 | 332811 | 3398 | Burning metals and metal products for the trade |
| 332811 | 332811 | 3398 | Hardening (i.e., heat treating) metals and metal products for the |
| | | | trade |
| 332811 | 332811 | 3398 | Heat treating metals and metal products for the trade |
| 332811 | 332811 | 3398 | Shot peening metal and metal products for the trade |
| 332811 | 332811 | 3398 | Tempering metals and metal products for the trade |
| 332812 | 332812 | 3479 | Aluminum coating of metal products for the trade |
| 332812 | 332812 | 3479 | Bonderizing metal and metal products for the trade |
| 332812 | 332812 | 3479 | Chasing metals and metal products for the trade |
| 332812 | 332812 | 3479 | Coating metals and metal products for the trade |
| 332812 | 332812 | 3479 | Coating of metal and metal products with plastics for the trade |
| 332812 | 332812 | 3479 | Enameling metals and metal products for the trade |
| 332812 | 332812 | 3479 | Engraving metals and metal products (except printing plates) for |
| | | | the trade |
| 332812 | 332812 | 3479 | Etching metals and metal products (except printing plates) for the |
| | | | trade |
| 332812 | 332812 | 3999 | Flocking metals and metal products for the trade |
| 332812 | 332812 | 3479 | Galvanizing metals and metal products for the trade |
| 332812 | 332812 | 3479 | Glazing metals and metal products for the trade |
| 332812 | 332812 | 3479 | Hot dip galvanizing metals and metal products for the trade |
| 332812 | 332812 | 3479 | Japanning metals and metal products for the trade |
| 332812 | 332812 | 3479 | Lacquering metals and metal products for the trade |
| 332812 | 332812 | 3479 | Painting metals and metal products for the trade |
| 332812 | 332812 | 3479 | Parkerizing metals and metal products for the trade |
| 332812 | 332812 | 3479 | Powder coating metals and metal products for the trade |
| 332812 | 332812 | 3479 | Rustproofing metals and metal products for the trade |
| 332812 | 332812 | 3479 | Sherardizing of metals and metal products for the trade |
| 332812 | 332812 | 3479 | Varnishing metals and metal products for the trade |
| 332813 | 332813 | 3471 | Anodizing metals and metal products for the trade |
| 332813 | 332813 | 3471 | Buffing metals and metal products for the trade |
| 332813 | 332813 | 3471 | Chrome plating metals and metal products for the trade |
| 332813 | 332813 | 3471 | Cleaning and descaling metals and metal products for the trade |
| 332813 | 332813 | 3471 | Coloring metals and metal products (except coating) for the trade |
| 332813 | 332813 | 3471 | Depolishing metals and metal products for the trade |
| 332813 | 332813 | 3471 | Electroplating metals and formed products for the trade |
| 332813 | 332813 | 3471 | Gold and silver plating metals and metal products for the trade |
| 332813 | 332813 | 3599 | Grinding metal castings for the trade |
| 332813 | 332813 | 3399 | Laminating metals and metal formed products without fabricating |
| 332813 | 332813 | 3471 | Pickling metals and metal products for the trade |
| 332813 | 332813 | 3471 | Plating metals and metal products for the trade |
| 332813 | 332813 | 3471 | Polishing metals and metal products for the trade |
| 332813 | 332813 | 3471 | Sandblasting metals and metal products for the trade |
| 332813 | 332813 | 3471 | Tumbling (i.e., cleaning and polishing) metal and metal products |
| | | | for the trade |
| 332911 | 332911 | 3491 | Angle valves, industrial-type, manufacturing |
| 332911 | 332911 | 3491 | Automatic (i.e., controlling-type, regulating) valves, industrial- |
| | | | type, manufacturing |
| 332911 | 332911 | 3491 | Ball valves, industrial-type, manufacturing |
| 332911 | 332911 | 3491 | Boiler gauge cocks, industrial-type, manufacturing |
| 332911 | 332911 | 3491 | Butterfly valves, industrial-type, manufacturing |
| 332911 | 332911 | 3491 | Check valves, industrial-type, manufacturing |
| 332911 | 332911 | 3491 | Compressed gas cylinder valves manufacturing |
| 332911 | 332911 | 3491 | Control valves, industrial-type, manufacturing |
| 332911 | 332911 | 3491 | Cross valves, industrial-type, manufacturing |
| 332911 | 332911 | 3491 | Fire hydrant valves manufacturing |
| 332911 | 332911 | 3491 | Fire hydrants, complete, manufacturing |
| 332911 | 332911 | 3491 | Gas valves, industrial-type, manufacturing |
| 332911 | 332911 | 3491 | Gate valves, industrial-type, manufacturing |
| 332911 | 332911 | 3491 | Globe valves, industrial-type, manufacturing |
| 332911 | 332911 | 3491 | Nuclear application valves manufacturing |
| 332911 | 332911 | 3491 | Plug valves, industrial-type, manufacturing |
| 332911 | 332911 | 3491 | Pressure control valves (except fluid power), industrial-type, |
| | | | manufacturing |
| 332911 | 332911 | 3491 | Safety (i.e., pop-off) valves, industrial-type, manufacturing |
| 332911 | 332911 | 3491 | Solenoid valves (except fluid power), industrial-type, |
| | | | manufacturing |
| 332911 | 332911 | 3491 | Steam traps, industrial-type, manufacturing |
| 332911 | 332911 | 3491 | Stop valves, industrial-type, manufacturing |
| 332911 | 332911 | 3491 | Straightway (i.e., Y-type) valves, industrial-type, manufacturing |
| 332911 | 332911 | 3491 | Thermostatic traps, industrial-type, manufacturing |
| 332911 | 332911 | 3491 | Valves for nuclear applications manufacturing |
| 332911 | 332911 | 3491 | Valves for water works and municipal water systems |
| | | | manufacturing |
| 332911 | 332911 | 3491 | Valves, industrial-type (e.g., check, gate, globe, relief, safety), |
| | | | manufacturing |
| 332911 | 332911 | 3491 | Waterworks and municipal water system valves manufacturing |
| 332912 | 332912 | 3492 | Control valves, fluid power, manufacturing |
| 332912 | 332912 | 3492 | Electrohydraulic servo valves, fluid power, manufacturing |
| 332912 | 332912 | 3728 | Fluid power aircraft subassemblies manufacturing |
| 332912 | 332912 | 3492 | Fluid power hose assemblies manufacturing |
| 332912 | 332912 | 3492 | Fluid power valves and hose fittings manufacturing |
| 332912 | 332912 | 3492 | Hose assemblies for fluid power systems manufacturing |
| 332912 | 332912 | 3492 | Hose couplings and fittings, fluid power, manufacturing |
| 332912 | 332912 | 3728 | Hydraulic aircraft subassemblies manufacturing |
| 332912 | 332912 | 3492 | Hydraulic hose fittings, fluid power, manufacturing |
| 332912 | 332912 | 3492 | Hydraulic valves, fluid power, manufacturing |
| 332912 | 332912 | 3728 | Pneumatic aircraft subassemblies manufacturing |
| 332912 | 332912 | 3492 | Pneumatic hose fittings, fluid power, manufacturing |
| 332912 | 332912 | 3492 | Pneumatic valves, fluid power, manufacturing |
| 332912 | 332912 | 3492 | Pressure control valves, fluid power, manufacturing |
| 332912 | 332912 | 3492 | Solenoid valves, fluid power, manufacturing |
| 332912 | 332912 | 3492 | Tube and hose fittings, fluid power, manufacturing |
| 332912 | 332912 | 3492 | Valves, hydraulic and pneumatic, fluid power, manufacturing |
| 332913 | 332913 | 3432 | Antiscald bath and shower valves, plumbing, manufacturing |
| 332913 | 332913 | 3432 | Backflow preventors, plumbing, manufacturing |
| 332913 | 332913 | 3432 | Cocks, drain, plumbing, manufacturing |
| 332913 | 332913 | 3432 | Drain cocks, plumbing, manufacturing |
| 332913 | 332913 | 3432 | Faucets, plumbing, manufacturing |
| 332913 | 332913 | 3432 | Flush valves, plumbing, manufacturing |
| 332913 | 332913 | 3432 | Plumbing fittings and couplings (e.g., compression fittings, metal |
| | | | elbows, metal |
| 332913 | 332913 | 3432 | Plumbing fixture fittings and trim, all materials, manufacturing |
| 332913 | 332913 | 3432 | Shower heads, plumbing, manufacturing |
| 332913 | 332913 | 3432 | Spigots, plumbing fixture fitting, manufacturing |
| 332913 | 332913 | 3432 | Stopcock drains, plumbing, manufacturing |
| 332913 | 332913 | 3432 | Supply line assemblies, plumbing (i.e., flexible hose with fittings), |
| | | | manufacturi |
| 332919 | 332919 | 3432 | Traps, water, manufacturing |
| 332919 | 332919 | 3432 | Water traps manufacturing |
| 332919 | 332919 | 3499 | Aerosol valves manufacturing |
| 332919 | 332919 | 3494 | Boiler couplings and drains, plumbing and heating-type, |
| | | | manufacturing |
| 332919 | 332919 | 3432 | Breakers, vacuum, plumbing, manufacturing |
| 332919 | 332919 | | Couplings, hose, metal (except fluid power), manufacturing |
| 332919 | 332919 | 3494 | Elbows, pipe, metal (except made from purchased pipe), |
| | | | manufacturing |
| 332919 | 332919 | 3494 | Flanges and flange unions, pipe, metal, manufacturing |
| 332919 | 332919 | 3429 | Hose couplings, metal (except fluid power), manufacturing |
| 332919 | 332919 | 3432 | Lawn hose nozzles and lawn sprinklers manufacturing |
| 332919 | 332919 | 3429 | Nozzles, fire fighting, manufacturing |
| 332919 | 332919 | 3432 | Nozzles, lawn hose, manufacturing |
| 332919 | 332919 | 3494 | Plumbing and heating inline valves (e.g., check, cutoffs, stop) |
| | | | manufacturing |
| 332919 | 332919 | 3432 | Sprinklers, lawn, manufacturing |
| 332919 | 332919 | 3494 | Steam fittings, metal, manufacturing |
| 332919 | 332919 | 3494 | Unions, pipe, metal (except made from purchased pipe), |
| | | | manufacturing |
| 332919 | 332919 | 3494 | Valves, inline plumbing and heating (e.g., cutoffs, stop), |
| | | | manufacturing |

The previous reference section serve two purposes: It provides those skilled in the art a quick ready reference of metal working terms and material standards to aid in the selection of materials for any particular device development. It also lays the foundation to expand applications and unique production techniques that are further taught and exemplified in the reproduction the Gilhoolie presently marketed as the (Wille grip).

New types of metal forming and metal treatment techniques e.g. Chemical Etching. Metal Stamping, RF Shielding and Rapid Prototyping are readily available in highly industrial states like the United States. Their mechanical application will be discussed and referred to in subsequent applications. Generating engineering software programs to design and then fabricate custom-made precision metal parts as well as, perform chemical etching, and metal stamping, to include RF shielding, or any custom part made out of metal to provide these production functions in a hurry are forth coming and detailed. With homogeneous design and production software product quality will be predictable and consistent in small and large quantity runs. Initial cost in equipment is the front end cost to the more industrialized state. While less industrialized countries will perform the mass tasks in peace meal using more labor to perform more redundant tasks to make parts and sub essemblies.

For example part manufacturing through etching

The unique design to production software components allow for rapid prototyping so it delivers prototypes in 25% of the normal time and at near the cost for limited run production units. The range of products are great from typical applications such as hand tools and kitchen aids devices to RF/EMI shields, screens, contacts, connector housings, lead frames, apertures and many more. Multiple industrial components can go from phoned in orders to specs to production in the same day for diverse applications. The Inventions highly industrialized special electronic controls manage chemical etching processes to create metal parts with a precision unmatched by traditional metal fabrication methods. For example the fully automated process can deliver tight tolerances within 0.0005″. And the near fully automated metal fabrication plant can make and ship custom parts more quickly and at a fraction of the cost of machine-tooled parts, generally. The trade off has always been the cost of the equipment to the cost of labor for the length of the run

Metal Stamping uses the same automation software to rapidly capture an idea and prepare equipment instructions and machine messaging to manage automated feed and stock robots as well as stamp and die equipment so they perform the automated component forming tasks. So from the beginning of the operation receiving the image, determining the specifications and materials, then applying computer controlled etching of the dies and the use of those dies in computer controlled stamping has all been automated via this machine messaging network. This innovative machine edge is available to the industrialized nation vs the machinist turning out dies, for punch machines in less industrialized countries. Where these tools are then mass produced to produce mass quantities. Costing greater use of energy creating greater waste but employing and feeding more.

The point being this invention applies science and technology to best fulfill a particular socio economical situation. This important teaching can provide entrepreneurs to world leaders the prime modality to participate in a free market economy through having the means to discern how to produce a particular product in a particular country.

Embossing

Another metal forming process for producing raised or sunken designs or relief in sheet material by means of male and female dies, theoretically with no change in metal thickness or by passing sheet or a strip of metal by passing between rolls of desired pattern. This will also be done via the automated machine messaging network, where design can be photographed and the image digitalized and reproduce in the metal via rolling, laser or chemical etching to mention a few methods offers a range of metal embossing services.

The following drawings completely address the various metal fabrication methods available around the world to produce one specific device in order to teach one to recognize the best combination of industrial techniques to produce a product geographically and demographically.

### DESCRIPTION OF THE DRAWINGS

Figure A

This figure serves a number of purposes. First to depict a singular rendering of the component parts from one mass stamping or laser cut from a singular sheet of steel (With the exemplary Wili Grip done in stainless steel). It also is used to display the exemplary device's component parts that could be constructed traditionally in singular Hi Die stamping technology as is done more frequently in less technical countries using more labor intense industrial methods. Here the components would be formed from reduced feed stock cuttings, which require another productions step to the raw flat steel purchased from the steel mill.

In the mass stamping the parts are blanked out in a single stroke via a die and preformed jig as well as pre set cutting edges and re-session in mating dies to allow for the formed component parts to be stamped out all at once. In this case there is still a great deal of pre engineering and tooling work to construct the mass die. This is a progressive step in the technology taught that when licensed separately could adjust competitive production cost as well as be a guide to marry the proper technology to the given geographic and demographic populous.

Discussed second (Laser Cutting) in mass forming of component parts applies to the most advanced nations and employs the least amount of persons per unit produced. It has the highest initial start up cost for machinery and relies on a good IT capacity. The start up costs rival the engineering and tool and die machine work required for mas and component stamping so clearly laser cutting is both feasible and desired for the manufacture and nation that has the infrastructure to support the technology. The obvious savings are in labor cost.

But what is important for the leaders of a developing country to realize is that they by employing Mechanical stamping and manual assembles can more easily get into world markets/economy by purchasing second hand machinery in bulk either to perform single stamping or by utilizing mass hi die or horizontal presses (a second step) either mechanical or hydraulic and their greatest asset an unemployed populous.

This provides jobs and a economic way of life to occupy and provision their citizens wit meaningful stability and the necessities of life, and provide the emotional conception of individual freedom which establishes the order and relative improvement in the quality of life, depending on how good their general leadership skills are.

This is no different in even the most technically advanced nation and in this case the world is sorely lacking in good leadership. Which is another reason these commercialization techniques are being patented as technical teachings of industrialization for the varied nation states and to help manage their use of technology and negative global impact through the market places these products are protected in. And to keep free enterprise alive but to stop the erroneous and indiscriminate “free for all” theft by huge corporations and International manufacturers that copy new and small enterprise products and proprietary technology as they are first marketed.

Re addressing the advantages of laser cutting (for the most technically advanced nations) for mass component parts production is that these machines are much quicker to set up in operation because one can go from the drawing board to operational production in one step. There is no machine tooling required to produce the die or mating receiver die to perform a stamping or blanking process. The electronic drawing is done in auto cad by the production designer or engineer in an electronic bit map software program. Then the program is loaded into the laser cutter and the parts are cut from the feed stock that is pre paced or jigged into the drivable table and mobile laser arrays depending on the equipment manufacture.

Figure B

The processes will employ simple bending, breaking or rolling dies that can be used to achieve the necessary final forms out of the stampings just described. In the most rudimentary form these can be performed by hammer an jigs (preformed guides by which an individual can hammer out a desired shape from base stock with consistent results). Second stage or multiple stages of additional stamping is another method to achieve final forms. All these modalities lend themselves to labor intense situation and are best practiced in less developed nations. This illustration is forthcoming in the formal filing.

Progressive rolling and folding technology are best suited for more industrialized nations and this illustrations will appear likewise in the formal figure as well.

The most technically advanced operation is the programmable robotic former or progressive roll machine which is being designed and is replicated in part by some advanced machinery today. This machine is in an early design state at the submission of this provisional application and will be illustrated and described in the formal filing as well as have special claims in the formal, or the technology advancement will be filed separately as a related technology in a second utility patent or as additional drawings if the specification supports the final formal drawings.

This Figure shows the most rudimentary manufacturing machines and techniques to an exemplary state of the art production layout to perform metal fabrication and produce the stamped out parts for the Willey Grip as a single through put opperation. The reader should keep in mind that the exemplary device being produced and the layout can be different or modified and still fall within the nature and scope of the invention for the exemplary device and all equivalent products. And that the techniques and equipment may vary per product produced to the most cost effective means. These are the restricting criteria that are used to help maintain a balance of trade in world economies so that the global economic tool can be used to provision the world populous better at any one given time. The balance of labor to energy consuming machinery use is but one important technique industrialized nations as well as labor intense countries of the world most understand well as energy supplies change from fossil fuels like coal and oil to water, hydrogen waste regeneration and other reusable energies to make electricity.

This drawing and any further illustrations will be used to further discuss the materials already developed in this application but will not introduce any new technology only a variation on what has been taught so far.

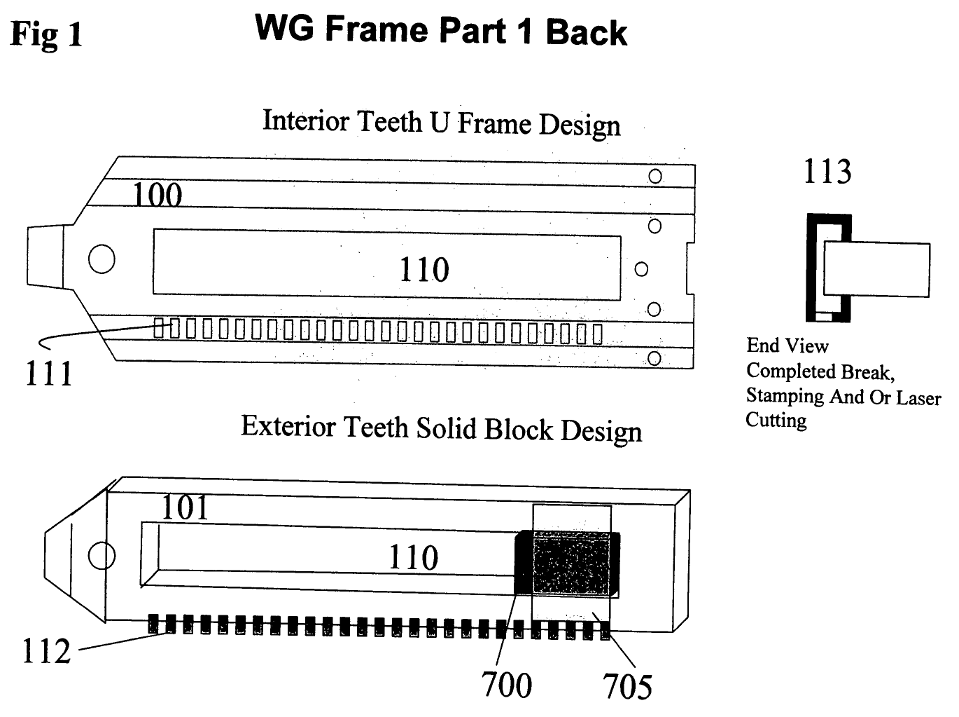

FIG. 1

FIG. 1 has two presentations for the frame rail part numbered 100 for the interior teeth U frame design located at the top of the page, and part 101 at the bottom of the page which is constructed from a solid block of metal and has exterior positioning teeth for the handle part 200 lever assembly to align with and mate it's latch assembly with. This second solid block variation has been innovatively added to the specification to better meet the nature and scope of the invention. Which is to make more cost effective legacy devices that previous designs or manufacturing techniques have excluded their production in the United States due to such high costs to perform the tasks. Not having to configure to opposing u channels as depicted in the upper figure part 100 illustration greatly reduces the set up and tool and die work required to make the part either by stamping or rolling this part progressively as has been discussed and will be further elaborated on. However, producing the part with the u channels is still part of this specification and performing this process will be further described presently in varying stages of automated industrialization to lessen the cost of this design as well. The point of the teaching is that all aspects from design through assembly to include packing and shipping are to be evaluated via the modalities described in the specification to best produce product and limit negative impacts for a company country and populous

Returning to part 100 description in the top of the FIG. 1 with the opposing U channels. It is a flat representation of the main frame rail and numbered part. 100. It supports the lid grabber assembly and handle of the Willey Grip. The center rectangle 110 is a stamp out slide area for the handle No. 200 mount and slider guide block parts numbered 701,702,703 704 depicted in figure seven. The numerous smaller rectangles in a horizontal line at the at the bottom of the drawing numbered 111 are milled or laser slots that act as latch position points for the handle latching mechanism to adjust to seat and anchor for the appropriate lid size to provide the correct cam down pressure and grip the lid. These latch position slots 111 can be punched or stampings or done by programmable laser cutting, depending on the material used, thickness required and gripping application as well as, the geographic demographic and socioeconomic characteristics of the nation state constructing the device. The horizontal full length lines are break or bend lines, where two 90 degree bends are made creating two opposing U channels on the same side of this frame rail down the elongated portions of the rail. These U channels are folded up to support an edge of the slider Part number 701 or 702 along with the rectangle slot No. 110 supporting the other edge of the slider 703 and 704. Part 200 has a rivet through an angular slot of the 700 series parts and one through the latch component one of the 600 series parts. These latches have to be the appropriate configuration to seat and anchor into area 111 the slots in the rail. With the frame rail folded into two closed u channels as seen in the end view 113, part 200 is folded down over the left U channel side in a wider U configuration as shown in figure two so that the latch can pass through the holes and lock the handle into the appropriate cam and gripping position for the lid and handle throw.

Looking down at part 101 at the bottom of the page the 3D solid block frame rail has a slider block part 700 and the guide 705 on the slider lays on the on the out side of the 100 frame rail part on either side to keep the slider in track. On the U channel design the 700 center piece fits down into the U channel to keep the slider block tracking properly.

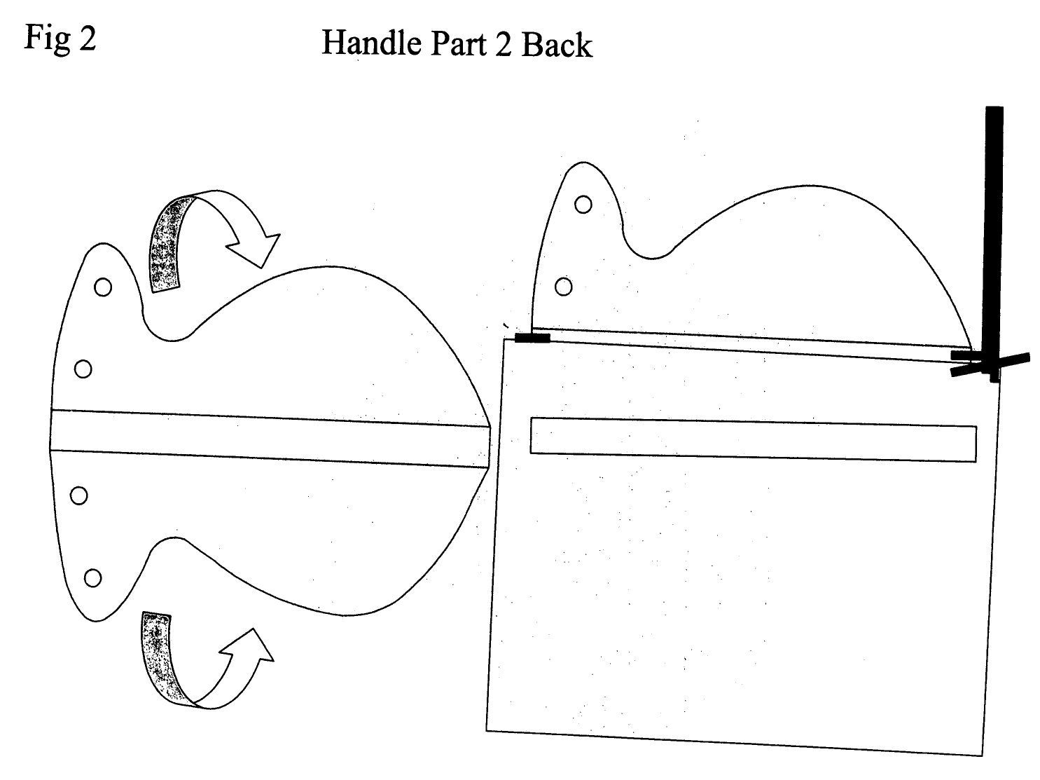

FIG. 2

FIG. 2 is the handle stamping laid out flat to the left with four punched holes or drillings. The holes using rivets to provide pivot points for the Latch Part No. 600 601 603 and slide block part no. 701,702, 703 and 704. To the right top of the figure is a side view of the handle assembly as it would appear after the downward break or bending process was completed and drew dow the sides to make the U shaped configuration described in the first figure. The rectangle in the center right of the drawing is a top view looking down on the handle assembly as seen when the handle is straddling the frame rail part 100 in figure one view 113.

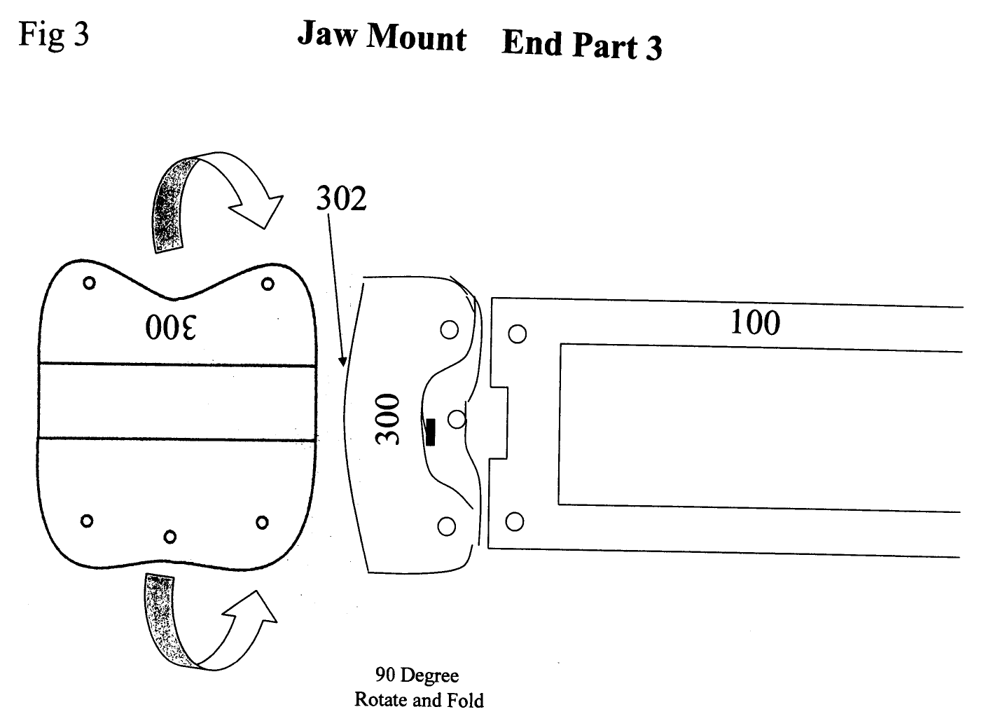

FIG. 3

This drawing is of the end plate part 300 or mounting plate for the gripping jaws to grasp the lid or object to be removed or tuned lose or tightened via the leverage grasping rotational force of the Wili Grip. This stamping part 300 is folded per the modalities detailed through out this specification and rotated 90 degrees to be attached to part 100 the frame rail folded, and combined with the end stop bottle opener hook part 800, not shown to more clearly show the jaw mount 300 end piece.

Once again rivets are used to secure and attach these three parts together. Two mount tips hold a forth part each a jaw part No. 500, 501 or 502 per application desired, which is also not shown here to clearly display part 300 the jaw mount. 302 can be straight and 303 end tip holes are made longer to allow for enough distance for circumferential grasping with out strikin the back wall of the mount

Manufacturing techniques vary as explained to meet the most efficient and cost effective manner per geographic and socio economic region whether it be more labor intense or fully automated process. The riveting process or assembly can be performed singularly by an individual with anvil hammer and spreading punch for each rivet installation or to apply all the assembly rivets (Totally manual). Or by a powered riveting machine with tooled anvil and spindle (possibly still requiring manual rivet placement and singular component installation).

Or a more automated component assembly process could be employed to include a robotics computerized set up with individual parts loaded into fitted magazines and delivered automatically at the appropriate time into the preplanned position via a preprogrammed software running in a machine controller, which energizes solenoids, motors belts stops and actuators via electronic signals and to signal a single stroke action to set and compress all rivets in the appropriate parts simultaneously (Assembling a unit every 20 second or less) with only one stock person for the assembly process.

Obviously, the same production levels can be achieved through rudimentary manufacturing means by using greater amounts of hands on labor as is possible via the most advanced robotics equipment in manufacturing and artificial intelligence. The key is to know what is needed and best suited to match the technology to the populous and the environment. This another issue that requires a responsible view in deciding the proper technology to manufacture with. Much has been done on this topic and this topic will be further developed in the formal specification to best aid in the use and application of technology taught for global manufacturing. Much of this environmental technical data is taught in other patents written by co inventor Richard C Walker and an additional portion to this consideration will be forthcoming in the formal filing without adding new material.

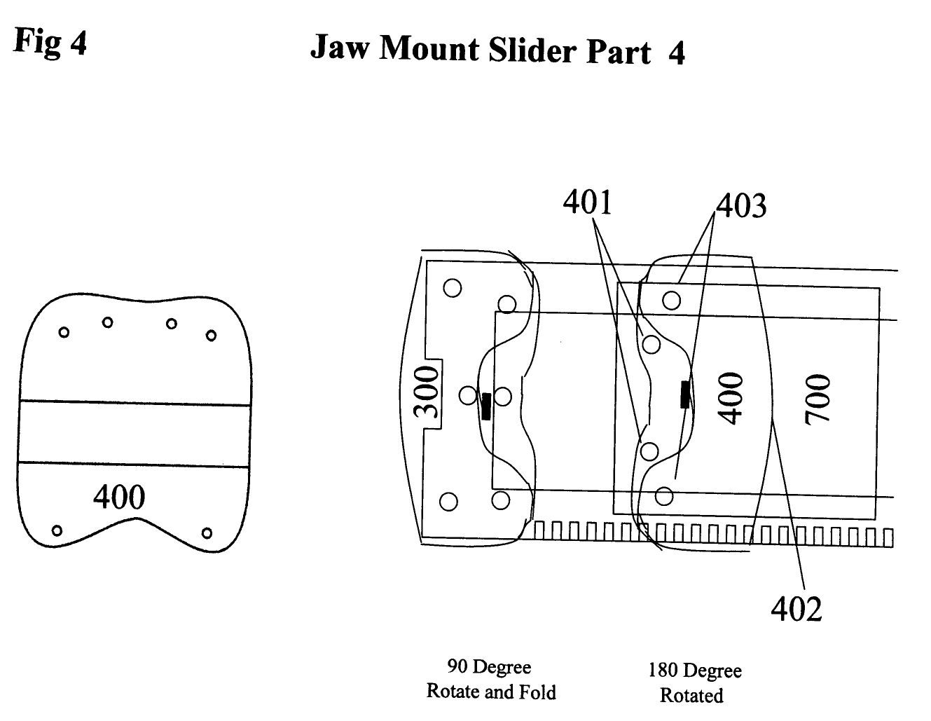

FIG. 4

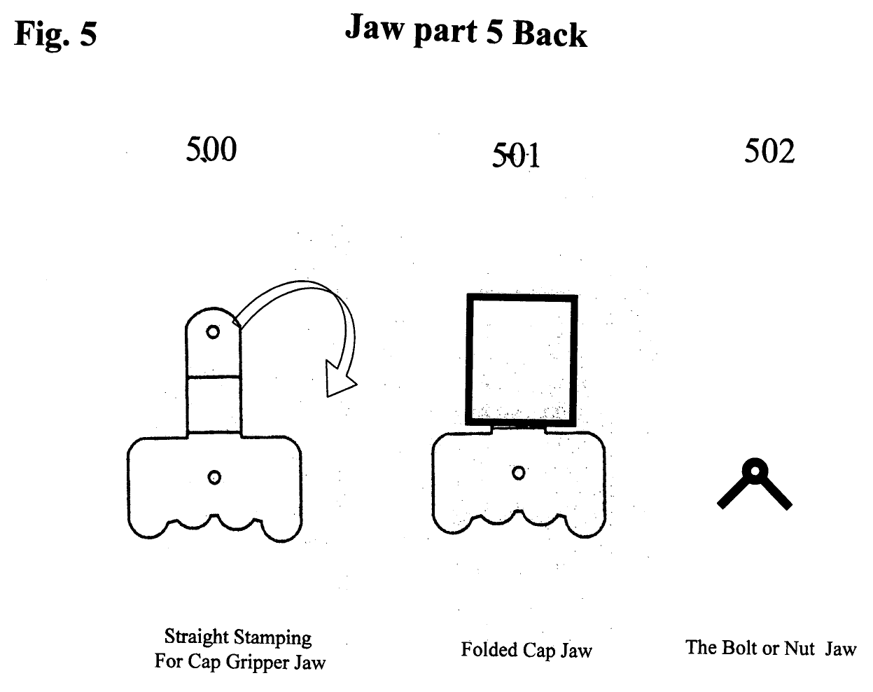

Basically, the jaw mount component part 400 on slider part 700 is the same as the jaw mount end piece 300 however it has two additional drillings or holes 401 and is rotated 180 Degrees more to oppose part 300 and form the opposite side gripping component. Here the part is shown with a radius back to more easily guide the jaws in a circumferential direction and griping action for flat round objects. In prototypes this piece 402 is straight with longer curved tips that extend more with the two drillings placed further out to allow for circumferential gripping jaws 500 in FIG. 5 to articulate around and accommodate a curved surface. 402 can be straight and 401 end tip holes are made longer to allow for enough distance for circumferential grasping to have radius movement with out striking the back wall of the mount 402. 401 rivets pass through 3 seven hundred series pieces depending on the combination of slider and grips used. This is explained in figure seven.

Another adaptation of the Wily Grip is to have a hole centered in a square angled gripping component like 502 in FIG. 5 to better grasp standard nuts and bolts and then utilize the cam leverage action of the Wili Grip to tighten or loosen them.

FIG. 5

This figure is of the gripping jaws for the lids and nuts and bolts. Part 500 is a flat stamping of the jaw. As the arrow indicates the elongated portion with the two cross lines and the hole in the end is folded or bent at each line down and under so that the holes line up as pictured in 501 for a rivet to pass through one of the jaw mounting brackets either on the slider part 400 or at the end of the frame rail part 300. These bends or breaks can be done by hammer and anvil or single jig or by a stamping die separately or during mass break with a multiple set up of the same part at the same time.

502 is an innovation on the Jaw piece. It is a top view for square nuts and bolts gripper. Other angles and configurations for special gripping applications can be constructed to have an articulating hole and be attached by the rivet system or quick release shoulder bolts or articulating pins in the same manner as the 500 standard jaw part is. The smaller gripper applications can be performed by the slider component section 700,701,702,703, 704, 705 and the end stop 800 or cut in the end of the frame rail 100.

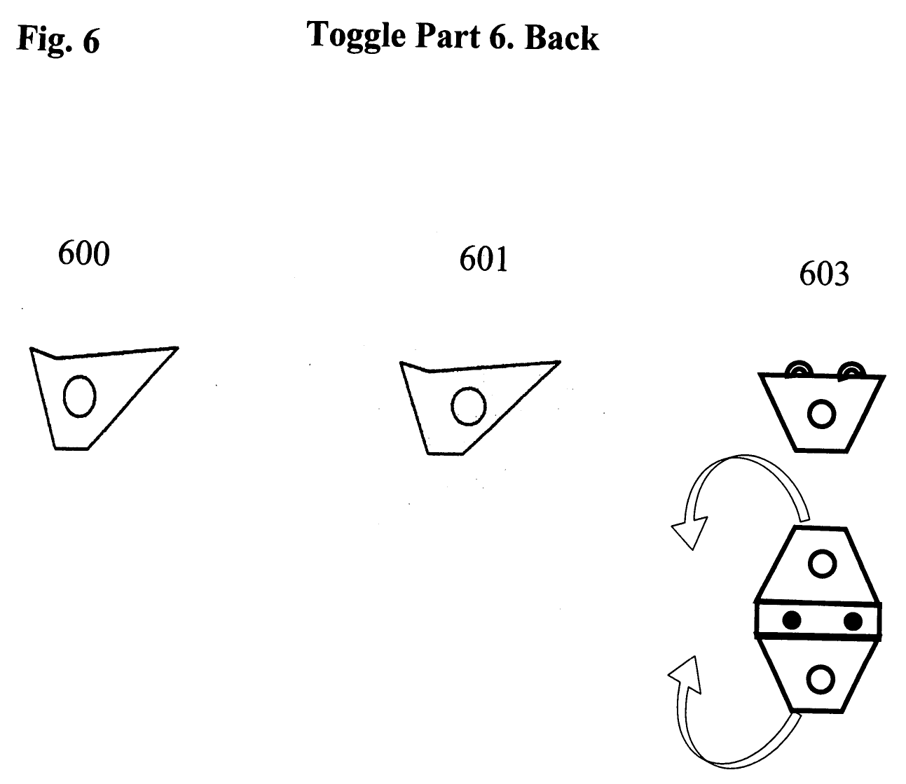

FIG. 6

The different latches represented in FIG. 6 are just a few of the lock and catch mechanisms that can be used in the Wili Grip construction and or produced through the various technologies and methods taught here within. Part 600 with the pointer edges catch and anchor into a matching lattice or strip gear on part 100, 101 or a derivation of these configurations. The drilling or punch hole is for the the articulating rivet that passes through the handle assembly part 200. When the handle is closed these catches are first pressed into the strip gear 111, 112 or a derivation of these 100 series parts in the first figure then the traveling rivet passing through handle 200 slides down the slider slot position 710 in the 700 series parts to press the the attached jaw parts 500 and mount 400 into opposing and identical 500 jaw parts on end mount 300 to squeeze the lid or object in a grasping action to turn to loosen or tighten the screwed on object.

601 is another side view of a latch and catch system and 603 is used to show a sheet metal development and folding or bending construction. All these parts can be constructed from soling piece of metal or by breaking them into the appropriate configuration.

603 up top is a side view of the specific catch with two stamped dimples that are made when the piece is stamped out flat in the illustration below. This is the mating piece for the stamped out slots positions 111 in FIG. 100 in the top frame rail illustration in figure one. Component 603 in the lower illustration has arrows that show how the trapezoid sides are folded up to form the woe support ails for the articulating holes for the 200 handle rivet pin.

Whether this part is a solid construction or one made by breaking and folding metal the over all width has to be small enough to slide inside the handle folds. Two separate manufacturing modalities have been expressed in FIGS. 1 and 6; that of solid and that or sheet metal breaking rolling and stamping. Some parts naturally lend themselves to specific construction techniques as the best way to produce them. Such may be the case with figures one and six. In some countries a solid block of aluminum cut out rather than a stainless steel progressive roll die or guide may prove the most cost effective means of making them. Both should be priced in various locations and individually as should all components.

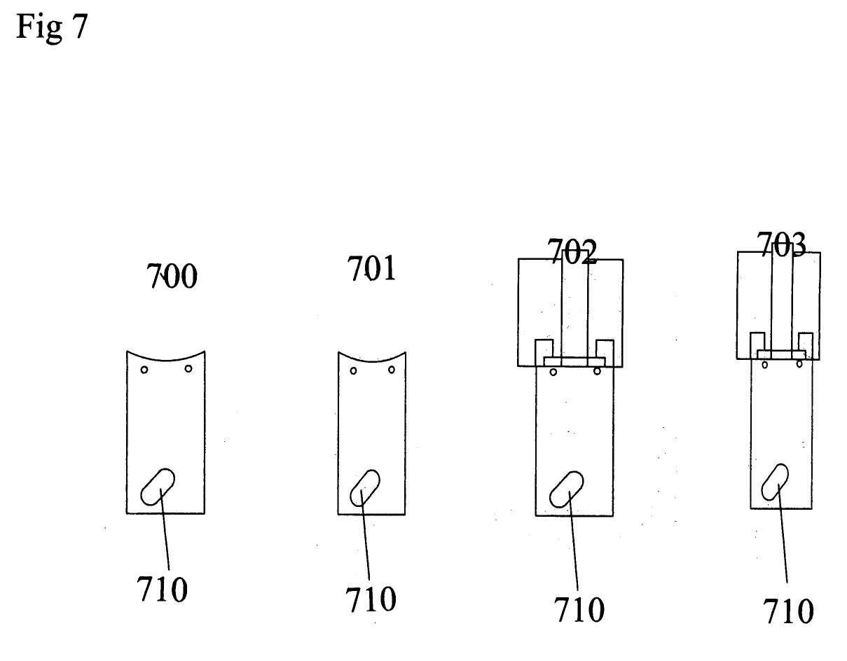

FIG. 7

FIG. 7 is the slider components and rail guide that ride in the center rectangle slot of part 100 in the top of FIG. 1. The more narrow pieces 701 and 703 are the slot edge guides and two identical stampings of this part are riveted to either side of one part 700 or 702 the center slide part. The oblong slot left corner to center is where the second handle rivet slides down when closing to apply inward pressure on the jar lid. This is determined by the entire assembly being slid close to the lids circumference and then anchoring and latching the handle (either latch part 600, 601, 603) into the specific set of receiving strip gear holes on the frame rail part one. The 700 series plate for the 101 solid form is a flat plate on either side of part 101 and is depicted at the bottom of FIG. 1 as part 705.

All these parts can be made solid or by stamping and in this case for this application stamping is probably the best modality.

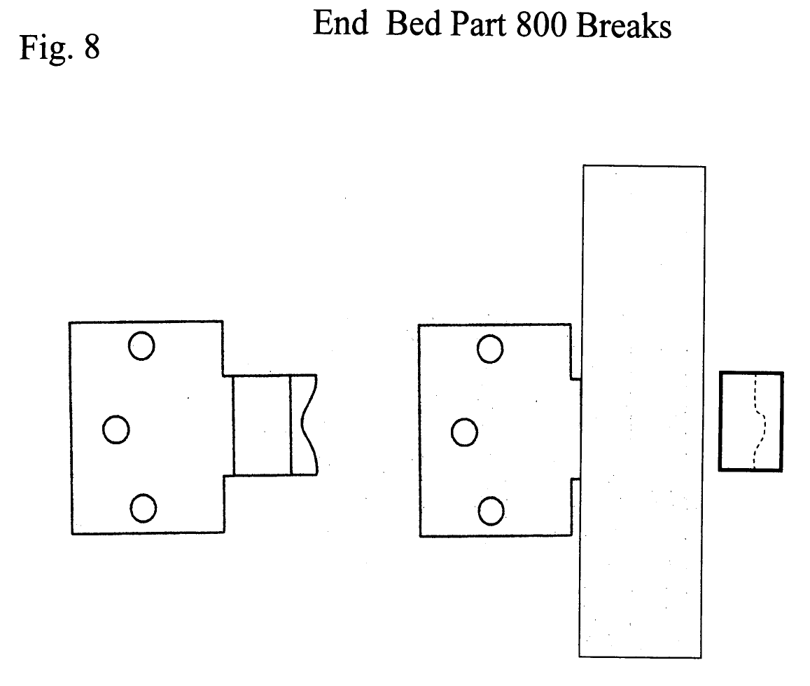

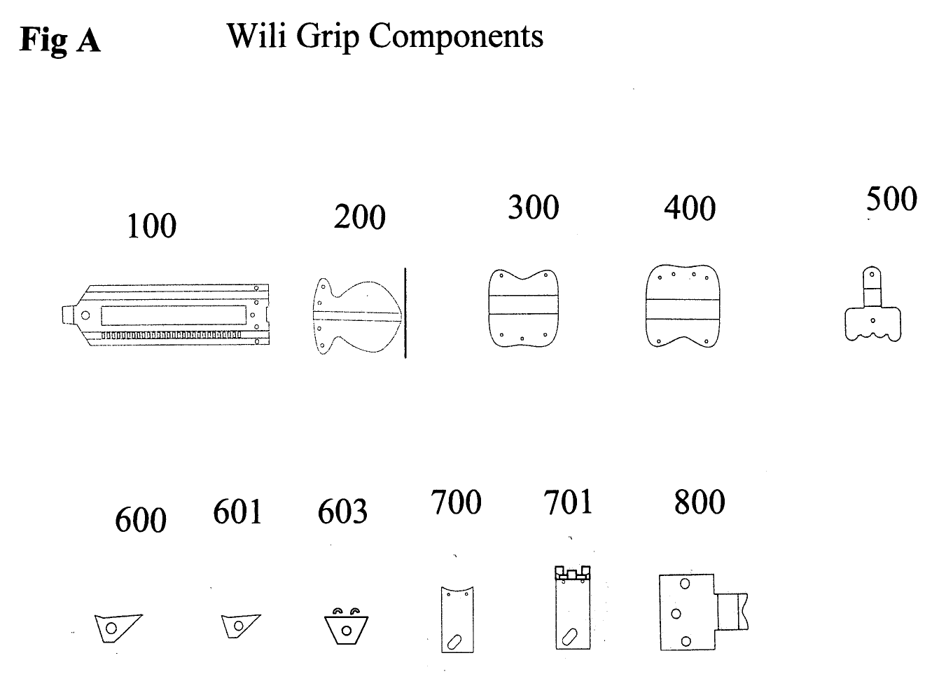

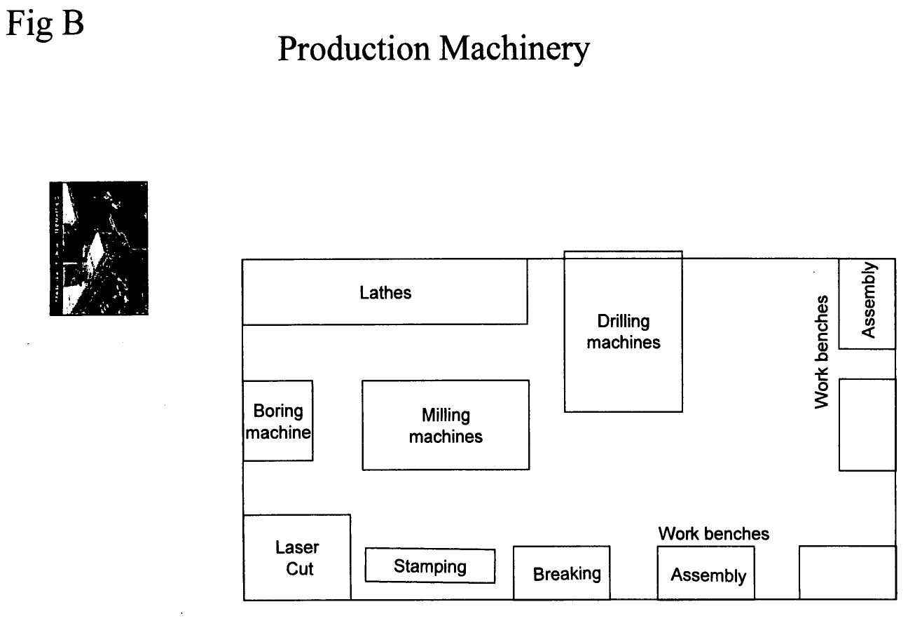

FIG. 8

The 800 part is the end bracket and bottle opener hook. Here the plate part is folded in to 90 degree angles at the indicated break lines. The part serves as an end stop for the slider grip and handle assembly and a spacer to support the folded rail structure.

It too can be machined out of a solid piece of metal or folded in a break machine as stated earlier. It can also be hand crafted if labor is inexpensive enough. Automated stamping and breaking to construct the part of stainless steel is most probably the best construction modality for this part as well.

While the metals of choice for the construction of the present day Wili grip include Aluminum and stainless steel all metals and and all metal finishes to include plating and painting fall within the nature and scope of the invention to reproduce this legacy device via a new and unique techniques.

### SUMMARY OF INVENTION

The progressive stamping and assembly technology balances the use of inexpensive labor globally with high tech mass production techniques to achieve the same competitive costing in getting product to market. This is the viable component of this newest of commercial manufacturing techniques to keep technically advanced countries competitive for manufacturing jobs that are traditionally going over seas. The technology is not designed to stop this practice, in fact it is to progressively relocate technical advancements to these more populous third world countries in the future. But in a ytimely manner that allows for the retraining and re-tooling that comes with technical advancement The process serves to commercially maintain cost effective manufacturing in domestic national products to provide essential goods in time of war or disaster. This better insures domestic tranquility and National security.

The United States is still the greatest market place in the world, but it needs to serve notice to the world manufacturing community it can still produce and manufacture all essentials domestically and inexpensive with high quality and variety if it must. This is the best way to serve free enterprise and an expanding world economy, with out being gobbled up and left helpless to produce product traditionally requiring manual labor.

Another technique discussed in the specification is to export technology and brokerage the workload to offshore companies with a certain amount of redundant production, if not of the same component at least similar components. This provides for another versatile supply line if one is compromised due to disaster or domestic problems. In an effort to be fair and responsible this is accomplished by managing the market place demand and measure market share as well as make timely alterations in supply line manufacturers both at the corporate level and at the geo political level to maintain good company reputations and international relations. Having the proper tools in place makes this massive job just a way of doing business for world leaders and commercial interest.

This application teaches a unique manufacturing and assembly process to make a high quality, intricate and costly kitchen hand tool again readily available to the US public at an inexpensive price. The manufacturing technique can be applied for other tools, utensils and products, however an exemplary device called the gohuli AKA by the inventors as the “Wili Grip” for the unique manner in which it is mass produced today.

A number of manufacturing techniques are applied to bring this exemplary device to market and will be fully elaborated in the formal filing. Originally the device is made via traditional metal work an machining. The prototype run or lot of 30 to 50 pieces are first cut out of 16 gauge 40 by 40 stainless steel sheet of metal and then folded via a break into a series of different 90 degree and U channel configurations as illustrated in the drawings. This rudimentary method is per formed in a repetitive manner via a multiple of parallel operations where labor is plentiful. In the more technically advanced countries the use of computerized digital laser cutting would be employed to make the massive amount of cuts in a multiple manner.

1. A claim is made for a variable global production processes, taught for the exemplary device called “The Gilhoolie” also known as the Wili Grip” or any similar derivation of this device or other similar device described, detailed and or represented herein or found comparable to product and or production techniques described herein, and to include any geographic locations these techniques are employed to produce said product or other similar products.

2. A claim according to claim 1 is made for the isolated manufacturing and processing of component parts for a device and its assembly in same or another country for the purposes of being cost effective to realize commercial viability, and or be competitive and protective of said product produced by said techniques.

3. A claim according to claim 1 is made for the sole manufacturer of all the components to further reduce costs when market share is secured and competition is diminished due to the economy of scale reducing product cost.

4. A claim according to claim 1 or 2 is made for the production of other products, devices and utensils via the same production techniques taught and detailed in this specification

5. A claim according to claim 1 is made for a nation to evaluate individual product, industry, population, resources and production techniques to determine economic, and environmental impacts, as well as structure policy for an optimum economy and way of life.

6. A claim is made according to claim 1 or 2 for an Individual organization group or corporation to evaluate product and production technique for commercial reasons, and or to determine economic, and or environmental impacts, as well as structure policy for an optimum commercial venture or to aid a government in its assessment of economy and way of life.

7. A claim is made for the exclusive rights to produce the exemplary device, or similar device referred to as the Gilhoolie or the Wili Grip as depicted in the specification regardless of the name or variation.

8. A claim for proprietary word use of The Wili Grip is made with all rights reserved for this and related technology.
